(19) United States
(12) Patent Application Publication
(10) Pub. No.: US 2025/0187003 A1
(43) Pub. Date: Jun. 12, 2025

(54) SYSTEMS, DEVICES, AND METHODS FOR MICROFLUIDIC FLUID ANALYSIS

(71) Applicant: Aufbau Medical Innovations Ltd., Dublin (IE)

(72) Inventors: David D. HURLEY, II, North Brunswick, NJ (US); John T. G. PENA, New York, NY (US); Hwi Yong LEE, North Brunswick, NJ (US); Apeksha C. RAJAMANTHRILAGE, Somerset, NJ (US); Kathleen HO, Somerset, NJ (US); Shayna F. BELDNER, Scotch Plains, NJ (US)

(21) Appl. No.: 18/977,577

(22) Filed: Dec. 11, 2024

Related U.S. Application Data
(60) Provisional application No. 63/608,790, filed on Dec. 11, 2023.

(51) Int. Cl. B01L 3/00; G01N 35/00; G01N 35/10

(52) U.S. Cl. CPC B01L 3/50273; B01L 3/502746; G01N 35/0099; G01N 35/1002; B01L 2200/025; B01L 2200/16; B01L 2300/0663; B01L 2300/0816; B01L 2300/0864; B01L 2400/049; B01L 2400/086

(57) ABSTRACT

Described here are systems, devices, and methods useful for high-throughput and automated separation of extracellular matrix bodies using a microfluidic chip. A system for separating extra-cellular matrix bodies (ECMBs) from a biological fluid may comprise a holder configured to receive the biological fluid, a robot configured to transfer the biological fluid from the holder to a microfluidic chip, a chip connector configured to hold at least one microfluidic chip, a manifold coupled to the at least one microfluidic chip, and a negative pressure source coupled to the manifold. The negative pressure source may be configured to apply a negative pressure of between about 10 mm HG and about 760 mm HG to the at least one microfluidic chip.

### CROSS-REFERENCE TO RELATED APPLICATIONS

This application claims the benefit of U.S. Provisional Application No. 63/608,790, filed Dec. 11, 2023, the content of which is hereby incorporated by reference in its entirety.

### TECHNICAL FIELD

The devices, systems, and methods herein relate to separating and/or analyzing extracellular matrix bodies (ECMBs) from a biological fluid.

### BACKGROUND

Conventional methods for diagnosis and prognosis of disease include isolating and analyzing a tiny fraction of a biological sample (e.g., biological fluid) where, for example, individual cells, extracellular matrix, extracellular vesicles or soluble tissue microenvironments, proteins, and nucleic acid molecules may be detected and analyzed. For example, the inventors previously described a method of detecting and analyzing molecules using microfluidic chips and positive pressure. However, drawbacks of such positive pressure systems include low-throughput, limited scalability and reproducibility. In addition, previous systems tend to require over reliance on manual labor. For example, a user is needed to pipette or manually inject with a syringe each biological sample and/or set of reagents to a respective inlet port of a microfluidic chip. Moreover, a positive pressure system relies on a significant amount of tubing to deliver the sample to the microfluidic chip, and therefore, a volume of liquid for each microfluidic chip may be inconsistent. Furthermore, these systems tend to suffer from a higher rate of contamination, as they require time-intensive manual labor for set-up and cleaning. Other conventional methods for diagnosis and prognosis of disease include isolating and analyzing intact organ tissues, whole cells, biomarkers (e.g., extracellular vesicles such as exosomes), and the like. However, a drawback of such methods includes the inability to detect or characterize disease when these isolated structures do not readily reflect the disease state. For example, biomarkers are often inherently limited by not being related directly to a pathology of interest. Accordingly, additional systems, devices, and methods for separating and analyzing a biological fluid are desirable.

### SUMMARY

Described here are systems, devices, and methods useful for separating extracellular matrix bodies (ECMBs) from a biological fluid, or indirectly from tissue or a gel, in an automated and high-throughput manner. In this way, the ECMBs may be used for use in diagnosing, prognosing, and/or treating a subject, for example using histochemical staining techniques, immunohistochemistry or nucleic acid hybridization and analysis. In general, the systems described herein for separating extra-cellular matrix bodies from a biological fluid may comprise a holder configured to receive the biological fluid, a robot configured to transfer the biological fluid from the holder to a microfluidic chip, a chip connector configured to hold at least one microfluidic chip, a manifold coupled to at least one microfluidic chip, and a negative pressure source coupled to the manifold. The negative pressure source may be configured to apply a negative pressure of between about 10 mm HG and about 760 mm HG to at least one microfluidic chip.

In some variations, the chip connector may comprise a base configured to contact a bottom portion of at least one microfluidic chip, and a cover configured to contact a top portion of at least one microfluidic chip. In some variations, the chip connector may be configured to distribute a compression force applied by the negative pressure to a perimeter of the microfluidic chip. In some variations, the bottom portion may comprise a perimeter of at least one microfluidic chip. In some variations, the cover may define a plurality of apertures. In some variations, the base may comprise a first fastener and the cover may comprise a second fastener. The first fastener and the second fastener may be configured to align the microfluidic chip in a predetermined orientation. In some variations, at least one inlet connector and at least one outlet connector may be disposed between the cover and the at least one microfluidic chip.

In some variations, at least one outlet connector may comprise an elongate body defining a lumen and comprising a plurality of steps along a length of the elongate body. In some variations, at least one outlet connector may comprise an elongate body defining a lumen having an inner diameter decreasing in a distal direction. In some variations, one or more the microfluidic chip, the inlet connector, and the outlet connector may comprise a disposable component. In some variations, the chip connector may comprise a durable component.

In some variations, the holder may be configured to receive one or more reagents, and the robot is configured to transfer one or more reagents from the holder to the microfluidic chip. In some variations, a sensor may be coupled to at least one inlet connector. The sensor may be configured to measure one or more of flow rate and pressure. In some variations, an optical sensor may be coupled to the chip connector. The optical sensor may be configured to image one or more of the microfluidic chips.

In some variations, at least one microfluidic chip may comprise at least one restriction channel fluidically coupled between an inlet and an outlet of the microfluidic chip. In some variations, the at least one restriction channel may comprise at least one obstruction. In some variations, the at least one restriction channel may comprise a length of between about 5 mm and about 30 mm. In some variations, each channel may comprise a cross-sectional dimension of between about 5 μm and about 30 μm. In some variations, at least one microfluidic chip may comprise at least one obstruction configured to restrict fluid flow. In some variations, at least one obstruction may comprise a pillar.

In some variations, the at least one microfluidic chip may comprise a restricted region configured to hold a first fraction of the biological fluid and permit fluid flow of a second fraction of the biological fluid. In some variations, the first fraction may comprise the ECMBs.

In some variations, the restricted region may comprise a plurality of obstructions configured to hold the first fraction. In some variations, a spacing between the plurality of obstructions in the restricted region decreases along a length of the microfluidic chip from an inlet of the restricted region to an outlet of the restricted region. In some variations, the spacing between the plurality of obstructions in the restricted region is between about 100 μm and about 4 μm. In some variations, each obstruction of the plurality of obstructions comprise a diameter of between about 50 μm and about 1 mm.

Also described here are methods of separating extra-cellular matrix bodies (ECMBs) from a biological fluid. In general, the methods comprise transferring the biological fluid to an inlet reservoir of a microfluidic chip, and applying negative pressure to the microfluidic chip. The microfluidic chip may comprise at least one restriction channel having an inlet and an outlet. The inlet reservoir may be fluidically coupled to the inlet of the at least one restriction channel, and at least one pillar, and an outlet reservoir. Negative pressure of between about 10 mm HG and about 760 mm HG may be applied to the outlet reservoir of the microfluidic chip where the ECMBs remain in the microfluidic chip after removal of the biological fluid from the microfluidic chip.

In some variations, a compression force applied by the negative pressure may be distributed from the outlet reservoir to a perimeter of the microfluidic chip. In some variations, the at least one restriction channel may comprise the at least one pillar. In some variations, the at least one restriction channel may comprise a length of between about 5 mm and about 30 mm. In some variations, the at least one restriction channel may comprise a cross-sectional dimension of between about 5 μm and about 30 μm. In some variations, the at least one microfluidic chip may comprise at least one obstruction configured to restrict fluid flow. In some variations, the at least one microfluidic chip may comprise a restricted region configured to hold a first fraction of the biological fluid and permit fluid flow of a second fraction of the biological fluid. In some variations, the restricted region may comprise a plurality of obstructions configured to hold the first fraction. In some variations, a spacing between the plurality of obstructions in the restricted region may decrease along a length of the microfluidic chip from an inlet of the restricted region to an outlet of the restricted region. In some variations, the spacing between the plurality of obstructions in the restricted region may be between about 100 μm and about 4 μm. In some variations, each obstruction of the plurality of obstructions may comprise a diameter of between about 50 μm and about 1 mm.

Once the ECMBs have been separated from a biological fluid, additional methods may then be used to analyze those ECMBs. For example, in some variations, one or more of a histochemical stain (including immunohistochemical (IHC) stains and multiplex IHC stains), a protein stain, a nucleic acid stain, chemical fixation, and a protease inhibitor may be applied to the ECMBs in the microfluidic chip. In some variations, one or more biomarkers in one or more of the biological fluid and the ECMBs may be measured by one or more of immunoassay, microscopy, immunohistochemistry, fluorescence in situ hybridization, immunofluorescence, infrared, and UV-VIS.

In some variations, the biological fluid removed from the microfluidic chip may be analyzed using one or more of microscopy, microfluidic device, mass spectrometry, microarray, nucleic acid amplification, hybridization, proteomic profiling, fluorescence hybridization, immunohistochemistry, nucleic acid analysis or sequencing, next generation sequencing, flow cytometry, chromatography, electrophoresis, immunostaining, fluorescence assay, fluorescent in situ hybridization (FISH), chelate complexation, quantitative HPLC, spectrophotometry, antibody array, Western blot, immunoassay, immunoprecipitation, ELISA, LC-MS, LC-MRM, radioimmunoassay, 2D gel mass spectrometry, LC-MS/MS, RT-PCR, and quantitative PCR.

In some variations, processing the biological fluid removed from the microfluidic chip may use one or more of microfluidic separation, affinity chromatography, centrifugation, differential centrifugation, density gradient centrifugation, mesh filtration, diafiltration, tangential flow filtration, membrane filtration, immuno-affinity capture, magnetic bead capture, size exclusion chromatography, electrophoresis, and AC electrokinetics.

In some variations, the biological fluid may comprise one or more of whole blood, blood plasma, blood serum, cerebrospinal fluid, intrathecal fluid, urine, saliva, sweat, tears, synovial fluid, pleural fluid, gastric fluid, peritoneal fluid, breast milk, nipple aspirate, semen, amniotic fluid, vitreous, aqueous humor, lymph, bile, cerumen, chyle, chyme, endolymph, perilymph, exudates, feces, ejaculate, gastric acid, gastric juice, mucus, pericardial fluid, pus, rheum, sebum, serous fluid, smegma, sputum, synovial fluid, vaginal secretion, menstrual effluent, and vomit, and fluids passed through one or more of tissues and gels.

### BRIEF DESCRIPTION OF THE DRAWINGS

FIG. 1 is a block diagram of an illustrative variation of a system.

FIGS. 2A-2C depict perspective views of an illustrative variation of a system. FIG. 2D depicts a side view of the system shown in FIG. 2C.

FIG. 3A depicts a plan view of an illustrative variation of a microfluidic chip. FIG. 3B depicts a cross-sectional side view of the microfluidic chip shown in FIG. 3A.

FIG. 3C depicts a plan view of an illustrative variation of a microfluidic chip array.

FIG. 4A depicts a perspective view of an illustrative variation of a chip connector. FIG. 4B depicts an exploded perspective view of a cover and a microfluidic chip shown in FIG. 4A. FIG. 4C depicts an exploded top perspective view of a base and a microfluidic chip shown in FIG. 4A. FIG. 4D depicts an exploded bottom perspective view of a base and a microfluidic chip shown in FIG. 4A.

FIGS. 5A-5E depict respective top perspective, bottom perspective, side, top, and bottom views of an illustrative variation of an outlet connector.

FIGS. 6A-6D depict respective top perspective, bottom perspective, top, and bottom views of an illustrative variation of an outlet connector.

FIG. 7 depicts a flowchart representation of an illustrative variation of separating ECMBs from a biological fluid.

FIGS. 8A and 8B are illustrative graphs of ECMB amounts based on microfluidic channel dimensions.

FIGS. 8C-8E are illustrative images of ECMBs on microfluidic chips having different channel dimensions.

FIG. 9 is an illustrative graph of fluid flow rate through a microfluidic chip with and without a chip connector.

FIG. 10A is an illustrative graph of set-up time of various outlet connector configurations.

FIG. 10B is an illustrative graph of experiment duration for staining procedures for a positive pressure system and a negative pressure system. FIG. 10C is an illustrative graph of abnormal morphology of various outlet connector configurations.

FIG. 11 is an illustrative graph of number of parallel experiments performed for a positive pressure system and a negative pressure system.

FIGS. 12A and 12B are illustrative images of biological contamination in a positive pressure microfluidic system. FIGS. 12C and 12D are illustrative images of biological contamination using the negative pressure systems described herein. FIG. 12E is an illustrative graph of biological contamination per area for a positive pressure system and the negative pressure system.

FIGS. 13A and 13B are illustrative graphs of ECMB amounts based on negative pressure. FIGS. 13C and 13D are illustrative images of ECMBs on microfluidic chips applied with different negative pressures.

FIGS. 14A, 14C, 14D, 14E, and 14I are illustrative graphs of ECMB amounts based on manifold ports. FIGS. 14B and 14J are illustrative graphs of ECMB amounts based on a pillar region. FIGS. 14F, 14G, and 14H are illustrative images of ECMBs on microfluidic chips applied with different negative pressures.

FIG. 15A is an illustrative graph of ECMB amounts based on a system with and without a manifold. FIG. 15B is an illustrative graph of ECMB amounts based on a pillar region and a system with and without a manifold.

FIGS. 16A and 16B are illustrative graphs of ECMB amounts based on negative pressure.

FIG. 17A are illustrative images of ECMBs on microfluidic chips perfused with a healthy (control) human aqueous humor sample.

FIG. 17B is an illustrative graph of ECMB amounts on microfluidic chips between a control sample and a primary open angle glaucoma (POAG) sample.

FIG. 18A depicts a plan view of another illustrative variation of a microfluidic chip. FIG. 18B depicts a perspective view of the microfluidic chip shown in FIG. 18A. FIG. 18C depicts a perspective view of the microfluidic chip shown in FIG. 18B coupled to a cover. FIG. 18D depicts a detailed plan view of the microfluidic chip shown in FIG. 18A.

FIG. 19A depicts a plan view of an illustrative variation of a multi-channel microfluidic chip. FIG. 19B depicts a detailed plan view of the microfluidic chip shown in FIG. 19A. FIG. 19C depicts a plan view of an illustrative variation of a multi-channel microfluidic chip array.

FIG. 20A depicts a plan view of another illustrative variation of a microfluidic chip. FIG. 20B depicts a detailed plan view of the microfluidic chip shown in FIG. 20A. FIG. 20C depicts a plan view of an illustrative variation of a microfluidic chip array. FIG. 20D depicts a perspective view of the microfluidic chip array shown in FIG. 20A coupled to a cover. FIG. 20E depicts a plan view of the cover shown in FIG. 20D. FIG. 20F depicts a plan view of the microfluidic chip array and the cover shown in FIG. 20D.

FIG. 21 depicts a plan view of another illustrative variation of a multi-channel microfluidic chip.

FIG. 22 depicts a perspective view of another illustrative variation of a chip connector.

FIG. 23 depicts a perspective view of an illustrative variation of a multi-chip chip connector.

FIGS. 24A-24D depicts a perspective view, top view, bottom view, and side view of an illustrative variation of an inlet connector.

FIGS. 25A-25D depicts a perspective view, top view, bottom view, and perspective side view of another illustrative variation of an inlet connector.

FIGS. 26A-26D depicts a perspective view, top view, bottom view, bottom perspective, and side view of another illustrative variation of an inlet connector.

FIGS. 27A-27D depicts a perspective view, top view, bottom view, and side view of an illustrative variation of an outlet connector.

FIGS. 28A-28D depicts a perspective view, top view, and bottom view of another illustrative variation of an outlet connector.

FIG. 29A is an illustrative image of fluid flow through a single channel microfluidic chip. FIG. 29B is an illustrative image of fluid flow through a channel of an 8-channel microfluidic chip.

FIG. 30A is an illustrative graph of non-laminar flow regions based on a single channel microfluidic chip and a multi-channel microfluidic chip. FIG. 30B is an illustrative graph of clogging rates based on a single channel microfluidic chip and a multi-channel microfluidic chip.

FIG. 30C is an illustrative graph of background noise based on a single channel microfluidic chip and a multi-channel microfluidic chip.

FIG. 31A is an illustrative image of staining artifacts possibly induced by non-laminar flow through a single channel microfluidic chip. FIG. 31B is an illustrative graph of artifact sizes based on a single channel microfluidic chip and a multi-channel microfluidic chip.

FIG. 32 is an illustrative graph of ECMB amounts on a microfluidic chip based on an inlet connector including silicone and an inlet connector absent silicone.

### DETAILED DESCRIPTION

Described here are systems, devices, and methods for separating ECMBs from a biological fluid (e.g., for analysis, etc.). For example, the systems, devices, and methods described herein may be useful for diagnosis, prognosis, and/or treating a subject by: separating, enriching, extracting, and/or immobilizing a predetermined fraction (e.g., ECMBs, proteins, nucleic acids, particles, materials, molecules, extracellular vesicles or soluble tissue microenvironments, proteins) from a biological fluid into a biological fluid fraction (e.g., isolate fraction) while preserving the fraction's composition and properties; improving a yield of a fraction from the biological fluid with reduced contamination to thereby improve a signal strength for a pathology of interest; identifying one or more of the fractions with a biomarker (e.g., proteins, genes, ECMB component) associated with a disease for disease target identification; and predicting a disease risk and/or medical condition based on an analysis of a plurality of biological fluid fractions.

Generally, the systems and devices described herein may separate ECMBs from a biological fluid in a manner that maintains their composition and properties to facilitate their use as biomarker(s) for disease diagnosis and/or monitoring of chemical or biological processes. For example, the systems and devices described herein may further be useful for: high-throughput, scalable, and automated microfluidic processing of biological fluids for histology; reduced compression of the microfluidic chip due to applied negative pressure based on distributed pressure; reduced clogging and increased laminar flow, flow rate consistency, and signal-to-noise ratio based on microfluidic chip channel density; reduced risk of contamination, set-up time, manual processing, and cleaning; visualization of ECMBs using immobilization and staining (e.g., histochemical, immunohistochemical) for one or more of spatial localization and profiling (e.g., protein, gene); and facilitating identification of disease ECMBs and physiologically normal ECMBs. Accordingly, biological fluid separation and histochemical analysis as described herein may be performed faster, cheaper, and with higher throughput (e.g., volume) than positive pressure microfluidic systems.

Generally, the systems and devices described herein may include microfluidic systems configured for biological assays of ECMBs of a biological fluid. For example, a microfluidic system may include a plurality of disposable microfluidic chips (e.g., microfluidic chip array) configured to receive a biological fluid (e.g., sample) from a robot that facilitates automation and high-throughput processing. The system may be configured to separate ECMBs from the biological fluid within the microfluidic chips using a negative pressure source coupled to the microfluidic chips. Separated ECMBs may be exposed to one or more reagents and buffers for histochemical staining and subsequent imaging and/or analysis. Accordingly, a plurality of biological samples may be processed in parallel by the microfluidic system.

For example, a system for separating extra-cellular matrix bodies (ECMBs) from a biological fluid may comprise a holder configured to receive the biological fluid, one or more robots configured to transfer the biological fluid from the holder to a microfluidic chip, a chip connector configured to hold at least one microfluidic chip, a manifold coupled to the at least one microfluidic chip, and a negative pressure source coupled to the manifold. The negative pressure source may be configured to apply a negative pressure of between about 10 mm HG and about 760 mm HG to the at least one microfluidic chip. In some variations, the system may comprise a plurality of holders, a plurality of chip connectors, a plurality of manifolds, a plurality of negative pressure sources, a plurality of reservoirs, a plurality of robots, and the like.

The negative pressure system of the devices and systems described herein help enable high-throughput, low contamination separation of ECMBs from biological fluid. In this way, a plurality of samples may be processed (e.g., undergo ECMB separation) and analyzed in an automated manner in parallel, thereby greatly reducing the time and effort associated with positive pressure microfluidic systems and methods. For example, negative pressure may be distributed evenly to a plurality of microfluidic chips in parallel using a manifold to provide consistent fluid flow and reproducible results. Furthermore, negative pressure applied at an outlet of a microfluidic chip enables an inlet of the microfluidic chip to be available for a robot to transfer fluids into such inlet, thereby increasing throughput and consistency, and reducing manual labor. However, modifying positive pressure microfluidic systems to apply a negative pressure to a microfluidic chip and sample would compromise the composition and properties of the biological fluid, as well as the structural integrity of the microfluidic chip, so as to hinder separation, enrichment, and/or extraction of the biological fluid into a useable biological fluid fraction. That is, applying negative pressure to positive pressure microfluidic chips and systems would generate unpredictable results without the innovations described herein.

A biological fluid may comprise one or more of human or animal bodily fluids, tissue, cells, whole blood, blood plasma, blood serum, cerebrospinal fluid, intrathecal fluid, urine, saliva, sweat, tears, synovial fluid, pleural fluid, gastric fluid, peritoneal fluid, breast milk, nipple aspirate, semen, amniotic fluid, vitreous, aqueous humor, lymph, bile, cerumen, chyle, chyme, endolymph, perilymph, exudates, feces, ejaculate, gastric acid, gastric juice, mucus, pericardial fluid, pus, rheum, sebum, serous fluid, smegma, sputum, synovial fluid, vaginal secretion, menstrual effluent, vomit, tumors, carriers, reagents, solutions, binding moieties, and the like.

A buffer may comprise one or more of MES, HCL acid buffer, Acid Phthalate buffer, Alkaline borate buffer, Acetate buffer, Acetic ammonia buffer, acetone buffer, ammonia buffer, barbitone buffer, buffered copper sulfate solution, glycerin solution, glycine buffer solution, palladium chloride buffer solution, citric acid Na2HPO4, citric acid Sodium Citrate Buffer Preparation, Sodium Acetate Acetic Acid Buffer Preparation, Na2HPO4-NaH2PO4, Imidazole (glyoxaline), Sodium Carbonate, TBE, TAE, BIS-TRIS, Bis-Tris propane, Phosphate buffer, formic acid, Pyridine and conjugate acid, Ammonia and conjugate acid, Methylamine and conjugate acid, ADA, ACES, PIPES, MOPSO, BES, MOPS, TES, HEPES, DIPSO, MOBS, TAPSO, Tris, Trizma, HEPPSO, POPSO, TEA, EPPS, Tricine, Gly-Gly, Bicine, HEPBS, TAPS, AMPD, TABS, AMPSO, CHES, CAPSO, AMP, CAPS, CABS, and the like.

Some microfluidic chips and systems suitable for use in the systems here are described in International Patent Application No. PCT/US2021/023827, filed Mar. 24, 2021, and titled “DEVICE AND METHODS FOR ISOLATING EXTRACELLULAR MATRIX BODIES,” International Patent Application No. PCT/US2019/052310, filed Sep. 21, 2019, and titled “COMPOSITIONS AND METHODS FOR GLAUCOMA,” each of which is hereby incorporated by reference in its entirety.

### I. Systems and Devices

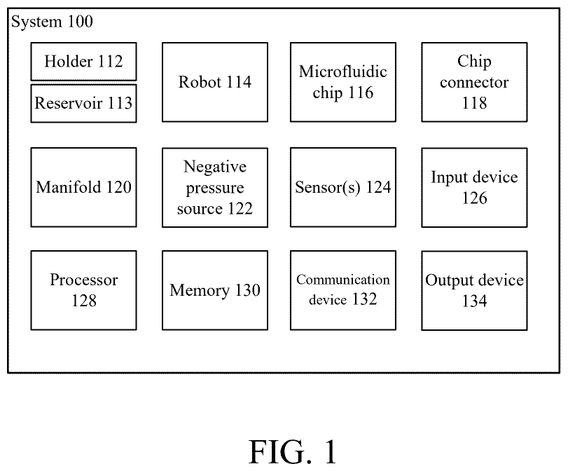

Generally, the systems and devices described herein may provide high-throughput separation of extracellular matrix bodies from a biological fluid. The separated ECMBs and remaining biological fluid (or portions or fractions thereof) may then be used for diagnosing, prognosing, or in helping to determine a treatment plan for a subject, and the effectiveness of such treatment plan. A block diagram of an exemplary system 100 is depicted in FIG. 1. The system 100 may comprise one or more of a holder 112, a reservoir 113, a robot 114, at least one microfluidic chip 116, a chip connector 118, a manifold 120, a negative pressure source 122, one or more sensors 124, an input device 126, a processor 128, a memory 130, a communication device 132, and an output device 134, each of which are described in more detail herein.

In some variations, the holder 112 (e.g., material storage) may be configured to store one or more fluids (e.g., biological fluid) for transfer to the microfluidic chip(s) 116. The holder 112 may comprise one or more of a tray and container. In some variations, the reservoir 113 may be configured to receive a predetermined fraction of the biological fluid (e.g., waste fluid) from the microfluidic chip 116. For example, a non-ECMB fraction of the biological fluid may be transferred to and stored in the reservoir 113 for further processing (e.g., separation, analysis) and/or disposal. Additionally or alternatively, the system 100 may comprise one or more preprocessing components such as a material separation assembly, aliquoting assembly, a biorepository, and the like.

In some variations, the robot 114 may be configured to transfer fluids (e.g., biological fluid, reagent) from holder 112 to at least one microfluidic chip 116. In some variations, the microfluidic chip 116 may be configured to receive and process a biological fluid. For example, the microfluidic chip 116 may include a channel (e.g., microfluidic channel) and at least one obstruction (e.g., pillar) configured to separate and hold (e.g., trap) a predetermined fraction of a biological fluid within the microfluidic chip 116 while the remaining fraction flows out of the microfluidic chip 116. In some variations, the chip connector 118 may be configured to hold at least one microfluidic chip 116. The microfluidic chip 116 may be releasably coupled to the chip connector 118 to facilitate cleaning and help reduce set-up time. For example, the microfluidic chip 116 may be a disposable component and the chip connector 118 may be a durable component. In some variations, the chip connector 118 may comprise disposable connectors (e.g., inlet connector, outlet connector) configured to facilitate negative pressure applied to the microfluidic chip 116 by the negative pressure source 122 in order to perfuse and flow the biological fluid through the microfluid chip 116.

In some variations, the manifold 120 may be configured to couple to at least one microfluidic chip 116. In some variations, the negative pressure source 122 may be configured to couple to the manifold 120. In this manner, a single manifold 120 may be fluidically coupled to a plurality of microfluidic chips 116 to facilitate application of negative pressure (e.g., vacuum, suction) to the plurality of microfluidic chips 116 using a single negative pressure source 122.

In some variations, the sensor 124 may comprise one or more sensors configured to measure one or more characteristics (e.g., pressure, flow rate, optical image, temperature, humidity) corresponding to one or more of the biological fluid and components of the system 100, 200. In some variations, the input device 126 may be configured to generate an input signal based on an operator input. In some variations, the processor 128 and memory 130 may be configured to control the system 100, 200. In some variations, the communication device 132 may be configured to communicate with one or more components of the system 100, 200 as well as with networks and other computer systems. In some variations, the output device 134 may be configured to output data corresponding to the system 100, 200 such as images of the biological fluid within the microfluidic chip 116, flow rates, and the like.

In some variations, the system 100, 200 may be configured to perform multiple assays such as ELISA, immunoassay, microscopy, immunohistochemistry, fluorescence in situ hybridization, immunofluorescence, infrared, UV-VIS, Raman, NMR, mass spectrometry, NG sequencing, protein array, ribonucleic acid array, gene array, qPCR, RT-qPCR, RT-PCR, and the like. In some variations, the microfluidic chip 116 may be analyzed by the system 100, 200 and/or removed and analyzed using another device (e.g., multi-well plate, microscope slide). Examples of imaging techniques include electron microscopy, stereoscopic microscopy, wide-field microscopy, bright-field microscopy, phase-contrast microscopy, polarizing microscopy, phase contrast microscopy, multiphoton microscopy, differential interference contrast microscopy, fluorescence microscopy, laser scanning confocal microscopy, multiphoton excitation microscopy, ray microscopy, ultrasonic microscopy, positron emission tomography, computerized tomography, and magnetic resonance imaging.

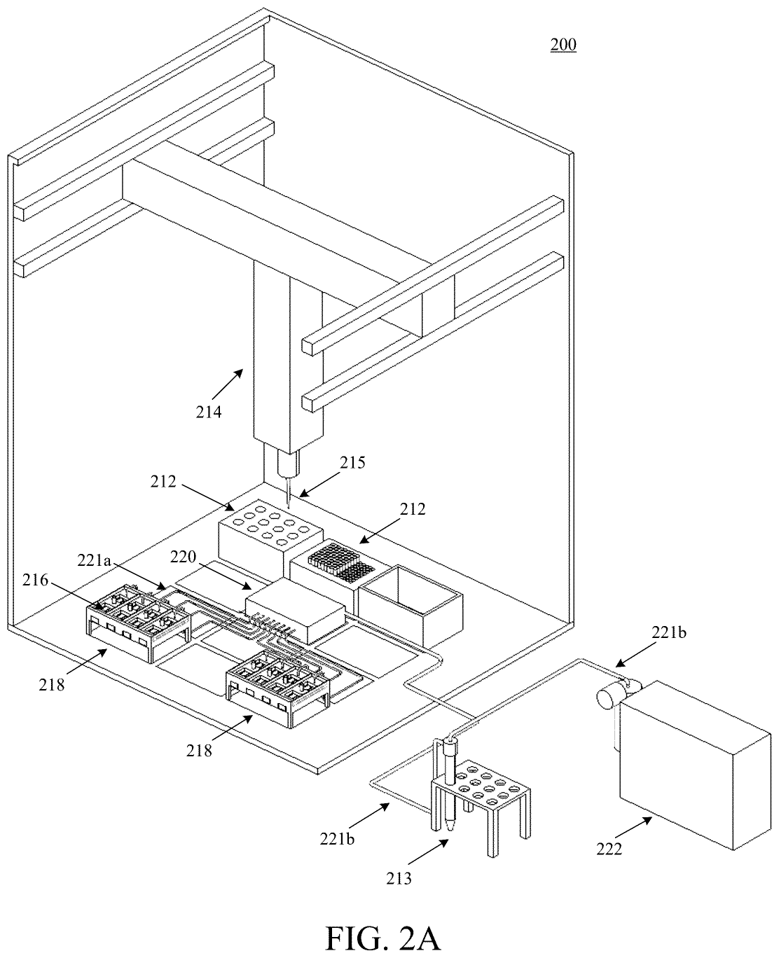

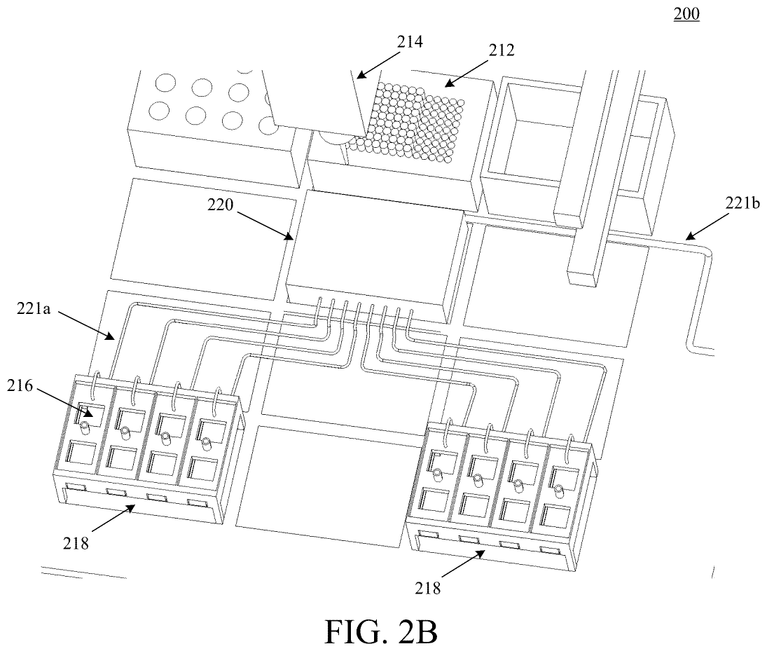

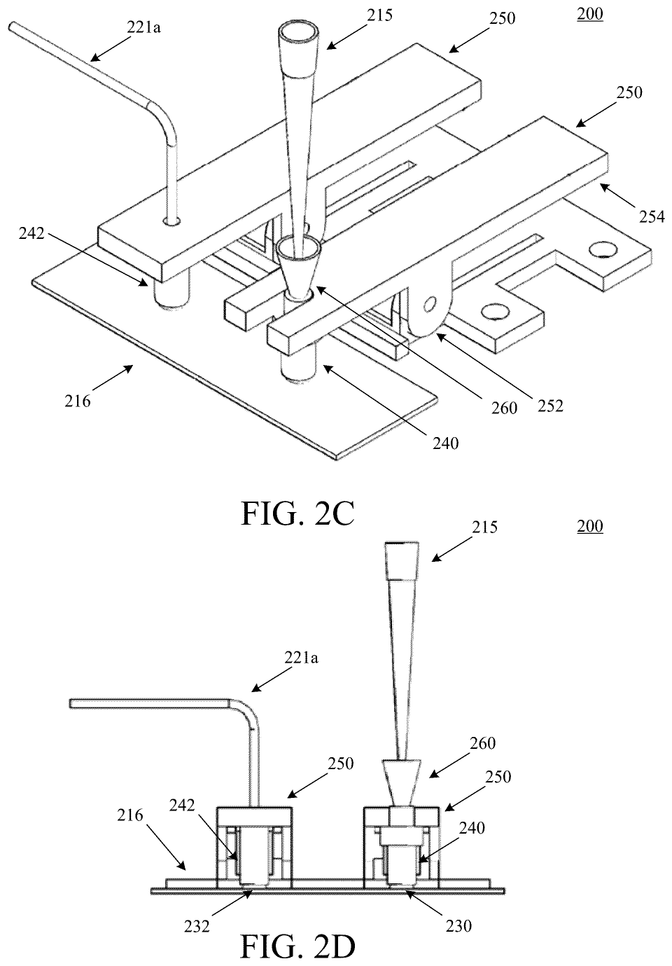

FIGS. 2A and 2B are perspective views of a system 200 comprising a holder 212, a reservoir 213, a robot 214, an end effector 215 (e.g., pipette) coupled to the robot 214, a plurality of chip connectors 218 with each chip connector 218 holding a plurality microfluidic chips 216, a manifold 220 including a plurality of fluid conduits 221a, 221b, and a negative pressure source 222. The system 200 may include a sensor, an input device, a processor, a memory, a communication device, and an output device as described with respect to FIG. 1, but are not shown in FIGS. 2A-2D for the sake of clarity. In some variations, the end effector 215 may comprise a plurality of pipettes configured to transfer fluid(s) stored in the holder 212 to the microfluidic chips 216 held in respective chip connectors 218. In some variations, the system 200 may include a plurality of robots 214. For example, a first robot may be configured to transfer biological fluids, a second robot (not shown for the sake of clarity) may be configured to transfer reagents, and a third robot (not shown for the sake of clarity) may be configured to releasably couple the microfluidic chips 216 from respective chip connectors 218. The third robot may be configured to assemble and disassemble the disposable components including the microfluidic chips 216 from the durable components (e.g., chip connector 218) of the system 200 to reduce manual labor and/or reduce contamination. In FIG. 2A, each microfluidic chip 216 is coupled to a respective fluid conduit 221a, each of which is coupled to the manifold 220. A single fluid conduit 221b may couple the manifold 220 to the reservoir 213 and negative pressure source 222.

In some variations, one or more fluids may be loaded from the holder 212 to a respective inlet of a plurality of microfluidic chips 216 using the robot 214. The negative pressure source 222 may apply suction to each of the microfluidic chips 216 via the manifold 220 and fluid conduits 221a, 221b. The fluid at the inlet (e.g., inlet reservoir) may be pulled toward the respective outlet of the microfluidic chip 216 while ECMBs remain in the microfluidic chip 216. The separated non-ECMB fluid is pulled through the fluid conduits 221a, 221b and manifold 220 and received at the reservoir 213 (e.g., waste disposal).

FIG. 2C is a detailed perspective view and FIG. 2D is a corresponding detailed side view of system 200 including the end effector 215 (e.g., pipette), the microfluidic chip 216, the fluid conduit 221a, an inlet connector 240, an outlet connector 242, and optionally, a clamp 250 and a funnel 260. The chip connector 218 and robot 214 are not shown in FIGS. 2C and 2D for the sake of clarity.

The inlet connector 240 may be coupled between an inlet 230 of the microfluidic chip 216 and one or more of the end effector 215 and the funnel 260. In some variations, the funnel 260 may be configured to receive the end effector 215 using the robot 214. For example, the funnel 260 may be configured to receive and/or guide fluid being transferred to the microfluidic chip 216 from the end effector 215. The outlet connector 242 may be coupled between an outlet 232 of the microfluidic chip 216 and the fluid conduit 221a. In some variations, the fluid conduit 221a may be configured to receive fluid being transferred from the microfluidic chip 216 to the reservoir 213 (e.g., via negative pressure).

In some variations, one or more clamps 250 may be configured to releasably couple (e.g., secure, hold) the inlet connector 240 and the outlet connector 242, respectively, to the microfluidic chip 216. For example, the clamp 250 may comprise one or more springs (not shown) and a hinge 252 configured to provide a predetermined force to hold the respective inlet connector 240 and outlet connector 242 in place relative to the microfluidic chip 216. In some variations, a portion 254 (e.g., actuator) of the clamp 250 may be actuated (e.g., pushed down by a robot or operator) to release one or more of the inlet connector 240 and the outlet connector 242 to facilitate removal of the microfluidic chip 216 from the chip connector 218.

### A. Holder

The systems described herein may comprise a holder 112, 212 configured to receive one or more fluids. In some variations, the holder 112, 212 may be configured to receive and store a plurality of fluids including a biological fluid (e.g., sample) and one or more reagents. Examples of reagents include a buffer, a lysing solution, a nucleic acid cleavage agent, a cleavage inhibitor, a precipitation agent, a fixative reagent, a carrier fluid, a biofluid, water, purified water, a saline solution, an organic solvent, a gelling agent, a surfactant, a ligand for binding or associating with a component of an ECMB, combinations thereof, and reagents for interacting with biological components of the sample. In some variations, the reagent may include one or more reagents for measuring a biomarker level or quantity, or for comparing a biomarker level to a control. In some variations, the holder 112, 212 may comprise a plurality of reservoirs to separately store each fluid without mixing. Fluids may include any suitable fluids, including for example biological fluids for sampling, and/or one or more fluids useful in analysis. Biological fluids for sampling may include, for example, one or more of human or animal bodily fluids, tissue, cells, whole blood, blood plasma, blood serum, cerebrospinal fluid, intrathecal fluid, urine, saliva, sweat, tears, synovial fluid, pleural fluid, gastric fluid, peritoneal fluid, breast milk, nipple aspirate, semen, amniotic fluid, vitreous, aqueous humor, lymph, bile, cerumen, chyle, chyme, endolymph, perilymph, exudates, feces, ejaculate, gastric acid, gastric juice, mucus, pericardial fluid, pus, rheum, sebum, serous fluid, smegma, sputum, synovial fluid, vaginal secretion, menstrual effluent, vomit, tumors, carriers, reagents, solutions, binding moieties, and the like. Biological fluids useful in analysis may include carriers, reagents, binding moieties, and the like. The holder 112, 212 may be disposed within the system 100, 200 at a location within reach of the robot 114, 214. For example, the holder 112, 212 may be configured to receive a plurality of pipettes coupled to the robot 114, 214 for transfer of a plurality of fluids from the holder 112, 212 to a plurality of microfluidic chips 116, 216.

### B. Robot

The systems described herein may comprise one or more robots 114, 214. Generally, a robot 114, 214 may be configured to move and transfer one or more fluids (e.g., biological fluid, reagent, antibodies, buffer) between a holder 112, 212 and at least one microfluidic chip 116, 216. For example, the robot 114, 214 may be configured to automatically load at least one microfluidic chip 116, 216 with fluids absent manual (e.g., human) intervention. In some variations, the robot 114, 214 may be coupled to an end effector 215 comprising one or more pipettes (e.g., micro-pipette, multi-channel pipette) configured to transfer a fluid (e.g., biological fluid, reagent) from the holder 112, 212 to at least one microfluidic chip 116, 216 (e.g., through an inlet connector 240 of a chip connector 118, 218). For example, a biological fluid from a subject may be first transferred from the holder 112, 212 to a plurality of microfluidic chips 116, 216 using the robot 114, 214. Then, different reagents may be transferred from the holder 112, 212 to predetermined microfluidic chips 116, 216 using the robot 114, 214 for different processing (e.g., different histochemical stains). The robot 114, 214 may be coupled to the processor 128 and memory 130 to control a type and volume of fluid transferred using one or more of the pipettes. In some variations, the end effector 215 may be configured to releasably couple (e.g., assemble, disassemble) the disposable components from the durable components of the system 200. Additionally or alternatively, the system 100 may comprise one or more material transport components such as a track and container configured to translate along the track.

In some variations, the robot 114, 214 may be configured to removably couple a microfluidic chip 116, 216 to one or more of a chip connector 118, 218 and a negative pressure source 122, 222. For example, the robot 114, 214 may be configured to couple a microfluidic chip 116, 216 to a chip connector 118, 218 such that the microfluidic chip 116, 216 is fluidically coupled to the manifold 120, 220 and negative pressure source 122, 222. Furthermore, robot 114, 214 may be configured to releasably couple other components (e.g., inlet connector, outlet connector) to the microfluidic chip 116, 216. Conversely, the robot 114, 214 may be configured to de-couple the microfluidic chip 116, 216 from the chip connector 118, 218 for transfer to another device (e.g., microscope slide, imaging system, analysis system). In some variations, the robot 114, 214 may be configured to remove one or more of the holder 112, 212 and reservoir 113, 213 from the system 100, 200 (e.g., to replace with a different holder 112, 212 and reservoir 113, 213). Automated system set-up, fluid transfer, and cleaning using the robot 114, 214 may, among other benefits, reduce contamination and human error, and increase consistency and throughput.

In some variations, the robot 114, 214 may be, for example, a linear robot arm, an articulated robotic arm, and/or a SCARA robotic arm. The robot 114, 214 may comprise one or more segments coupled together by a joint (e.g., shoulder, elbow, wrist) configured to provide a single degree of freedom. Joints are mechanisms that provide a single translational or rotational degrees of freedom. For example, the robot 114, 214 may have six or more degrees of freedom. The set of Cartesian degrees of freedom may be represented by three translational (position) variables (e.g., surge, heave, sway) and by the three rotational (orientation) variables (e.g., roll, pitch, yaw). In some variations, the robot 114, 214 may have less than six degrees of freedom.

In some variations, the robot 114, 214 may be configured to move over all areas of a system 100, 200 in up to three dimensions. The robot 114, 214 may comprise one or more motors configured to translate and/or rotate the joints and move the robot 114, 214 to a desired location and orientation. In some variations, the position of the robot may be temporarily locked when delivering fluid to a predetermined microfluidic chip or when one or more microfluidic chips 116, 216 are being removed from a chip connector 118, 218 (e.g., for transfer to a microscope or other imaging system). The robot 114, 214 may be mounted to any suitable object, such as a platform (e.g., table), a wall, a ceiling, or may be self-standing (e.g., on the ground). Additionally or alternatively, the robot 114, 214 may be configured to be moved manually.

### C. Microfluidic Chip

The systems described herein may comprise one or more microfluidic chips 116, 216. Generally, a microfluidic chip 116, 216 may be configured to receive and process one or more fluids. In some variations, a microfluidic chip 116, 216 may comprise an inlet reservoir, at least one channel (e.g., restriction channel, uniform flow channel), at least one obstruction (e.g., pillar) configured to restrict fluid flow, and an outlet reservoir. The restriction channel may include an inlet and an outlet. The inlet reservoir may be fluidically coupled to the inlet of the restriction channel, and the outlet of the restriction channel may be fluidically coupled to the outlet reservoir. The inlet reservoir may be configured to receive and store fluid transferred from robot 114, 214. The microfluidic chip 116, 216 may be configured to process a biological fluid through the channel while receiving negative pressure from an outlet (e.g., outlet reservoir) of the microfluidic chip 116, 216.

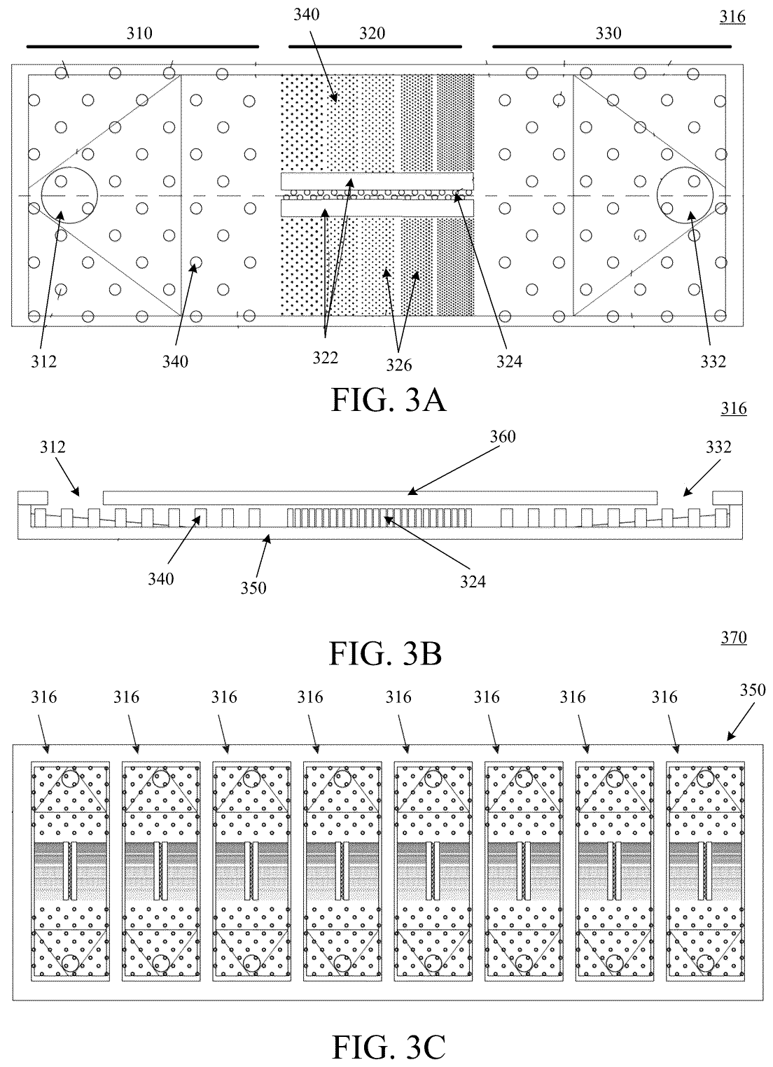

FIGS. 3A and 3B are respective plan and cross-sectional side views of a microfluidic chip 316 comprising an inlet reservoir 310, an outlet reservoir 330, and a restricted region 320 (e.g., filter region) in fluid communication with the inlet reservoir 310 and the outlet reservoir 330. The inlet reservoir 310 may include an inlet 312 (e.g., opening) and at least one obstruction 340 (e.g., pillar). Likewise, the outlet reservoir 330 may include an outlet 332 (e.g., opening) and at least one obstruction 340. The size, shape, and spacing of the obstructions 340 in the inlet reservoir 310 and outlet reservoir 330 may be the same or different. In some variations, fluid may be received at inlet 312 and flow through the restricted region 320 toward the outlet 332. A fluid conduit coupled to a manifold and a negative pressure source (not shown in FIGS. 3A-3C) may be coupled to the outlet 332. The suction applied by the negative pressure source through the outlet 332 may pull fluid received at the inlet 312 through the inlet reservoir 310, restriction region 320, and the outlet reservoir 330.

In some variations, the restricted region 320 may be configured to restrict fluid flow so as to separate and hold (e.g., trap) a first fraction of the fluid within the restricted region 320 of the microfluidic chip 316 while a remaining second fraction of the fluid is permitted to flow out of the microfluidic chip 316 via the negative pressure applied to the microfluidic chip 316. In some variations, the first fraction of the fluid may include ECMBs. As shown in FIG. 3A, the restricted region 320 may include flow barriers 322 that define the restriction channel 324 (e.g., uniform flow channel) and a plurality of obstructions 340 (e.g., pillars) having a plurality of spacings 326. The restriction channel 324 may be linear and have a length at least equal to a length of the restricted region 320. In some variations, one or more of laminar flow and flow rate consistency may be based on a length of the restriction channel 324. For example, a restriction channel 324 that does not extend into one or more of the inlet reservoir 310 and the outlet reservoir 330 may increase one or more of laminar flow and flow rate consistency throughout the microfluidic chip (e.g., along a width and length of the microfluidic chip 316).

The plurality of obstructions 340 within the restricted region 320 may be configured to restrict (e.g., impede) fluid flow and hold the first fraction of the biological fluid. For example, a spacing between the plurality of obstructions 340 in the restricted region 320 may decrease along a length of the microfluidic chip 316 from an inlet of the restricted region 320 to an outlet of the restricted region 320. In some variations, the spacing between the plurality of obstructions 340 in the restricted region 320 may be between about 100 μm and about 4 μm. For example, the spacing between obstructions 340 at an inlet of the restricted region 320 may be about 100 μm whereas the spacing between obstructions 340 at an outlet of the restricted region 320 may be about 4 μm. In some variations, the spacing may vary in stepwise increments. For example, the spacing may decrease in order from about 100 μm to about 50 μm to about 25 μm to about 15 μm and to about 4 μm. Additionally or alternatively, the spacing between obstructions 340 may vary continuously along a length of the restricted region 320. In some variations, a larger proportion of ECMBs may be captured within the portions of the restricted region 320 having smaller spacing.

The restriction channel 324 may have a length of between about 5 mm and about 30 mm, between about 10 mm and about 30 mm, between about 15 mm and about 30 mm, between about 20 mm and about 30 mm, between about 5 mm and about 25 mm, between about 5 mm and about 20 mm, about 15 mm, about 20 mm, about 25 mm, about 30 mm, including all ranges and sub-values in-between. The restriction channel 324 may have a cross-sectional dimension of between about 5 μm and about 30 μm, between about 10 μm and about 30 μm, between about 15 μm and about 30 μm, between about 20 μm and about 30 μm, between about 5 μm and about 25 μm, between about 5 μm and about 20 μm, about 15 μm, about 20 μm, about 25 μm, about 30 μm, including all ranges and sub-values in-between. In some variations, the restriction channel 324 may comprise at least one obstruction. The plurality of obstructions 340 may comprise a diameter of about 50 μm and about 1 mm.

As shown in the cross-sectional side view of FIG. 3B, the microfluidic chip 316 may comprise a substrate 350 coupled to a cover 360 (e.g., top plate, glass slide). The cover 360 placed over and on top of the substrate 350 facilitates processing of fluids through the microfluidic chip 316. For example, the cover 360 may be configured to enclose the substrate 350 (e.g., including inlet reservoir 310, restricted region 320, and outlet reservoir 330), except for one or more inlets 312 and one or more outlets 332. In some variations, the substrate 350 may comprise a plurality of microfluidic chips 316. For example, FIG. 3C illustrates a set of eight microfluidic chips 316 disposed in parallel on a substrate 350. In this manner, a single microfluidic chip array 370 may be used to separately (e.g., individually) process a plurality of fluid samples, thereby increasing throughput and efficiency, as well as reducing a size of the system. For example, a microfluidic chip array 370 having eight microfluidic chips 316 may enable independent ECMB separation for eight fluid samples using any combination of histology stains, immunohistochemical (IHC) stains, reagents, and the like. In some variations, the substrate 350 may comprise suitable materials including one or more silicon-based polymers (e.g., Polydimethylsiloxane (PDMS)), other polymers, thermoplastics, thermoplastic elastomers, hydrogels, paper, and glass.

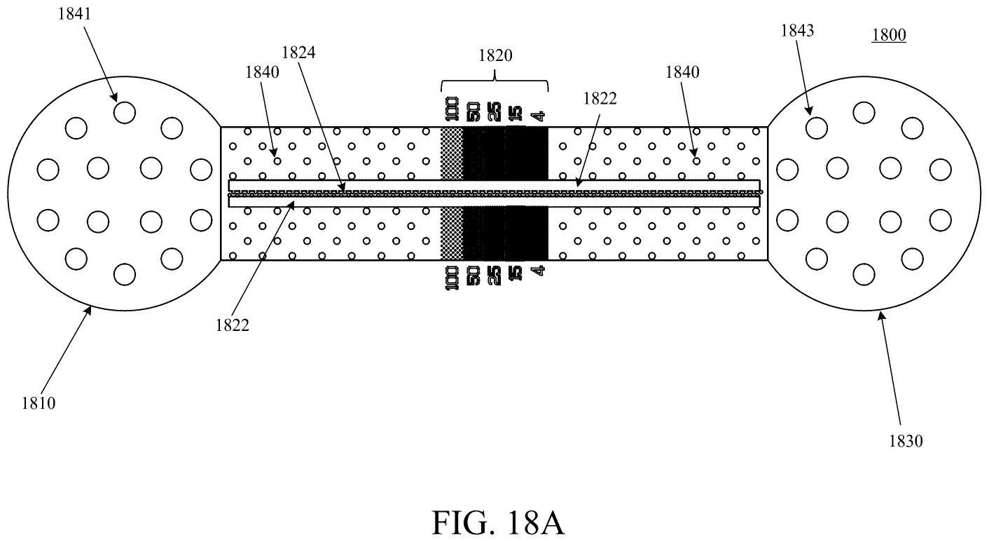

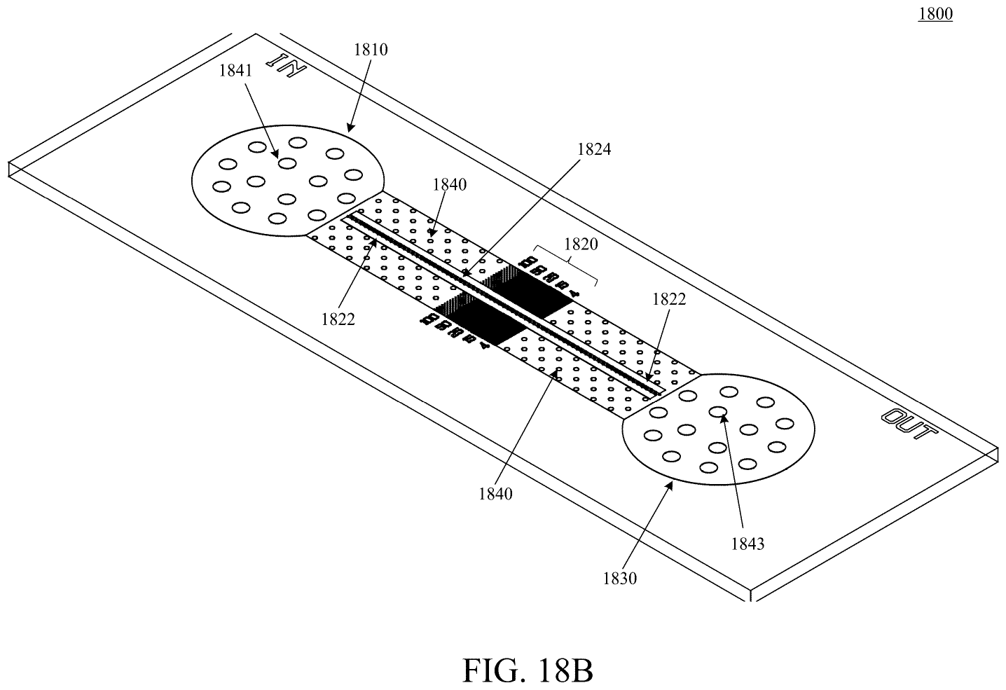

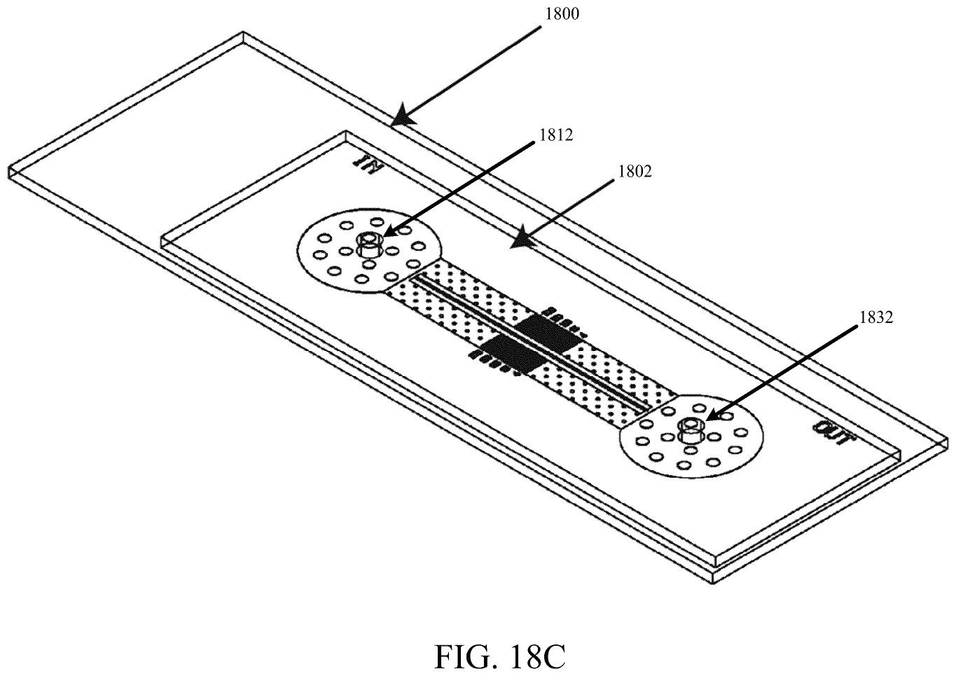

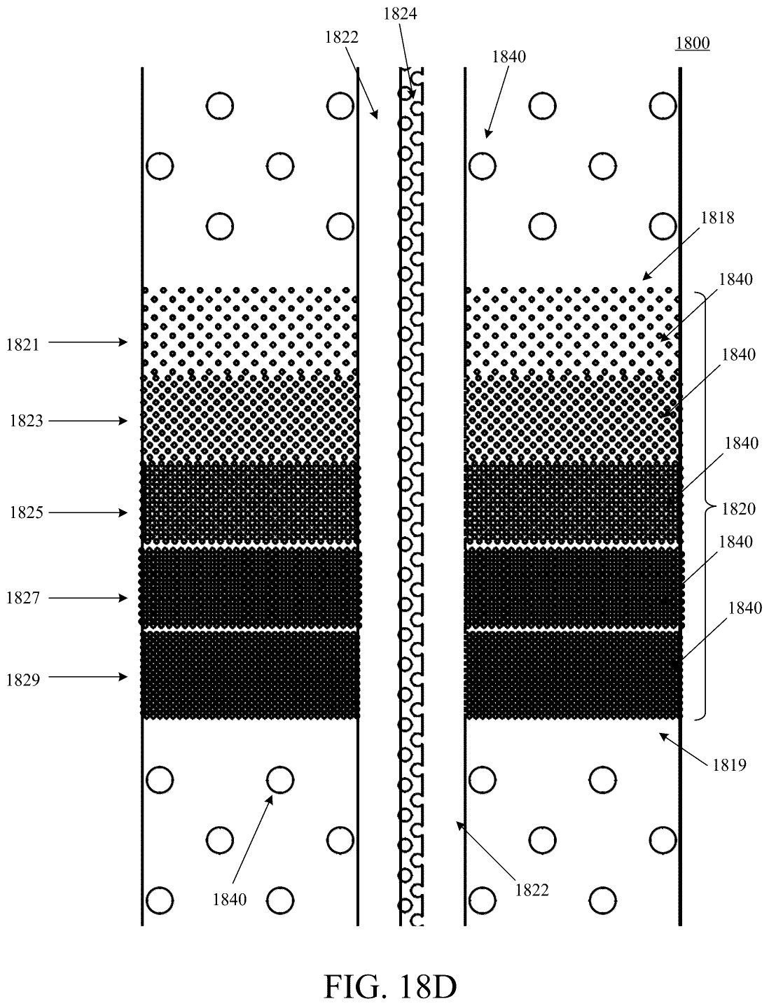

In some variations, a restriction channel may extend beyond a length of a restricted region. For example, FIGS. 18A and 18B depict a respective plan view and perspective view of a microfluidic chip 1800 including an inlet reservoir 1810, an outlet reservoir 1830, and a restricted region 1820 (e.g., filter region) in fluid communication between the inlet reservoir 1810 and the outlet reservoir 1830. The inlet reservoir 1810 may include at least one inlet obstruction 1841, and the outlet reservoir 1830 may include at least one outlet obstruction 1843. The inlet reservoir 1810 and the outlet reservoir 1830 may have a generally circular shape. FIG. 18C depicts the microfluidic chip 1800 coupled to a cover 1802. In some variations, the cover 1802 may comprise an inlet 1812 in fluid communication with the inlet reservoir 1810 of the microfluidic chip 1800 and an outlet 1832 in fluid communication with the outlet reservoir 1830. A plurality of obstructions 1840 may be disposed between the inlet reservoir 1810 and the outlet reservoir 1830. Similar to the microfluidic chip 316, the restricted region 1820 may be configured to restrict fluid flow so as to separate and hold (e.g., trap) a first fraction of the fluid within the restricted region 1820 of the microfluidic chip 1800 while a remaining second fraction of the fluid is permitted to flow out of the microfluidic chip 1800 via the negative pressure applied to the microfluidic chip 1800. In some variations, the first fraction of the fluid may include ECMBs. The restricted region 1820 may include flow barriers 1822 that define the restriction channel 1824 (e.g., uniform flow channel) and a plurality of obstructions 1840 (e.g., pillars) having a plurality of spacings 1826, as described in more detail with respect to FIG. 18D. The restriction channel 1824 may be linear and have a length greater than a length of the restricted region 1820. The restriction channel 1824 may be configured to facilitate fluid flow through the microfluidic chip 1800 when negative pressure is applied to the outlet 1832 of the microfluidic chip 1800. For example, the restriction channel 1824 may reduce the formation of air bubbles in the microfluidic chip 1800.

The plurality of obstructions 1840 within the restricted region 1820 may be configured to restrict (e.g., impede) fluid flow and hold the first fraction of the biological fluid for analysis (e.g., image analysis). For example, FIG. 18D provides a detailed view of the restricted region 1820 of the microfluidic chip 1800 including the fluid barriers 1822, restriction channel 1824, and a plurality of spacings 1821-1829. In some variations, a spacing between the plurality of obstructions 1840 in the restricted region 1820 may decrease along a length of the microfluidic chip 1800 from an inlet 1818 of the restricted region 1820 to an outlet 1819 of the restricted region 1820. In some variations, the spacing between the plurality of obstructions 1840 in the restricted region 1820 may be between about 100 μm and about 4 μm. For example, a first spacing 1821 between obstructions 1840 at an inlet 1818 of the restricted region 1820 may be about 100 μm, followed by a second spacing 1823 of about 50 μm, a third spacing 1825 of about 25 μm, a fourth spacing 1827 of about 15 μm, and a fifth spacing 1829 of about 4 μm at an outlet of the restricted region 1820. The length of each spacing as well as a diameter of the obstructions 1840 may be the same or different. In some variations, the restricted region 1820 may extend across a width of the microfluidic chip 1800 except for the fluid barriers 1822 and restriction channel 1824.

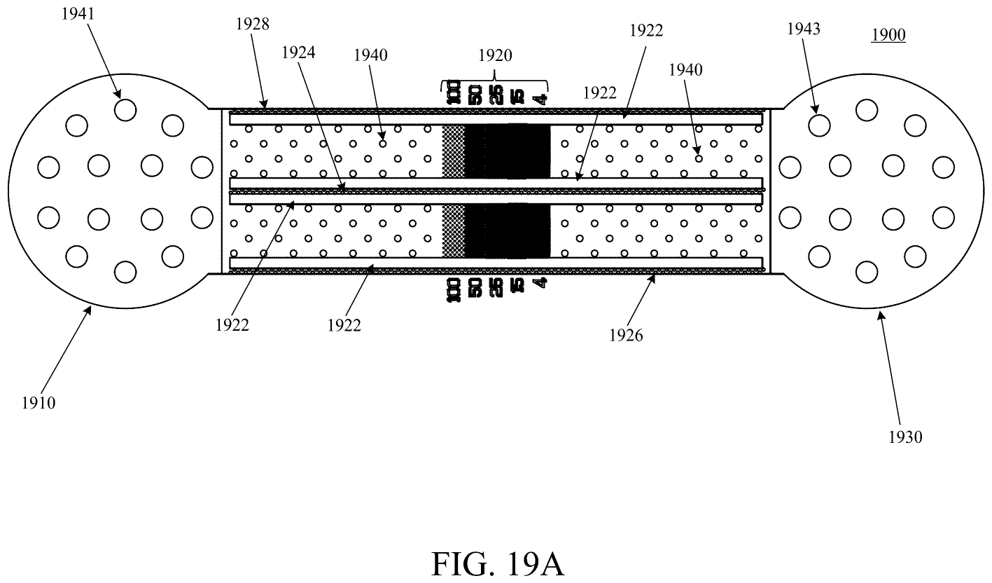

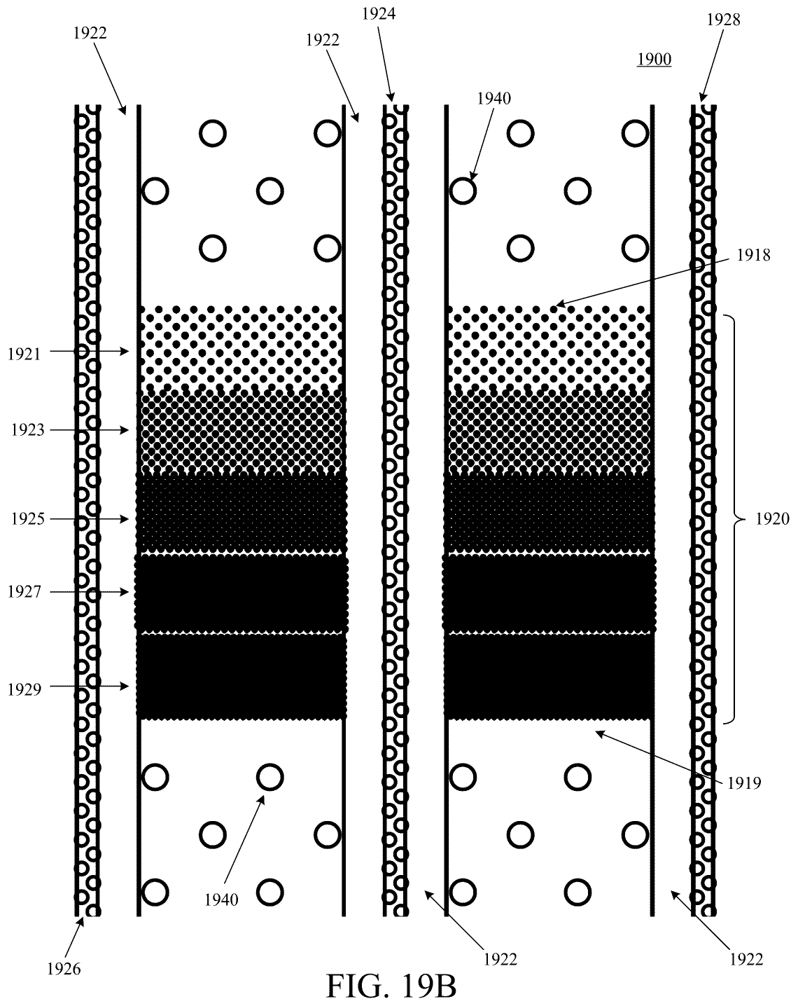

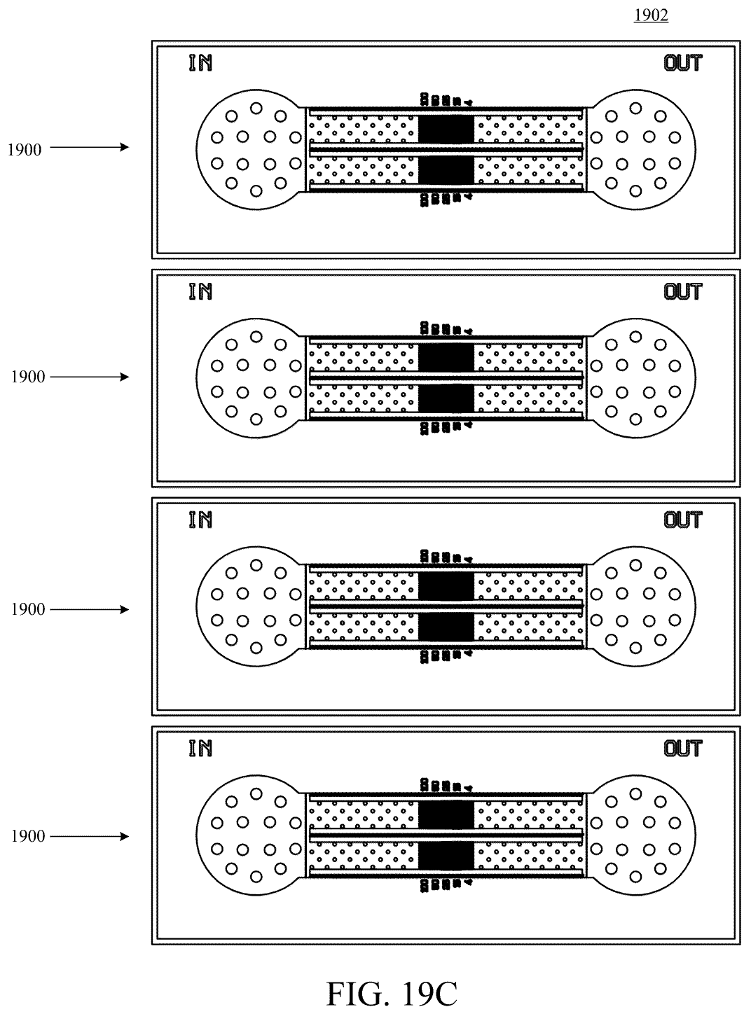

In some variations, a microfluidic chip may include a plurality of restriction channels to promote fluid flow and reduce formation of air bubbles and clogging within the microfluidic chip. For example, FIGS. 19A and 19B depict plan views of a multi-restriction channel microfluidic chip 1900 including an inlet reservoir 1910, an outlet reservoir 1930, and a restricted region 1920 (e.g., filter region) in fluid communication between the inlet reservoir 1910 and the outlet reservoir 1930. The inlet reservoir 1910 may include at least one inlet obstruction 1941, and the outlet reservoir 1930 may include at least one outlet obstruction 1943. The inlet reservoir 1910 and the outlet reservoir 1930 may have a generally circular shape. A plurality of obstructions 1940 may be disposed between the inlet reservoir 1910 and the outlet reservoir 1930. Similar to the microfluidic chips 316, 1800, the restricted region 1920 may be configured to restrict fluid flow so as to separate and hold (e.g., trap) a first fraction of the fluid within the restricted region 1920 of the microfluidic chip 1900 while a remaining second fraction of the fluid is permitted to flow out of the microfluidic chip 1900 via the negative pressure applied to the microfluidic chip 1900. In some variations, the first fraction of the fluid may include ECMBs. FIGS. 19A-19C depict microfluidic chips 1900 with a plurality of restriction channels 1924, 1926, 1928 (e.g., uniform flow channels) that may be spaced-apart, linear, and in-parallel. For example, the restricted region 1920 may include flow barriers 1922 that define respective restriction channels 1924, 1926, 1928, and a plurality of obstructions 1940 (e.g., pillars) having a plurality of spacings 1921, 1923, 1925, 1927, 1929, as described in more detail with respect to FIG. 19B. The restriction channels 1924, 1926, 1928 may have a length greater than a length of the restricted region 1920. The restriction channels 1924, 1926, 1928 may have a same or different lengths relative to each other. Accordingly, the plurality of restriction channels 1924, 1926, 1928 may be configured to facilitate fluid flow through the microfluidic chip 1800 while minimizing air bubbles and clogging when negative pressure is applied to an outlet reservoir 1930 of the microfluidic chip 1900. Furthermore, FIG. 19C depicts the microfluidic chip array 1902 comprising a plurality of multi-restriction channel microfluidic chips 1900. A single microfluidic chip array 1902 may be used to separately (e.g., individually) process a plurality of fluid samples, thereby increasing throughput and efficiency, as well as reducing a size of the system. In some variations, a microfluidic chip array may include a plurality of microfluidic chips having different configurations (e.g., including at least one microfluidic chip 316, at least one microfluidic chip 1800, at least one microfluidic chip 1900, etc.).

The plurality of obstructions 1940 within the restricted region 1920 may be configured to restrict (e.g., impede) fluid flow and hold the first fraction of the biological fluid for analysis (e.g., image analysis). For example, FIG. 19B provides a detailed view of the restricted region 1920 of the microfluidic chip 1900 including the fluid barriers 1922, a first restriction channel 1924, a second restriction channel 1926, a third restriction channel 1928, and a plurality of spacings 1921, 1923, 1925, 1927, 1929. In some variations, a spacing between the plurality of obstructions 1940 in the restricted region 1920 may decrease along a length of the microfluidic chip 1900 from an inlet 1918 of the restricted region 1920 to an outlet 1919 of the restricted region 1920. In some variations, the spacing between the plurality of obstructions 1940 in the restricted region 1920 may be between about 100 μm and about 4 μm. For example, a first spacing 1921 between obstructions 1940 at an inlet 1918 of the restricted region 1920 may be about 100 μm, followed by a second spacing 1923 of about 50 μm, a third spacing 1925 of about 25 μm, a fourth spacing 1927 of about 15 μm, and a fifth spacing 1929 of about 4 μm at an outlet 1919 of the restricted region 1920. The length of each spacing as well as a diameter of the obstructions 1840 may be same or different. In some variations, the restricted region 1920 may extend across a width of the microfluidic chip 1900 except for the fluid barriers 1922 and the restriction channels 1924, 1926, 1928.

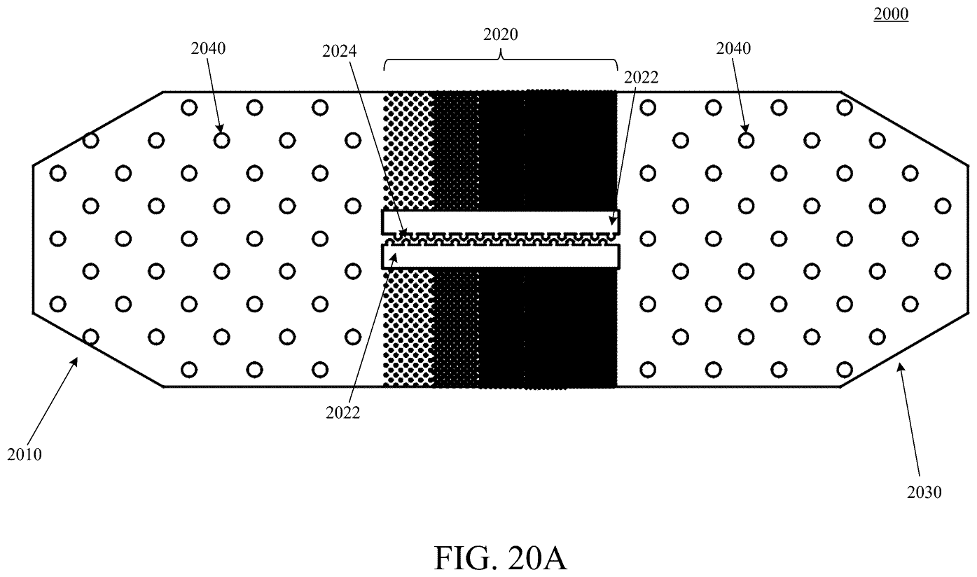

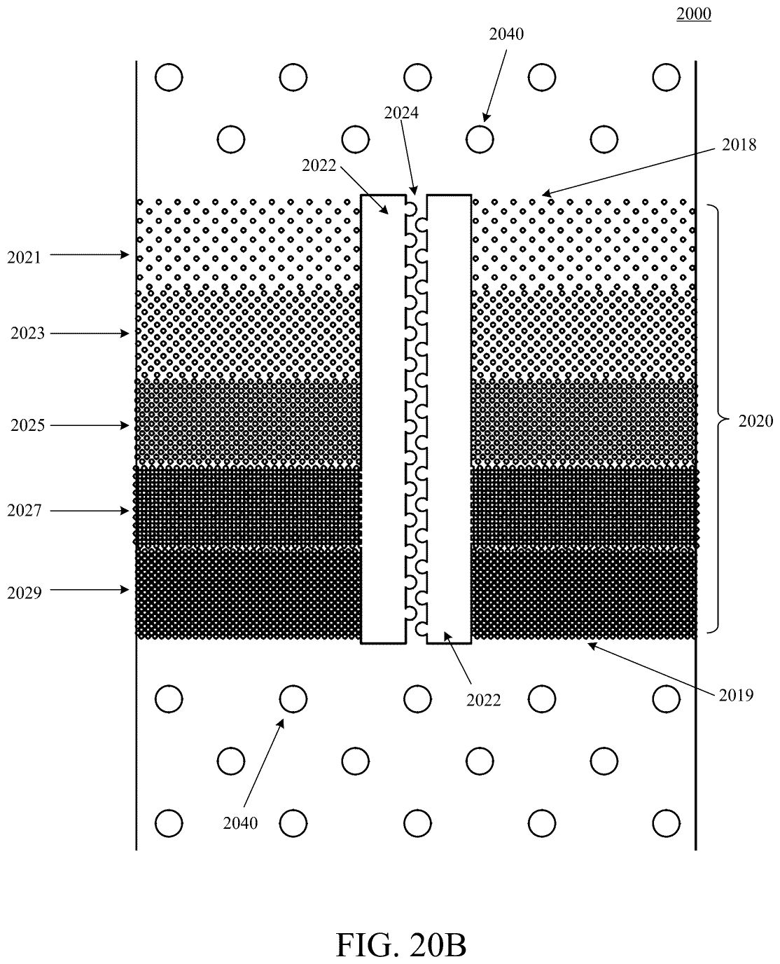

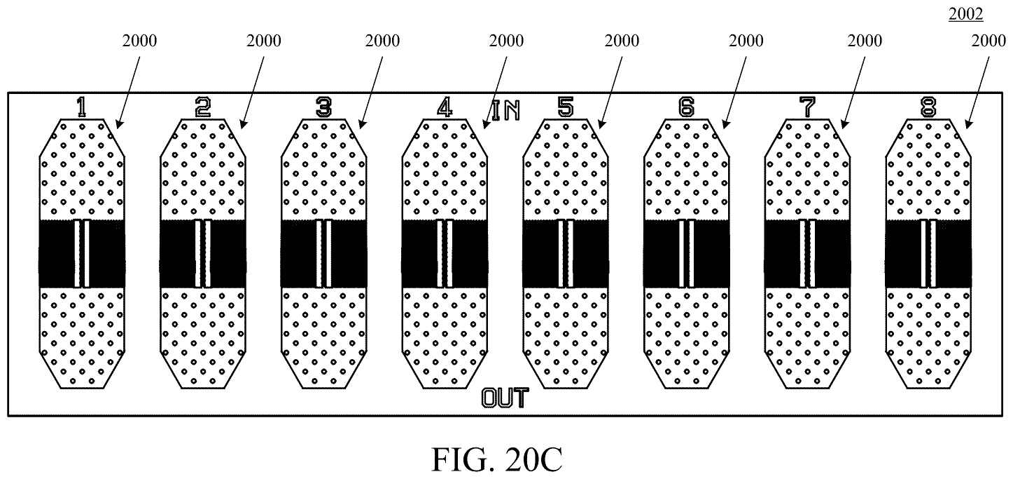

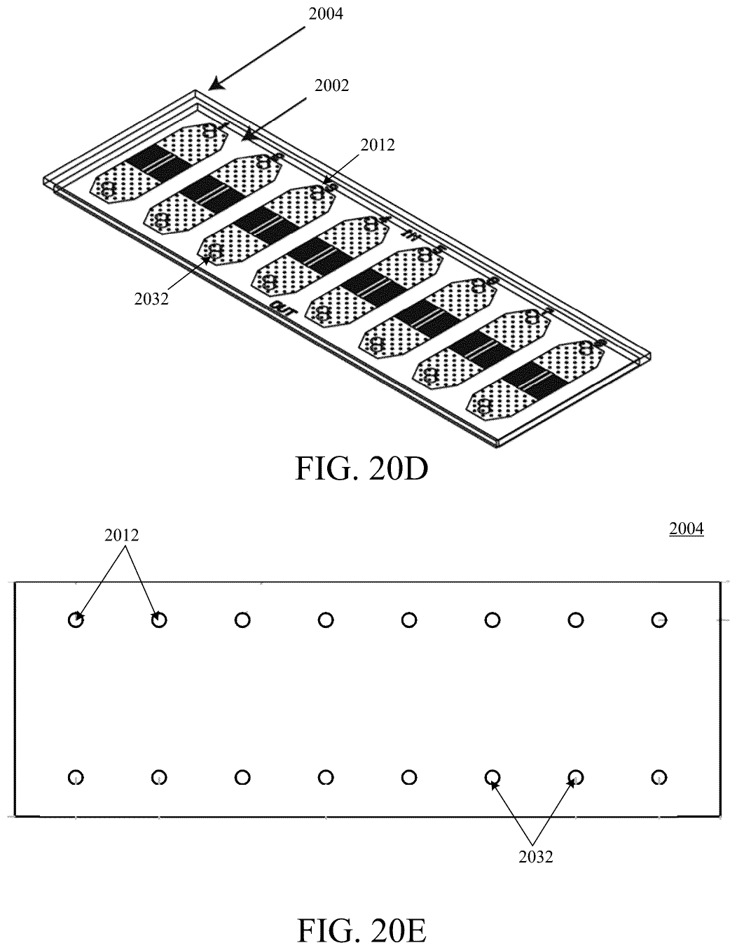

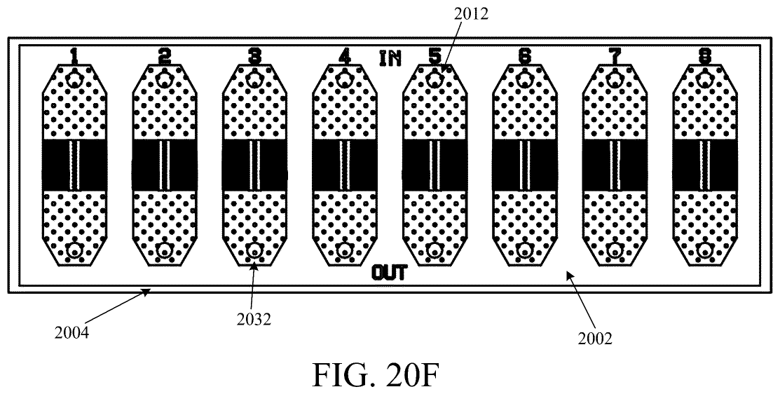

FIGS. 20A and 20B depict plan views of a microfluidic chip 2000 including an inlet reservoir 2010, an outlet reservoir 2030, and a restricted region 2020 (e.g., filter region) in fluid communication between the inlet reservoir 2010 and the outlet reservoir 2030. The inlet reservoir 2010 and the outlet reservoir 2030 may include at least one inlet obstruction 2040. The inlet reservoir 1810 and the outlet reservoir 1830 may have a generally polygonal shape.

A plurality of obstructions 2040 may be disposed between the inlet reservoir 2010 and the outlet reservoir 2030. Similar to the microfluidic chips 316, 1800, 1900, the restricted region 2020 may be configured to restrict fluid flow so as to separate and hold (e.g., trap) a first fraction of the fluid within the restricted region 2020 of the microfluidic chip 1800 while a remaining second fraction of the fluid is permitted to flow out of the microfluidic chip 2000 via the negative pressure applied to the microfluidic chip 2000. In some variations, the first fraction of the fluid may include ECMBs. The restricted region 2020 may include flow barriers 2022 that define the restriction channel 2024 (e.g., uniform flow channel) and a plurality of obstructions 2040 (e.g., pillars) having a plurality of spacings 2021, 2023, 2025, 2027, 2029, as described in more detail with respect to FIG. 20B. The restriction channel 2024 may be linear and have a length at least equal to a length of the restricted region 2020. The restriction channel 2024 may be configured to facilitate fluid flow through the microfluidic chip 2000 when negative pressure is applied to the outlet 2032 of the microfluidic chip 2000. For example, the restriction channel 2024 may reduce the formation of air bubbles in the microfluidic chip 2000.

The plurality of obstructions 2040 within the restricted region 2020 may be configured to restrict (e.g., impede) fluid flow and hold the first fraction of the biological fluid for analysis (e.g., image analysis). For example, FIG. 20B provides a detailed view of the restricted region 2020 of the microfluidic chip 2000 including the fluid barriers 2022, the restriction channel 2024, and a plurality of spacings 2021, 2023, 2025, 2027, 2029. In some variations, a spacing between the plurality of obstructions 2040 in the restricted region 2020 may decrease along a length of the microfluidic chip 2000 from an inlet 2018 of the restricted region 2020 to an outlet 2019 of the restricted region 2020. In some variations, the spacing between the plurality of obstructions 2040 in the restricted region 2020 may be between about 100 μm and about 4 μm. For example, a first spacing 2021 between obstructions 2040 at an inlet 2018 of the restricted region 2020 may be about 100 μm, followed by a second spacing 2023 of about 50 μm, a third spacing 2025 of about 25 μm, a fourth spacing 2027 of about 15 μm, and a fifth spacing 2029 of about 4 μm at an outlet of the restricted region 2020. The length of each spacing as well as a diameter of the obstructions 2040 may be the same or different. In some variations, the restricted region 2020 may extend across a width of the microfluidic chip 2000 except for the fluid barriers 2022 and restriction channel 2024.

FIG. 20C depicts a plan view of a microfluidic chip array 2002 comprising a plurality of microfluidic chips 2000. A single microfluidic chip array 2002 may be used to separately (e.g., individually) process a plurality of fluid samples, thereby increasing throughput and efficiency, as well as reducing a size of the system. FIG. 20D depicts the microfluidic chip array 2002 coupled to a cover 2004. In some variations, the cover 2004 may comprise an inlet 2012 in fluid communication with the inlet reservoir 2010 of a respective microfluidic chip 2000 and an outlet 2032 in fluid communication with the outlet reservoir 2030. FIG. 20E depicts a plan view of the cover 2004 shown in FIG. 20D. For example, an inlet 2012 and an outlet 2032 of the cover 2004 may correspond to each respective microfluidic chip 2000 of the microfluidic chip array 2002. In some variations, a distance between adjacent inlets 2012 may be based on a diameter of an end effector (e.g., pipette). For example, a distance between adjacent inlets 2012 may be between about 5 mm and about 15 mm, between about 7 mm and about 13 mm, between about 8 mm and about 12 mm, about 8 mm, about 9 mm, about 10 mm, about 11 mm, including all ranges and sub-values in-between. FIG. 20F depicts a plan view of the microfluidic chip array 2002 and the cover 2004 shown in FIG. 20D.

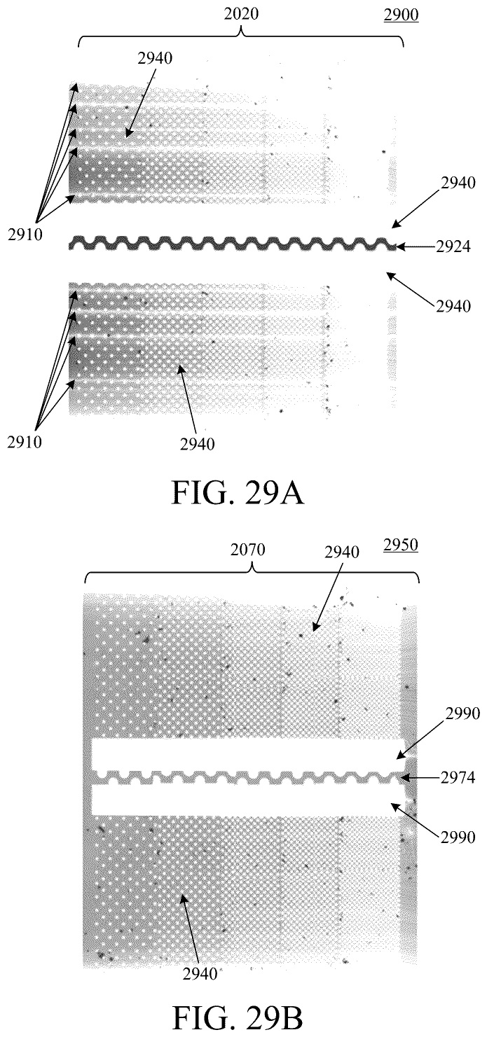

The microfluidic chips described herein may comprise a single channel (e.g., microfluidic chip 1800, 1900, 2000) or a plurality of channels (e.g., microfluidic chip array 2002). In some variations, unexpected, surprising, and significant improvements may be found in one or more of laminar flow, flow rate consistency, clogging, signal-to-noise ratio, and artifacts based on a channel density a microfluidic chip (e.g., single channel microfluidic chip compared to a multi-channel microfluidic chip array). For example, FIG. 29A is a fluorescence image of fluid flow through a single channel microfluidic chip 2900, and FIG. 29B is a corresponding fluorescence image of fluid flow through a channel of an 8-channel microfluidic chip array 2950. In particular, FIGS. 29A and 29B depict respective restricted regions 2020, 2070 including a plurality of obstructions 2940, restriction channels 2924, 2974, and fluid barriers 2940, 2990. For example, a secondary antibody (e.g., B100) was perfused into each of the microfluidic chip 2900 and microfluidic chip array 2950 at about 100 mmHg and about 75 mmHg, respectively until reaching steady state fluid flow. Comparing the single channel microfluidic chip 2900 to the multi-channel microfluidic chip array 2950, the microfluidic chip array 2950 has significantly less dead zones 2910 than the microfluidic chip 2900. The dead zones 2910 in FIG. 29A are characterized by relatively slow and/or turbulent (e.g., non-laminar) fluid flow that appear as white lines across a length of the restricted region 2020. By contrast, fluid flow is laminar across a width and length of a channel of the microfluidic chip array 2950. The fluid flow through the obstructions 2940 and restriction channel 2974 is more even (e.g., equal) in the microfluidic chip array 1950 than between the fluid flow through the obstructions 2940 and restriction channel 2924 in the microfluidic chip 2900.

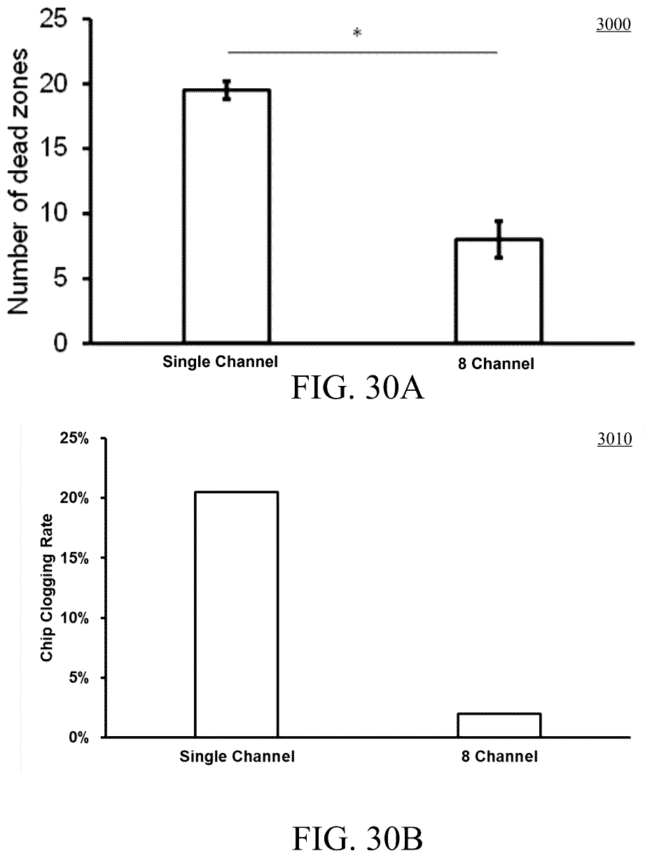

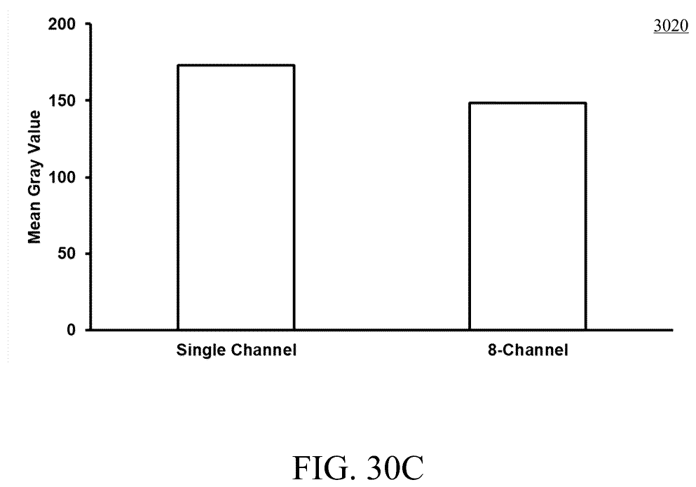

The difference in laminar flow between the single channel microfluidic chip 2900 and multi-channel microfluidic chip array 2950 was unexpected, surprising, and significant, as shown in the graphs in FIGS. 30A-30C. FIG. 30A is a graph 3000 of non-laminar flow regions (e.g., number of dead zones) based on a single channel microfluidic chip and a multi-channel microfluidic chip array. For example, the number of dead zones of a single channel microfluidic chip (e.g., microfluidic chip 2900) were compared to that of a single channel of a microfluidic chip array (e.g., microfluidic chip array 2950) having eight channels. The error bars correspond to standard deviation. The improved laminar flow through the multi-channel microfluidic chip array 2950 may correspond to the decreased frequency of dead zones. The data shows significantly increased disruptions to the laminar flow (bar graph, left) in the single-channel microfluidic chip compared to the disruption in flow in a single lane in the 8-channel microfluidic chip array. Surprisingly, we observed fewer disruptions to the flow in the 8-channel microfluidic chip array.

FIG. 30B is a graph 3010 of clogging rates based on a single channel microfluidic chip (e.g., microfluidic chip 2900) and a multi-channel microfluidic chip (e.g., microfluidic chip 2950). Each chip 2900, 2950 was loaded with a 200 μl sample of human plasma sample and stained, and was determined to be clogged if there was substantially no fluid flow. FIG. 30B shows that the microfluidic chip clogging rates for the single channel microfluidic chip and the 8 channel microfluidic chip array was about 20% and about 2%, respectively. The improved laminar flow through the multi-channel microfluidic chip array 2950 may correspond to the decreased clogging rate. FIG. 30C is a graph 3020 of background noise (e.g., mean gray value) for stained fluid samples based on a single channel microfluidic chip (e.g., microfluidic chip 2900) and a multi-channel microfluidic chip (e.g., microfluidic chip 2950). Due to improved fluid flow rates in the multi-channel microfluidic chip arrays relative to the single channel microfluidic chips, a lower background noise value was observed in the microfluidic chip arrays. For example, graph 3020 depicts about a 15% reduction in background noise in the multi-channel microfluidic chip array relative to the single channel microfluidic chip. The respective standard deviations observed for the single channel microfluidic chip and the 8 channel microfluidic chip array were 0.83 and 0.49, respectively.

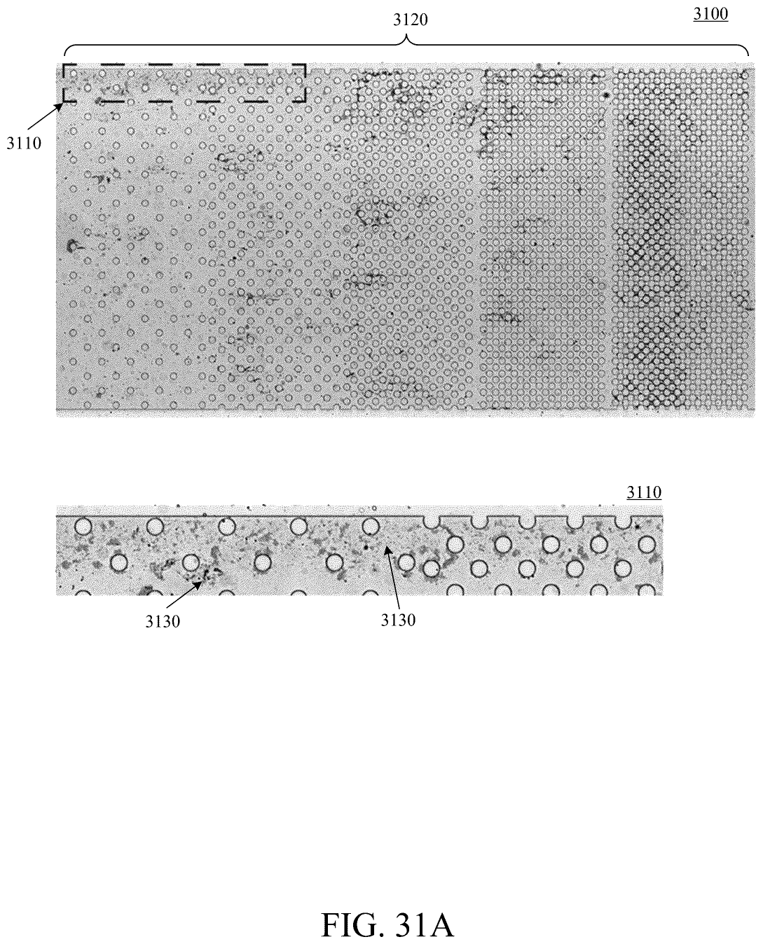

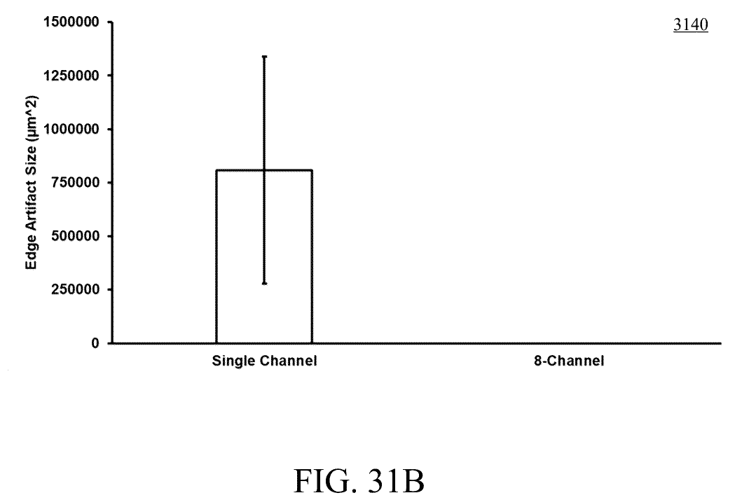

In some variations, reduced laminar flow in a channel of a microfluidic chip may correspond to an increase in artifacts and higher non-laminar flow. For example, FIG. 31A is an image 3100 of non-laminar flow through a restricted region 3120 of a single channel microfluidic chip for a sample (e.g., SRX 1032) stained with Eosin. In particular, boundary (e.g., edge, perimeter) regions of the restricted region 3120 may have a higher frequency of artifacts. For example, a top edge region 3110 of the restricted region 3120 may include a higher frequency of artifacts 3130 (e.g., retained Eosin staining conglomerates) corresponding to disturbed flow. The artifacts and ECMBs may be distinguished based on morphology. FIG. 31B is a graph 3140 of artifact size based on a single channel microfluidic chip and a multi-channel microfluidic chip. The difference in artifact size between a single channel microfluidic chip and a multi-channel microfluidic chip array was unexpected, surprising, and significant. For example, the edge artifacts for a single channel microfluidic chip were quantified with higher frequency due to the disturbed fluid flow through the microfluidic chip relative to a microfluidic chip array. In particular, edge artifacts were not observed in the 8 channel microfluidic chip arrays due to the laminar flow and consistent flow pattern through the microfluidic chip array. The error bars correspond to standard deviation.

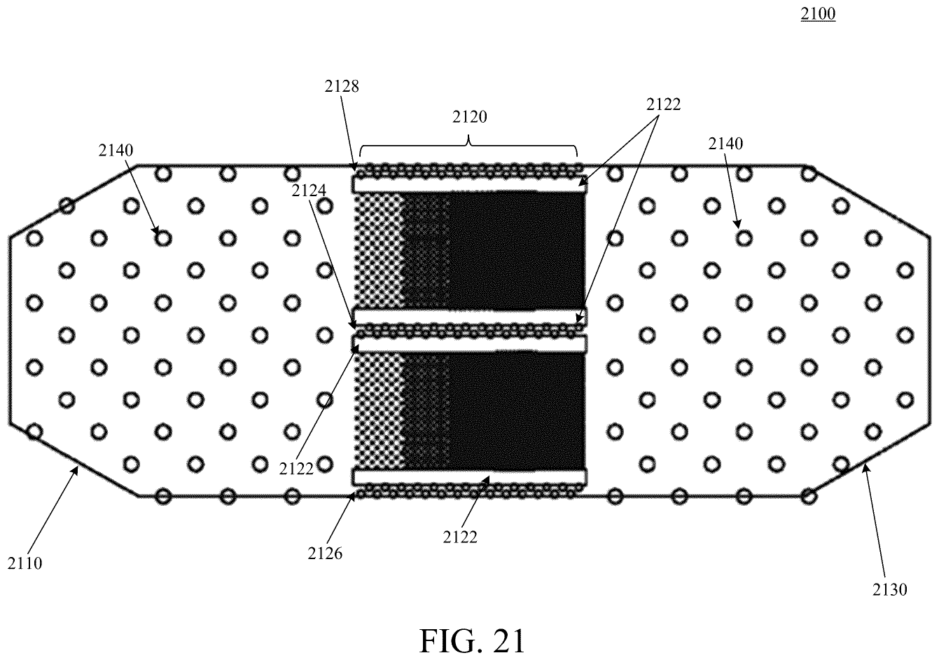

FIG. 21 depicts a plan view of a multi-restriction channel microfluidic chip 2100 including an inlet reservoir 2110, an outlet reservoir 2130, and a restricted region 2120 (e.g., filter region) in fluid communication between the inlet reservoir 2110 and the outlet reservoir 2130. The inlet reservoir 2110 and the outlet reservoir 2130 may include at least one obstruction 2140. The inlet reservoir 2110 and the outlet reservoir 2130 may have a generally polygonal shape. A plurality of obstructions 2140 may be disposed between the inlet reservoir 2110 and the outlet reservoir 2130. Similar to the microfluidic chips 316, 1800, 1900, 2000, the restricted region 2120 may be configured to restrict fluid flow so as to separate and hold (e.g., trap) a first fraction of the fluid within the restricted region 2120 of the microfluidic chip 2100 while a remaining second fraction of the fluid is permitted to flow out of the microfluidic chip 2100 via the negative pressure applied to the microfluidic chip 2100. In some variations, the first fraction of the fluid may include ECMBs. Microfluidic chip 2100 may include a plurality of restriction channels 2124, 2126, 2128 (e.g., uniform flow channels) that may be spaced-apart, linear, and in-parallel. For example, the restricted region 2120 may include flow barriers 2122 that define respective restriction channels 2124, 2126, 2128, and a plurality of obstructions 2140 (e.g., pillars) having a plurality of spacings. The restriction channels 2124, 2126, 2128 may have a length greater than a length of the restricted region 2120. The restriction channels 2124, 2126, 2128 may have a same or different lengths relative to each other. Accordingly, the plurality of restriction channels 2124, 2126, 2128 may be configured to facilitate fluid flow through the microfluidic chip 1800 while minimizing air bubbles and clogging when negative pressure is applied to an outlet reservoir 2130 of the microfluidic chip 2100. In some variations, a microfluidic chip array may comprise a plurality of microfluidic chips 2100.

The microfluidic chips described herein may have various configurations and dimensions. For example, the obstructions described herein may have one or more of a circular, a spherical, a triangular, a square, a polygonal, a diamond, and a fin-shape. The obstructions may have the same or different shapes, sizes, and spacings. For example, the obstructions may have a spacing between adjacent pillars of between about 4 μm and about 100 μm, about 4 μm, about 15 μm, about 25 μm, about 50 μm, about 100 μm, including all ranges and sub-values in-between.

In some variations, a microfluidic chip applied with negative pressure may improve a yield (e.g., immobilization) of a predetermined fraction of a biological fluid based on a cross-sectional dimension of a channel. For example, each channel may comprise a cross-sectional (e.g., height) dimension of between about 5 μm and about 30 μm, between about 5 μm and about 10 μm, between about 5 μm and about 20 μm, between about 5 μm and about 15 μm, between about 10 μm and about 20 μm, between about 15 μm and about 30 μm, about 8 μm, about 11 μm, about 15 μm, including all ranges and sub-values in-between.

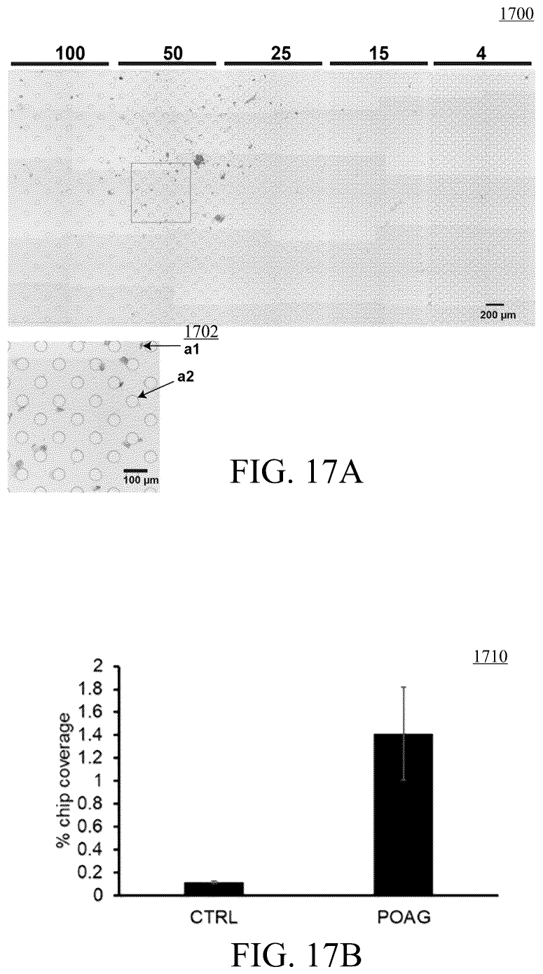

In some variations, ECMB capture amounts using the negative pressure systems as described herein may depend on the contents of the fluid (e.g., healthy control sample, positive sample). FIG. 17A are images 1700, 1702 of ECMBs captured within a restricted region of a microfluidic chip for a glaucomatous human aqueous humor sample following Eosin-Y staining. The magnified image 1702 depicts trapped ECMBs a1 wrapped around pillars a2. A high abundance of aggregated material trapped in the microfluidic chip suggests that healthy aqueous humor clogs the trabecular meshwork with ECMBs and may lead to increased pressure in the eye. By contrast, healthy (control) human aqueous humor samples show a low relative abundance of ECMBS trapped on a microfluidic chip compared to images 1700, 1702. For example, FIG. 17B is a graph 1710 of ECMB abundance (e.g., % chip coverage) as a function of sample type (healthy control sample, primary open angle glaucoma (POAG) sample). The amount of ECMBs trapped in the microfluidic chip was significantly more abundant in the POAG sample than the healthy control aqueous humor sample. Accordingly, the data suggests that increased ECMBs in the POAG sample may be responsible for clogging and blocking the flow of ocular humor out of the eye at the trabecular meshwork and may be responsible for increasing the ocular pressure in glaucoma.

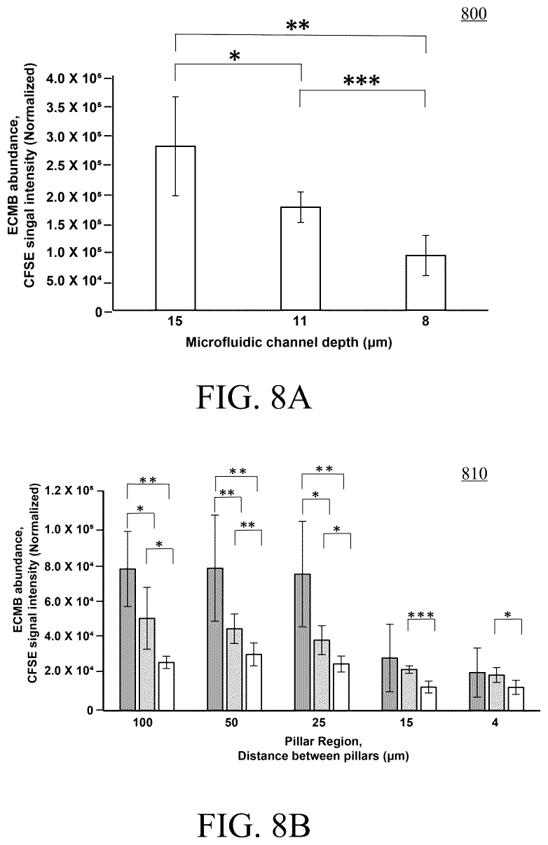

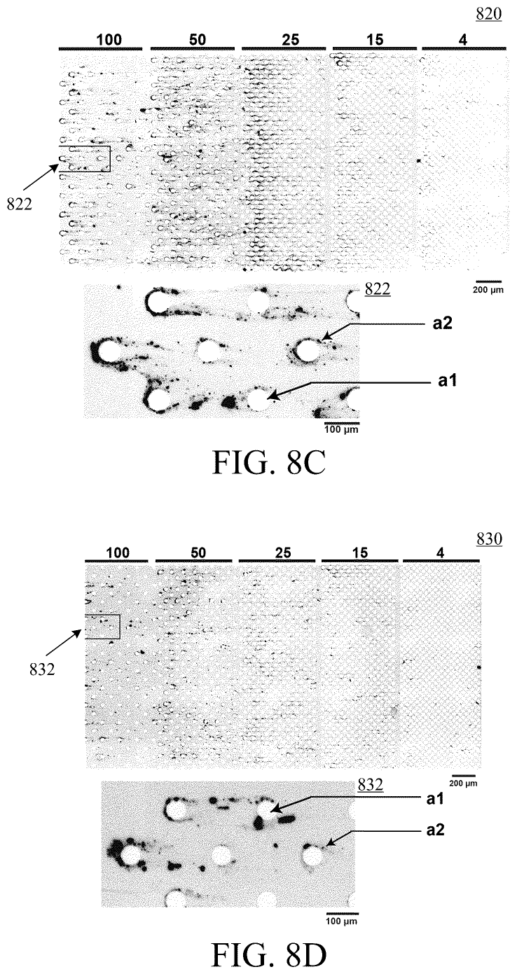

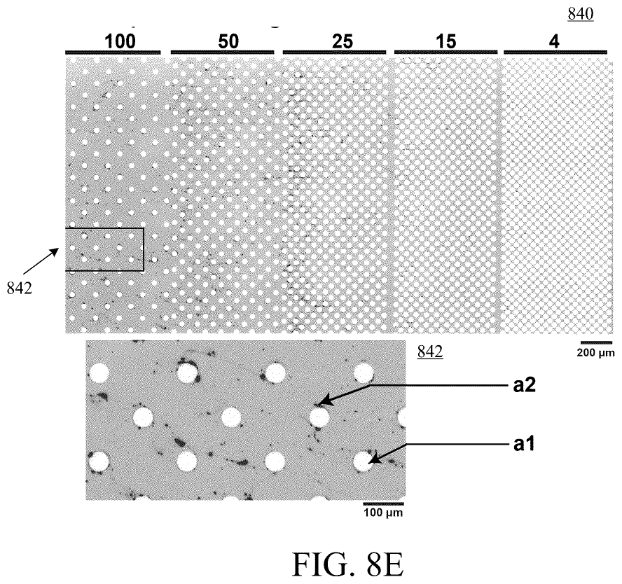

In some variations, ECMB capture amounts using the negative pressure systems as described herein may depend on one or more microfluidic channel dimensions. For example, FIG. 8A is a graph 800 of ECMB amounts as a function of cross-sectional channel dimension in a microfluidic chip. For example, graph 800 compares the total amount of ECMBs trapped in 8 μm, 11 μm, and 15 μm cross-sectional heights of respective microfluidic channels. The normalized CarboxyFluoroscein Succinimidyl Ester (CFSE) signal intensity indicates a total amount of proteins and correlates to ECMB abundances, with a linear relationship between channel dimension and ECMB abundance. FIG. 8B is a graph 810 of ECMB amounts as a function of obstruction (e.g., pillar) spacing in a microfluidic chip. For example, FIG. 8B compares the total amount of ECMBs across pillar regions having different height (cross-sectional) spacings. For all 15 μm (dark gray bar), 11 μm (light gray), and 8 μm (white) dimension channels, the majority of the ECMBs are trapped in the 100 μm, 50 μm, and 25 μm spacing regions.

FIGS. 8C-8E are illustrative images 820, 830, 840 of ECMBs on microfluidic chips having different channel cross-sectional (e.g., height) dimensions. FIG. 8C is an image 820 of ECMBS a2 stained with CSFE with a channel dimension of 15 μm. The majority of the ECMBs are trapped in the 100 μm, 50 μm, and 25 μm spaced pillar a1 regions. The magnified image 822 depicts trapped ECMBs a2 wrapped around pillars a1. FIG. 8D is an image 830 of ECMBS a2 stained with CSFE with a channel dimension of 11 μm. The majority of the ECMBs are trapped in the 100 μm, 50 μm, and 25 μm spaced pillar a1 regions. The magnified image 832 depicts trapped ECMBs a2 wrapped around pillars a1. FIG. 8E is an image 840 of ECMBS a2 stained with CSFE with a channel cross-sectional (e.g., height) dimension of 8 μm. The majority of the ECMBs are trapped in the 100 μm, 50 μm, and 25 μm spaced pillar a1 regions. The magnified image 842 depicts trapped ECMBs a2 wrapped around pillars a1.

### D. Chip Connector

The systems described herein may comprise a chip connector. Generally, a chip connector 118, 218 may be configured to hold one or more microfluidic chips 116, 216, 316, 1800, 1900, 2000, 2100 and improve performance of the system 100, 200. Application of negative pressure to a microfluidic chip generates forces on the structure of the microfluidic chip itself that may reduce and/or prevent processing of a biological fluid using the microfluidic chip. For example, negative pressure applied to a channel (e.g., restriction channel) of a microfluidic chip may generate force at an outlet that may compress (and/or collapse) an outlet reservoir of the microfluidic chip corresponding to unpredictable flow rates, air bubbles, and unequal distribution of material within the microfluidic chip. By contrast, the chip connectors described herein may be configured to hold a microfluidic chip and distribute the negative pressure forces applied by a negative pressure source more evenly throughout a microfluidic chip 116, 216, 316 so as to maintain the structural integrity of the microfluidic chip 116, 216, 316 and provide consistent results.

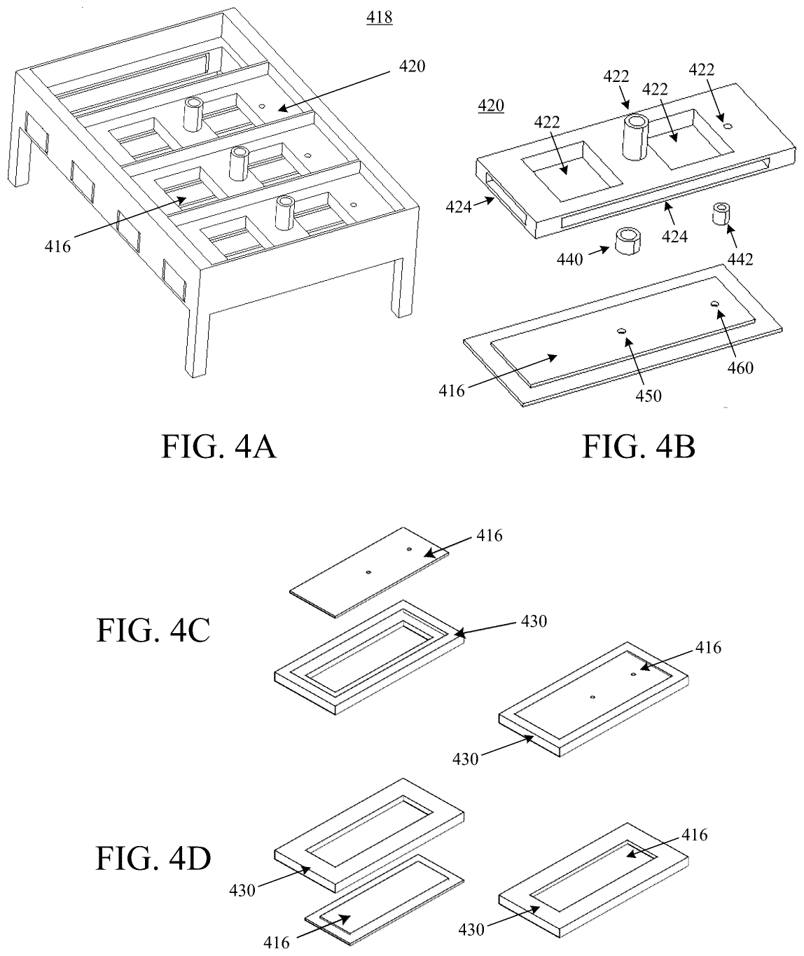

FIG. 4A depicts a perspective view a chip connector 418 configured to hold a plurality of microfluidic chips 416. FIG. 4B depicts an exploded perspective view of a cover 420 of the chip connector 418 and the microfluidic chip 416. As shown in FIGS. 4A-4D, the chip connector 418 may comprise a cover 420 configured to contact a top portion of the microfluidic chip 416, and a base 430 configured to contact a bottom portion of the microfluidic chip 416. The cover 420 may define a plurality of apertures 422 and include (e.g., overlap, cover) a perimeter of the microfluidic chip 416. The plurality of apertures 422 may be configured to overlap one or more of the inlet 450 and outlet 460 of the microfluidic chip 416. Accordingly, a fluid conduit of the manifold (not shown) may be coupled to the microfluidic chip 416 via an aperture 422. In some variations, an inlet connector 440 may be coupled to the inlet 450 and be configured to receive fluid from a robot 114. Similarly, an outlet connector 442 may be coupled between a fluid conduit (not shown for the sake of clarity) and the outlet 460 and configured to receive fluid being transferred to the reservoir 113. The outlet connector 442 may be a connection interface between the fluid conduit and the outlet 460.

In some variations, the microfluidic chip 416 held between the cover 420 and the bottom portion 430 may distribute the negative pressure forces applied at the outlet 460 of the microfluidic chip 416 to the perimeter of the microfluidic chip 416 (e.g., sides of the chip not having a channel), thereby reducing compression at an outlet of the microfluidic chip and non-perimeter portions of the microfluidic chip (e.g., were fluid flows), and thereby facilitate a consistent flow rate and more equal distribution of material through the microfluidic chip 416. For example, FIGS. 4C and 4D depict respective exploded top and bottom perspective views of a base 430 of the chip connector 418 and the microfluidic chip 416 where a perimeter of the microfluidic chip 416 contacts a perimeter of the base 430 such that an inner (e.g., non-perimeter) bottom portion of the microfluidic chip 416 does not contact the chip connector 418. This configuration enables the forces applied by negative pressure at an outlet 460 (that push the microfluidic chip 416 towards the base 430) to be distributed to the perimeter of the microfluidic chip 416 (where fluid does not flow) to reduce compression at an outlet 460 and a non-perimeter portion (where fluid flows) of the microfluidic chip 416. In this manner, the chip connector 418 may be configured to distribute a compressive force applied by the negative pressure to the microfluidic chip 416 to relieve pressure on the microfluidic chip 416 and keep a fluid channel open for fluid flow. Accordingly, the chip connector facilitates laminar fluid flow and consistent flow rates that minimize dead zones, clogging, background noise, and artifacts.

In some variations, the chip connector 418 may comprise one or more fasteners configured to couple the microfluidic chip 416 to the chip connector 418. For example, as shown in FIG. 4B, the chip connector 418 may comprise a plurality of magnets 424 configured to securely hold a microfluidic chip 416 in place within the chip connector 418. For example, each of the base 430 and cover 420 of the chip connector 418 may comprise a magnet 424 configured to align the microfluidic chip 418 in a predetermined orientation. As shown in FIG. 4B, a perimeter (e.g., sides) of the cover 420 may comprise one or more magnets 424. In some variations, the magnets 424 may be configured to provide a counter-force to the negative pressure applied to the outlet 460 to further reduce compression at the outlet 460. In variations, a fastener may comprise one or more of a latch, strap, clip, mount, clasp, snap, clamp, closure, anchor, tie, adhesive, hook-and-loop fastener, combinations thereof, and the like.

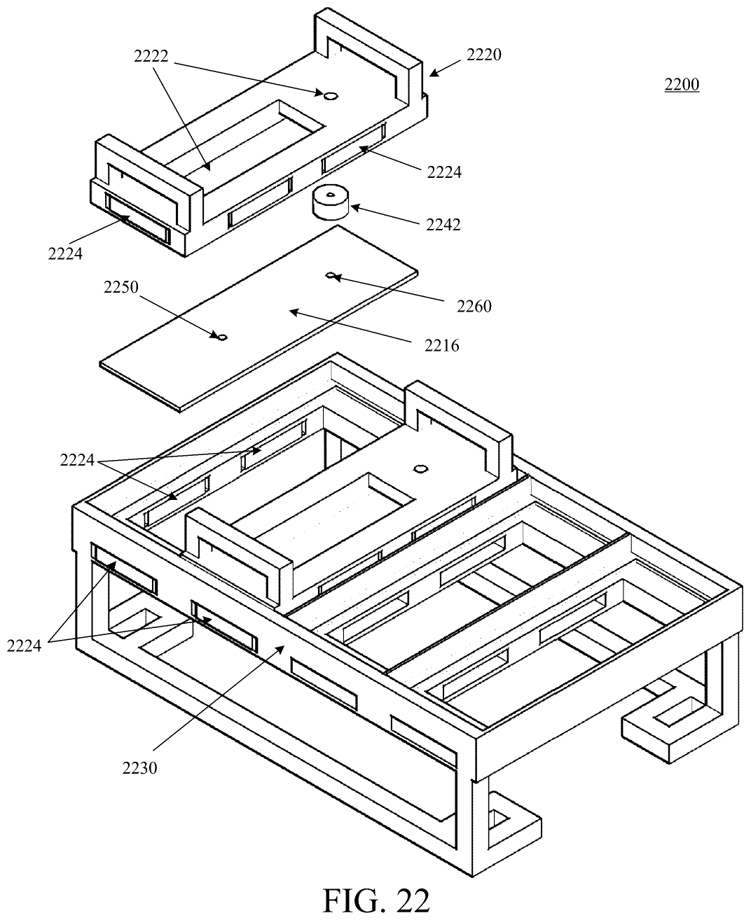

FIG. 22 depicts an exploded perspective view a chip connector 2200 configured to hold one or more microfluidic chips 2216. The chip connector 2200 may comprise a base 2230 configured to contact a bottom portion of the microfluidic chip (e.g., portion facing opposite a cover of the microfluidic chip), an outlet connector 2242, and a cover 2220 configured to contact a top portion of the microfluidic chip 2216 (e.g., portion facing the outlet connector 2242). The cover 2220 may define a plurality of apertures 2222 and include (e.g., overlap, cover) a perimeter of the microfluidic chip 2216. The plurality of apertures 2222 may be configured to overlap one or more of the inlet 2250 and outlet 2260 of the microfluidic chip 2216. Accordingly, a fluid conduit of the manifold (not shown) may be coupled to the microfluidic chip 2216 via a corresponding aperture 2222. In some variations, an inlet connector (not shown for the sake of clarity) may be coupled to the inlet 2250 and be configured to receive fluid from a robot 114. Similarly, an outlet connector 2242 may be coupled between a fluid conduit (not shown for the sake of clarity) and the outlet 2260 and configured to receive fluid being transferred (e.g., suctioned) to the reservoir 113. In some variations, the outlet connector 2242 may be a connection interface between the fluid conduit and the outlet 2260. The chip connector 2200 may further comprise a base (e.g., base 430, FIGS. 4C and 4D) not illustrated in FIG. 22 for the sake of clarity. The base may be configured to contact a bottom portion of the microfluidic chip 2216 in the same manner as shown and described with respect to FIGS. 4C and 4D.

In some variations, the microfluidic chip 2216 held between the cover 2220 and the base 2230 of the chip connector 2200 may distribute the negative pressure forces applied at the outlet 2260 of the microfluidic chip 2216 to the perimeter of the microfluidic chip 2216 (e.g., sides of the chip not having a channel), thereby reducing compression at an outlet 2260 of the microfluidic chip 2216 and thereby facilitate a consistent flow rate and more equal distribution of material (e.g., first fraction, ECMBs) through the microfluidic chip 2216. This configuration enables the forces applied by negative pressure at an outlet 2260 (that push the microfluidic chip 2216 towards the base 2230) to be redistributed to the perimeter of the microfluidic chip 2216 to reduce compression at an outlet 2260 of the microfluidic chip 2216. In this manner, the chip connector 2200 may be configured to distribute a compressive force applied by the negative pressure to the microfluidic chip 2216 to relieve pressure on the microfluidic chip 2216 and keep a fluid channel open for fluid flow. Accordingly, the chip connector 2200 facilitates laminar fluid flow and consistent flow rates that minimize dead zones, clogging, background noise, and artifacts.

In some variations, as shown in FIG. 22, the chip connector 2200 may comprise a plurality of magnets 2224 configured to securely hold a microfluidic chip 2216 in place within the chip connector 2200. For example, each of the base 2230 and cover 2220 of the chip connector 2200 may comprise at least one respective magnet 2224 configured to align the microfluidic chip 2200 in a predetermined orientation. As shown in FIG. 22, a perimeter (e.g., sides) of the cover 2220 and an internal perimeter (e.g., side walls) of the base 2230 may each comprise one or more magnets 2224 configured to enclose the microfluidic chip 2216 in the chip connector 2200.

In some variations, the chip connector 118, 218 may be configured to hold one or more microfluidic chips 116, 216, 316, 1800, 1900, 2000, 2100 and/or microfluidic chip arrays 370, 2002 to improve the throughput and/or reduce the size of the system. Furthermore, a chip connector may be configured to distribute the negative pressure forces applied by a negative pressure source more evenly throughout a plurality of microfluidic chips to maintain structural integrity and provide consistent results in a compact space.

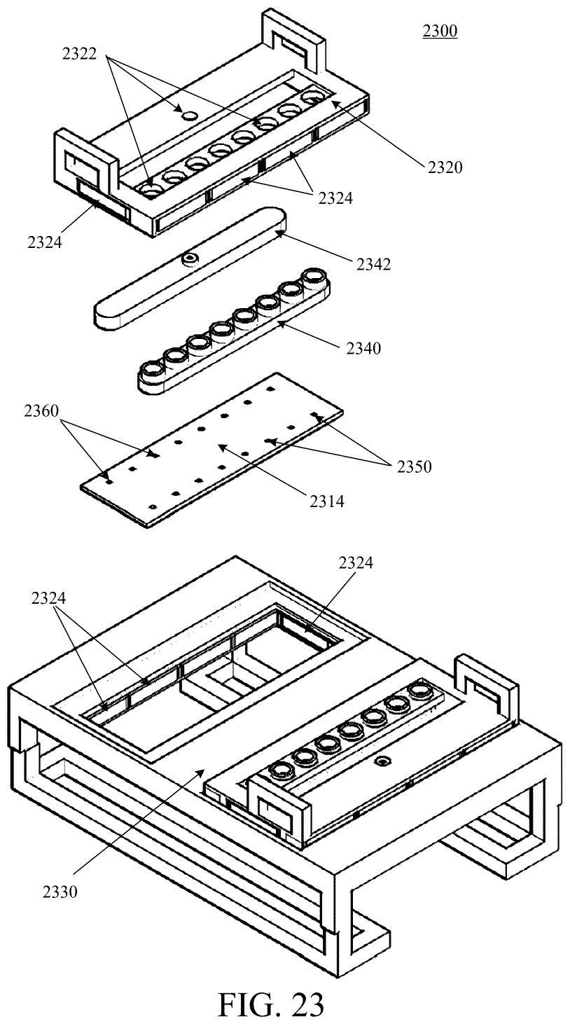

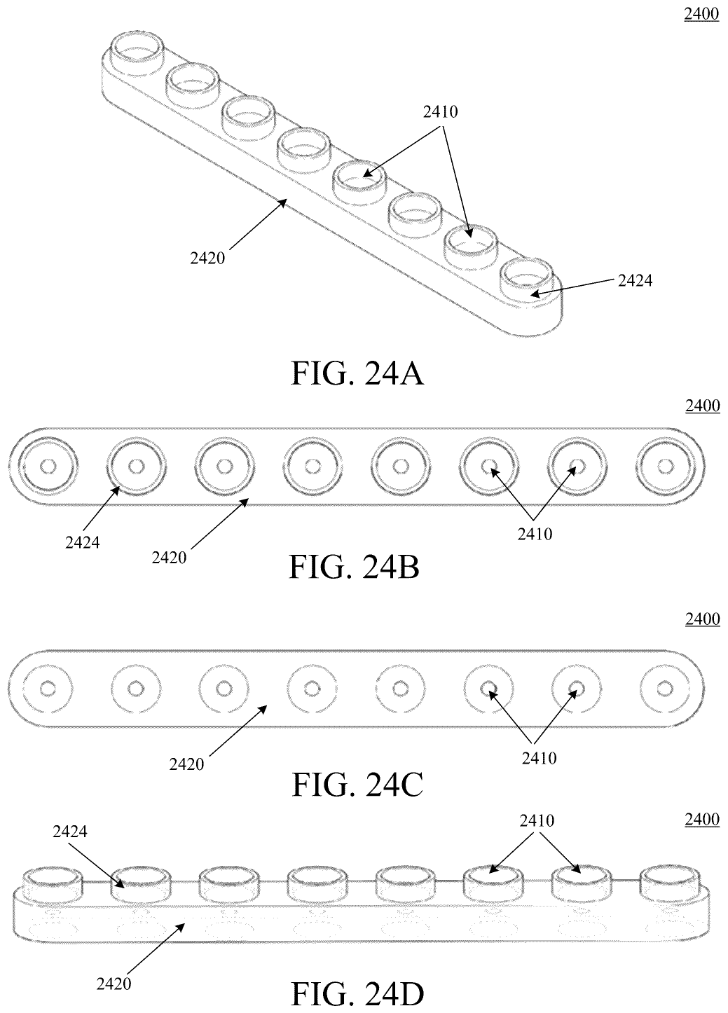

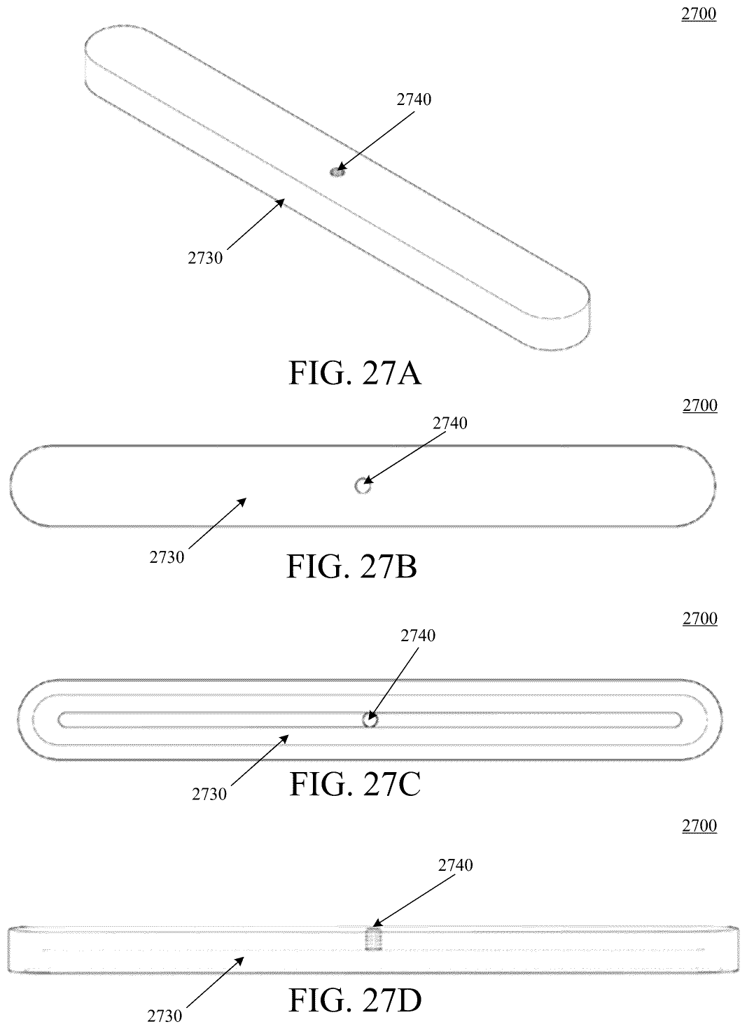

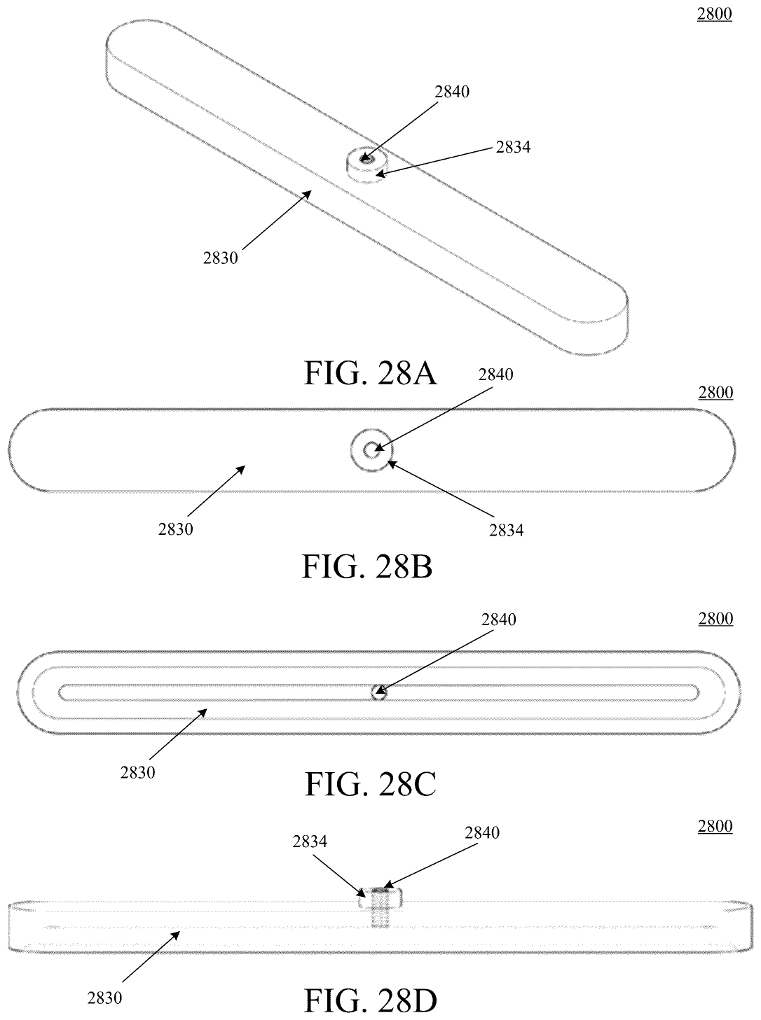

FIG. 23 depicts an exploded perspective view a chip connector 2300 configured to hold one or more microfluidic chip arrays 2314. For example, the chip connector 2300 may comprise a cover 2320 configured to contact a top portion (e.g., portion facing the inlets 2350 and outlets 2360) of the microfluidic chip array 2314, and a base 2330 configured to contact a bottom portion (e.g., portion facing away from the inlets 2350 and outlets 2360) of the microfluidic chip array 2314. The cover 2320 may define a plurality of apertures 2322 and include (e.g., overlap, cover) a perimeter of the microfluidic chip array 2314. The plurality of apertures 2322 may be configured to overlap one or more of the plurality of inlets 2350 and the plurality of outlets 2360 of the microfluidic chip array 2314. Accordingly, a fluid conduit of the manifold (not shown) may be coupled to the microfluidic chip array 2314 via an aperture 2322. In some variations, an inlet connector 2340 of the chip connector 2300 may be coupled to the plurality of inlets 2350 of the microfluidic chip array 2314 and be configured to receive fluid from a robot 114. Similarly, an outlet connector 2342 of the chip connector 2300 may be coupled between a fluid conduit (not shown for the sake of clarity) and the plurality of outlets 2360 of the microfluidic chip array 2314 and configured to receive fluid being transferred (e.g., suctioned) to the reservoir 113. Accordingly, the outlet connector 2342 may be a connection interface between the fluid conduit and the plurality of outlets 2360. Inlet connectors of the chip connector are further described with respect to FIGS. 27A-27D and 28A-28D, and outlet connectors of the chip connector are further described with respect to FIGS. 24A-24D, 25A-25D, 26A-26D.

In some variations, the microfluidic chip array 2314 held between the cover 2320 and the bottom portion 2330 of the chip connector 2300 may distribute the negative pressure forces applied at the plurality of outlets 2360 of the microfluidic chip array 2314 to the perimeter of the microfluidic chip array 2314 (e.g., sides of the chip not having a channel), thereby reducing compression at the outlets of the microfluidic chip array and thereby facilitating a consistent flow rate and more equal distribution of material through the microfluidic chip array 2314. This configuration enables the forces applied by negative pressure at the plurality of outlets 2360 (that push the microfluidic chip array 2314 towards the base 2330) to be redistributed to the perimeter of the microfluidic chip array 2314 to reduce compression at the plurality of outlets 2360 of the microfluidic chip array 2314. In this manner, the chip connector 2300 may be configured to distribute a compressive force applied by the negative pressure to the microfluidic chip array 2314 to relieve pressure on the microfluidic chip array 2314 and keep a fluid channel open for fluid flow. Accordingly, the chip connector 2300 facilitates laminar fluid flow and consistent flow rates that minimize dead zones, clogging, background noise, and artifacts.

In some variations, as shown in FIG. 23, the chip connector 2300 may comprise a plurality of magnets 2324 configured to securely hold a microfluidic chip array 2314 in place within the chip connector 2300. For example, each of the base 2330 and cover 2320 of the chip connector 2300 may comprise at least one respective magnet 2324 configured to align the microfluidic chip 2300 in a predetermined orientation. As shown in FIG. 23, a perimeter (e.g., sides) of the cover 2320 and an internal perimeter (e.g., side walls) of the base 2330 may each include one or more magnets 2324 configured to enclose the microfluidic chip array 2314 in the chip connector 2300. The chip connector 2300 may further comprise a base (e.g., base 430, FIGS. 4C and 4D) not illustrated in FIG. 23 for the sake of clarity. The base may be configured to contact a bottom portion of the microfluidic chip array 2314 in the same manner as shown and described with respect to FIGS. 4C and 4D.

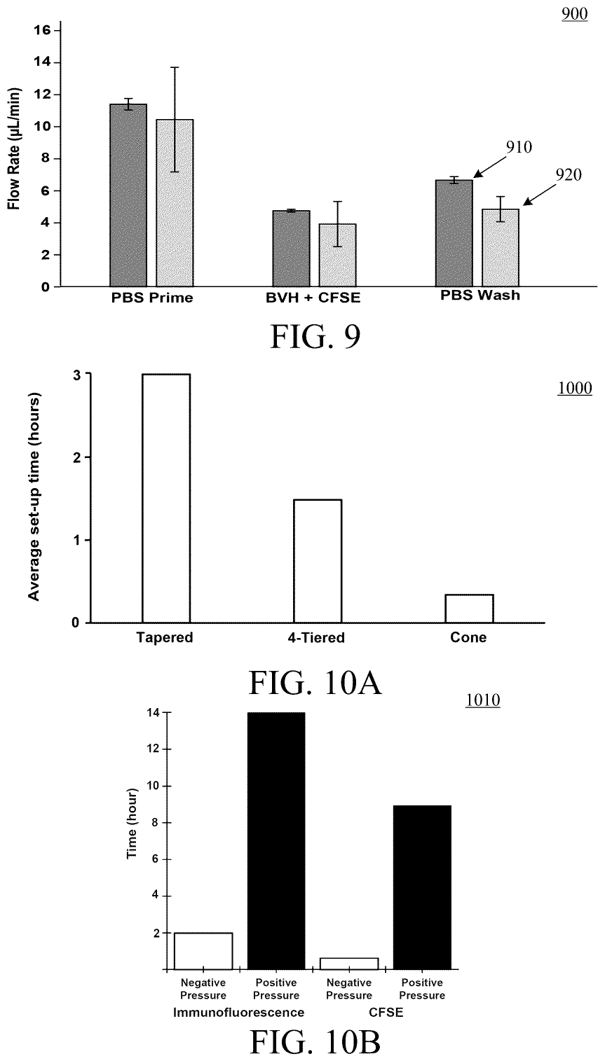

In some variations, a fluid flow rate and a flow rate consistency through a microfluidic chip 116, 216, 316, 416 being applied with negative pressure may be improved by holding the microfluidic chip 116, 216, 316, 416 in a chip connector 118, 218, 418, 2200, 2300. FIG. 9 illustrates the improvements in flow rate and flow rate consistency between a microfluidic chip coupled to a chip connector as described herein and a microfluidic chip without a chip connector. In particular, FIG. 9 is a graph 900 of flow rate for three fluid flow processes (e.g., PBS priming, BVH stained with CFSE, PBS wash) between a system 910 (e.g., system 100, dark gray bar) using a microfluidic chip and chip connector and a system 920 (light gray bar) using a microfluidic chip without a chip connector at a negative pressure of about 100 mmHg. In particular, the flow rate of PBS priming without a chip connector was 10.4±3.27 μl/min and 11.4±0.36 μl/min with a chip connector. The signal-to-noise ratio (SNR) (e.g., average to standard deviation of the flow rate) increased 9.8 times, from 3.2 without a chip connector to 31.3 with a chip connector. For BVH stained with CFSE, the flow rates were 3.9±1.42 μl/min without a chip connector and 4.8±0.10 μl/min using a chip connector. The signal-to-noise ratio increased 17.9 times from 2.8 without the chip connector to 50.0 with the chip connector. The flow rate of PBS for washing reagents was 4.9±0.79 μl/min without the chip connector and 6.7±0.22 μl/min with the chip connector. The signal-to-noise ratio also increased 4.8 times from 6.2 without the chip connector to 30.0 with the chip connector. The standard deviation is consistently larger for the microfluidic chip without the chip connector. The redistribution of pressure forces across the microfluidic chip by the chip connectors described herein correspond to the lower standard deviation, higher SNR, and predictable fluid flow and further enable the systems described herein to be automated.

In some variations, a chip connector 118, 218, 418 may include at least one inlet connector 440 and at least one outlet connector 442 disposed between the cover 420 and the microfluidic chip 416. In some variations, application of negative pressure to a microfluidic chip 416 may generate forces at a connection interface between the microfluidic chip 416 and a fluid conduit that may reduce and/or prevent processing of a biological fluid using the microfluidic chip 416. For example, the outlet 460 of the microfluidic chip 416 may be coupled to a fluid conduit (e.g., vacuum tube) of the manifold 120, 220 and negative pressure source 122, 222 (not shown). The negative pressure forces applied through the fluid conduit and at the outlet 460 of the microfluidic chip 416 may otherwise dislodge the fluid connection between the microfluidic chip 416 and the manifold 120, 220 so as to create a leak. In some variations, one or more of the connectors 440, 442 described herein may be coupled to the microfluidic chip 416 to improve one or more of a seal, connection strength, and alignment tolerance between the microfluidic chip 416 and the manifold 120, 220 and thereby provide a consistent flow rate (e.g., by preventing leaks) and equal distribution of material. In some variations, one or more of the inlet connectors 440 and outlet connectors 442 may be disposable to reduce contamination and set-up time.

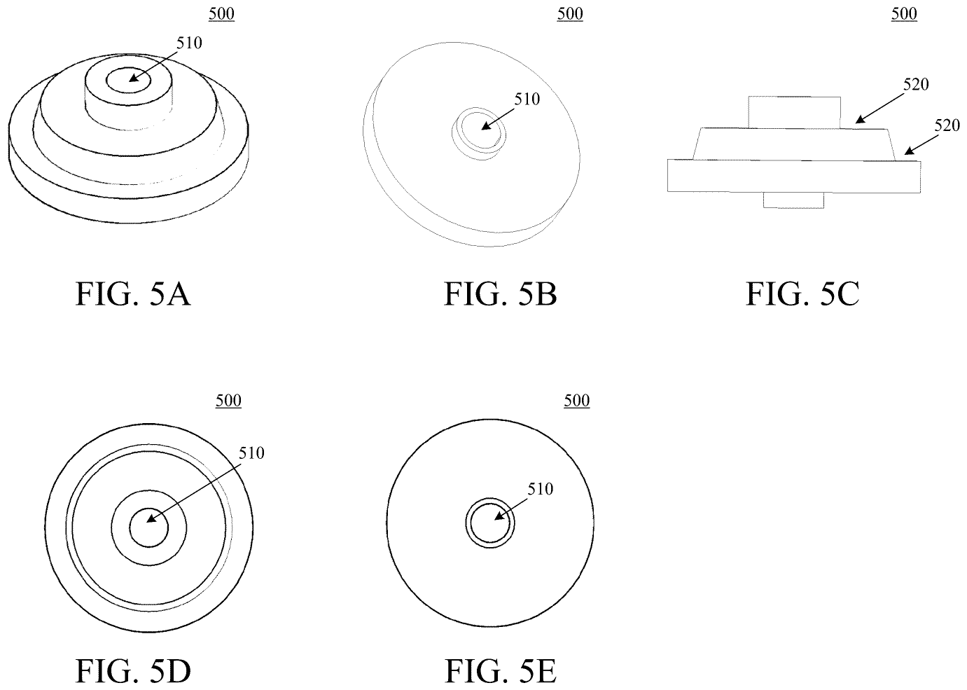

FIGS. 5A-5E depict respective top perspective, bottom perspective, side, top, and bottom views of an outlet connector 500. In some variations, the outlet connector 500 (e.g., gasket) may comprise an elongate body defining a lumen 510 and include a plurality of steps 520 along a length of the elongate body. For example, the outlet connector 500 has 4 steps (e.g., tiers) having different diameters, although any of the outlet connectors described herein may have 2, 3, 4, 5, or more steps. The steps of the outlet connector 500 facilitate an increased contact area between the fluid conduit and the microfluidic chip, thereby strengthening the connection interface.

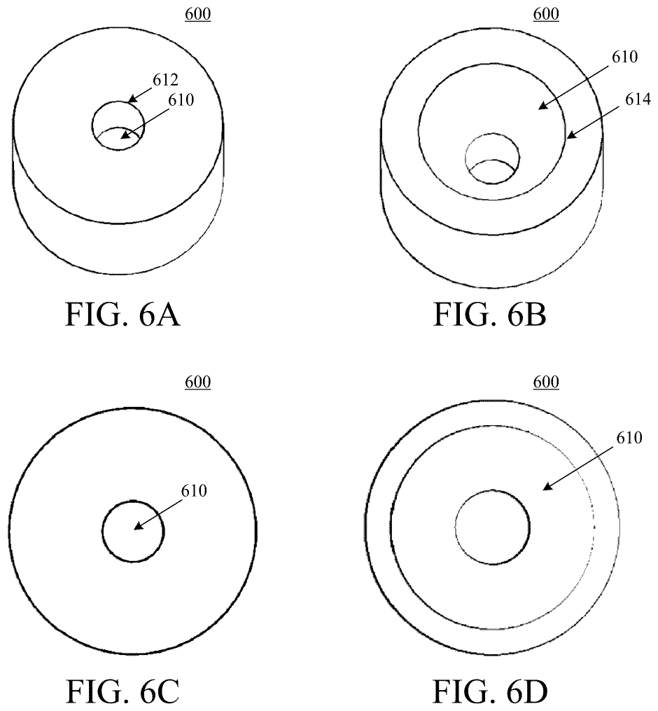

FIGS. 6A-6D depict respective top perspective, bottom perspective, top, and bottom views of an outlet connector 600. In some variations, the outlet connector 600 may comprise an elongate body defining a lumen 610 having an inner diameter decreasing in a distal direction. For example, the lumen 610 may be tapered such that an inner diameter 614 at a proximal end of the outlet connector 600 is larger than an inner diameter 612 at a distal end of the outlet connector 600. For example, the lumen 610 may have a cone-shape and the elongate body may have a cylindrical shape. The lumen 610 having a varying inner diameter may provide an increased tolerance for coupling a fluid conduit to the outlet connector 600 and thereby reduce setup time and leaks due to misalignment.

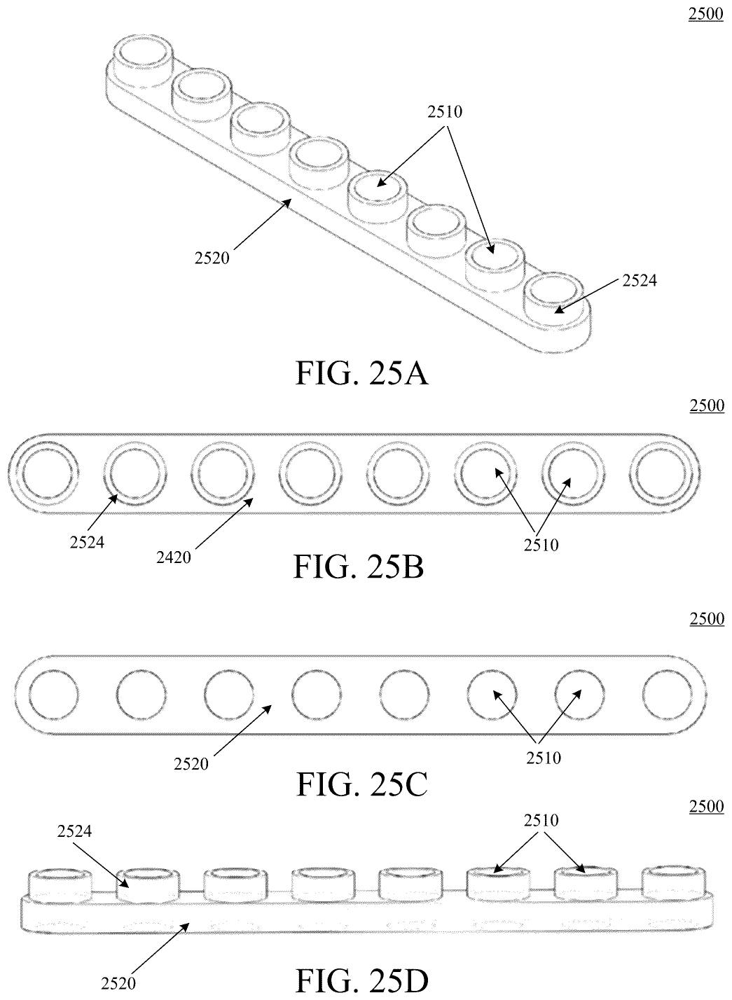

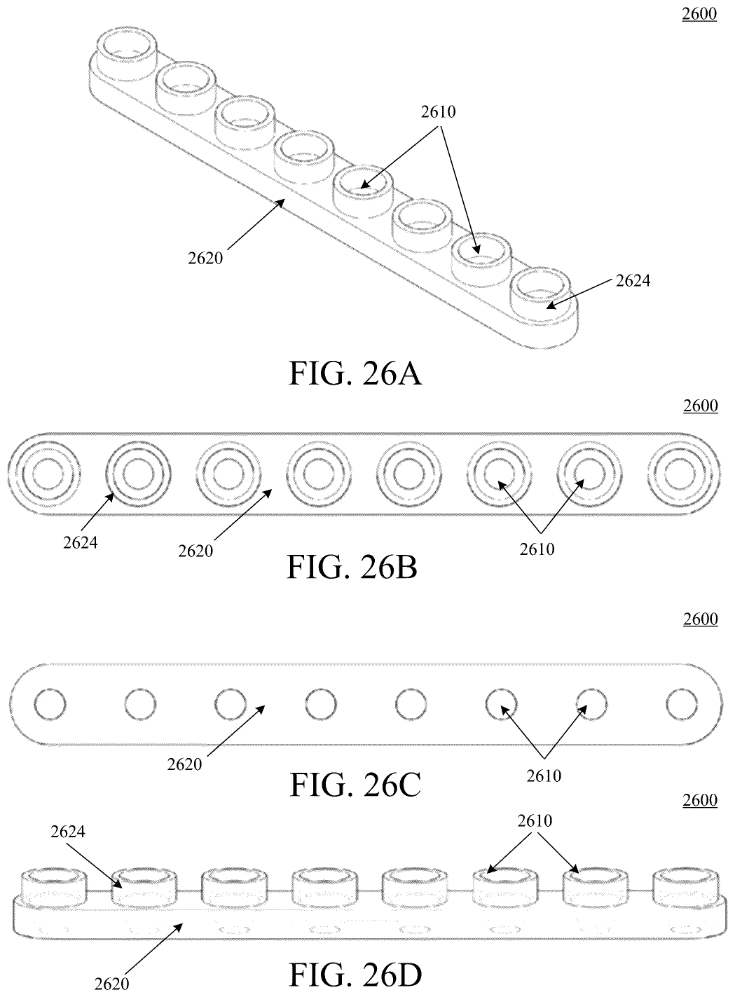

In some variations, a single inlet connector may be configured to transfer (e.g., receive) fluid for a plurality of microfluidic chips, thereby reducing the complexity of the chip connector as well as reducing set-up and cleaning times. FIGS. 24A-24D depicts a perspective view, top view, bottom view, and side perspective view of an inlet connector 2400. FIGS. 25A-25D depicts a perspective view, top view, bottom view, and side perspective view of another inlet connector 2500. FIGS. 26A-26D depicts a perspective view, top view, bottom view, and side perspective view of yet another inlet connector 2600. In some variations, the inlet connector 2400, 2500, 2600 (e.g., gasket) may comprise a body 2420, 2520, 2620 defining a plurality of lumens 2410, 2510, 2610. The plurality of lumens 2410, 2510, 2610 may be configured to be in fluid communication with a corresponding plurality of inlet reservoirs of a microfluidic chip array (e.g., plurality of separate microfluidic chips). The body 2420, 2520, 2620 may comprise one or more collars 2424, 2524, 2624 configured to extend a length of the lumens 2410, 2510, 2610 and facilitate secure fluid communication between an end effector 215 (e.g., pipette) and a respective microfluidic chip, thereby strengthening the connection interface.

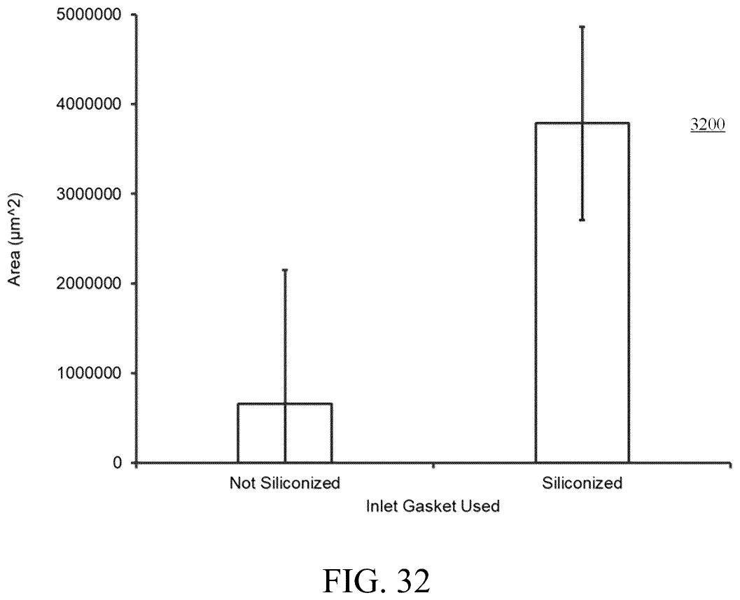

In some variations, the inlet connector 2400, 2500, 2600 may comprise a body defining a plurality of lumens each defining a distal portion (e.g., portion facing an inlet of the microfluidic chip) and a proximal portion (e.g., portion approaching a collar 2424, 2524, 2624). Each lumen 2410, 2510, 2610 may have an inner diameter increasing in one or more of a distal and proximal direction. For example, as shown in FIGS. 24A-24D, the lumen 2410 may be tapered such that the inner diameter increases in both a distal and proximal direction. In particular, the lumen 2410 may have an hourglass-shape within the body 2420 of the inlet connector 2400 and a cylindrical shape through the collar 2424. In some variations, as shown in FIGS. 26A-26D, the lumen 2610 may be tapered such that the inner diameter increases from a distal end to a proximal end. For example, the lumen 2610 may have a cone-shape within the body 2620 of the inlet connector 2600 and a cylindrical shape through the collar 2624. In some variations, the inlet connectors described herein may surprisingly, unexpectedly, and significantly increase ECMB capture amounts in a microfluidic chip. For example, FIG. 32 is a graph 3200 of ECMB amounts on a microfluidic chip (e.g., within a restricted region) based on an inlet connector (e.g., inlet connector 2400, 2500, 2600) including silicone and an inlet connector (e.g., inlet connector 2400, 2500, 2600) absent silicone. In particular, homogenized bovine vitreous humor was perfused through respective 8-channel inlet connector (e.g., inlet connector 2400, 2500, 2600) and into a microfluidic chip, and further stained with Eosin. The inlet connectors having silicone (e.g., a silicone surface) may reduce protein adhesion to a surface of the inlet connector and thereby improve the amount of ECMBs captured in the microfluidic chip. The error bars correspond to standard deviation.

In some variations, a single outlet connector may be configured to transfer (e.g., withdraw) fluid from a plurality of microfluidic chips, thereby reducing the complexity of the chip connector as well as reducing set-up times and cleaning times. For example, the single outlet connector demonstrates a lower standard deviation for flow rates relative to conventional connectors. FIGS. 27A-27D depicts a perspective view, top view, bottom view, and perspective side view of an outlet connector 2700 (e.g., gasket). FIGS. 28A-28D depicts a perspective view, top view, bottom view, and perspective side view of another outlet connector 2800. In some variations, the outlet connector 2700, 2800 may comprise a body 2730, 2830 comprising one or more lumens 2740, 2840. The lumen 2740, 2840 may be configured to receive fluid from a plurality of outlets of a microfluidic chip for transfer through a single outlet of the outlet connector. Additionally, the body 2730, 2830 and one or more lumens 2740, 2840 may be configured to redistribute the negative pressure applied to the microfluidic chip to reduce compression at a respective outlet of the plurality of microfluidic chips, thereby improving flow rate consistency.

In some variations, the lumen 2740, 2840 may define a distal portion (e.g., portion facing an outlet of the microfluidic chip), a proximal portion (e.g., portion approaching a collar 2834), and an inner diameter. As show in FIGS. 27C and 28C, the lumen 2740, 2840 may have a defined inner diameter in the proximal portion and may be tapered in the distal portion such that the inner diameter increases toward the distal end. For example, the lumen 2740, 2840 may have a cylindrical shape in the proximal portion and may have a trough-shape in the distal portion. In some variation, as shown in FIGS. 28A-28D, the body 2830 of the outlet connector may comprise one or more collars 2834 configured to extend one or more lumens 2810 to facilitate fluid communication and contact between the fluid conduit and the microfluidic chip, thereby strengthening the connection interface.

In some variations, the inlet and outlet connectors may comprise suitable materials including one or more silicone-based polymers, other polymers, thermoplastics, thermoplastic elastomers, and the like. For example, one or more of the inlet and outlet connectors may comprise plastic coated with silicone. Inlet and outlet connectors comprising silicone may further improve flow rate consistency. Silicone may include liquid silicone rubber, high consistency silicone, solid silicone rubber, room temperature vulcanized (RTV) silicone, fluorosilicone, combinations thereof, and the like.

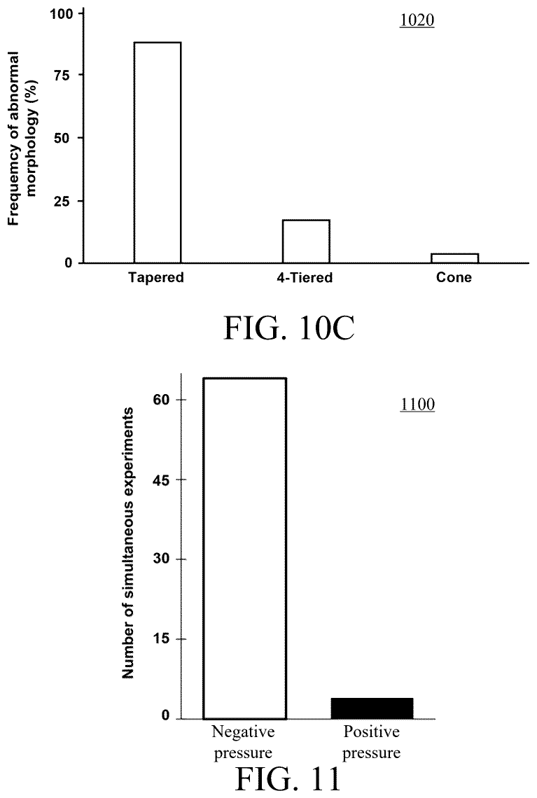

In some variations, a geometry of the disposable inlet and outlet connectors described herein may improve operational aspects of a negative pressure system such as assembly and cleaning that may reduce a set-up time of the system. For example, FIG. 10A is a graph 1000 of set-up time for a 16 microfluidic chip system using a conventional (e.g., tapered) outlet connectors and the outlet connectors described herein. The improved geometry (e.g., tiered, cone shape) of the disposable outlet connectors improve a fluid seal between a chip connector and a fluid conduit of a manifold relative to a tapered outlet connector and may be easier to manipulate so as to reduce set-up time.

In some variations, an overall experiment duration for exemplary staining procedures may be improved using a negative pressure system relative to a positive pressure system. For example, FIG. 10B is a graph 1010 of an overall duration (e.g., including set-up, experiment, cleaning) for immunofluorescence (IF) and CSFE staining procedures for a positive pressure system and a negative pressure system. In particular, the average time for IF experiments decreases about 12 hours using a negative pressure system relative to a positive pressure system. The average time for CFSE staining decreases about 8.25 hours using a negative pressure system relative to a positive pressure system. This increased efficiency may be attributed in part to the disposable outlet connectors and negative pressure source that eliminate the time-consuming (e.g., up to about 8 hours) process of flushing the system to remove contamination. For example, disposable outlet connectors may be replaced rather than cleaned between experiments, thus reducing cleaning time and the overall experiment duration, and lessening variability between connectors due to cleaning variability.

In some variations, the improved fluid seal of the disposable inlet and outlet connectors described herein may reduce contamination in a microfluidic chip corresponding to abnormal morphology relative to a reusable connector used in a positive pressure system. FIG. 10C is a graph 1020 of the average frequency of abnormal BVH morphologies when using a tapered outlet connector and the outlet connectors described herein. For example, an incomplete seal (e.g., air leaking) at a connection interface between a fluid conduit, outlet connector, and microfluidic chip may correspond to an increase in abnormal morphologies. Incomplete seals may in part be due to misalignment of the outlet connector to one or more of the fluid conduit and the microfluidic chip. The improved geometry of the outlet connectors described herein reduce the set-up time and the frequency of abnormal morphologies.

### E. Manifold

The systems described herein may comprise a manifold 120, 220. Generally, a manifold 120, 220 may be configured to couple to a plurality of microfluidic chips 116, 216, 316 and negative pressure source 122, 222. For example, the manifold 120, 220 may be in fluid communication with a single negative pressure source 122, 222 and each microfluidic chip 116, 216, 316 held by a chip connector 118, 218 such that a negative pressure generated by the negative pressure source 122, 222 may be applied to each microfluidic chip 116, 216, 316 coupled to the manifold 120, 220. In some variations, the manifold 120, 220 may comprise a plurality of fluid conduits (e.g., vacuum tubes, fluid lines) configured to be releasably coupled to each of the microfluidic chips 116, 216, 316 and the negative pressure source 122, 222. Accordingly, the manifold may reduce the size of the system 100 since each microfluidic chip does not need its own negative pressure source.

In some variations, the manifold and negative pressure source significantly increase throughput by scaling and increasing efficiency without a reduction in consistency or flowrate. FIG. 11 is a graph 1100 of number of parallel (e.g., simultaneous) experiments performed for a positive pressure system and the negative pressure systems described herein. For example, a manifold coupled to 8 microfluidic chips with each chip having 8 channels enables 64 simultaneous experiments to be run, thereby significantly increasing throughput over positive pressure systems that do not use negative pressure and a manifold. Instead, positive pressure systems rely on pumps and sample injection mechanisms having limited connectivity.

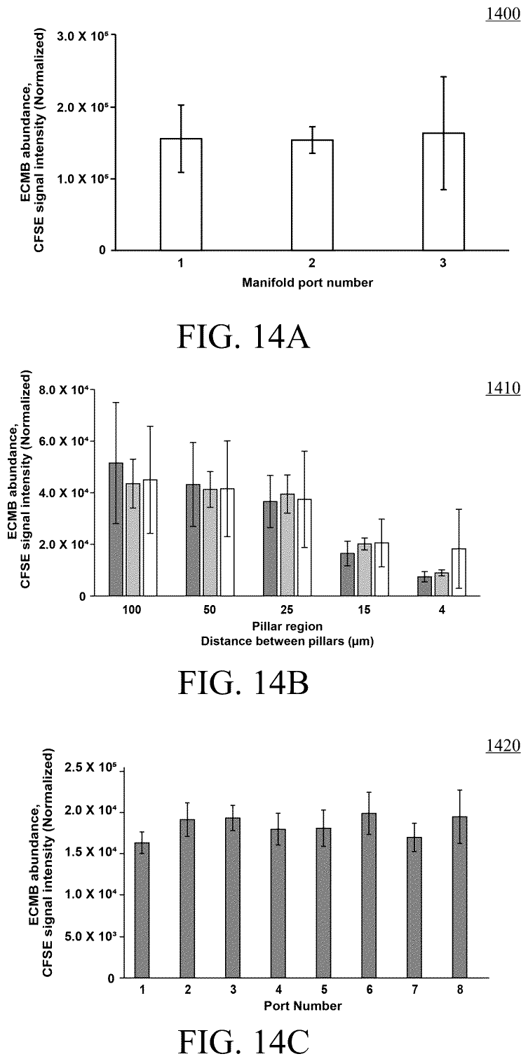

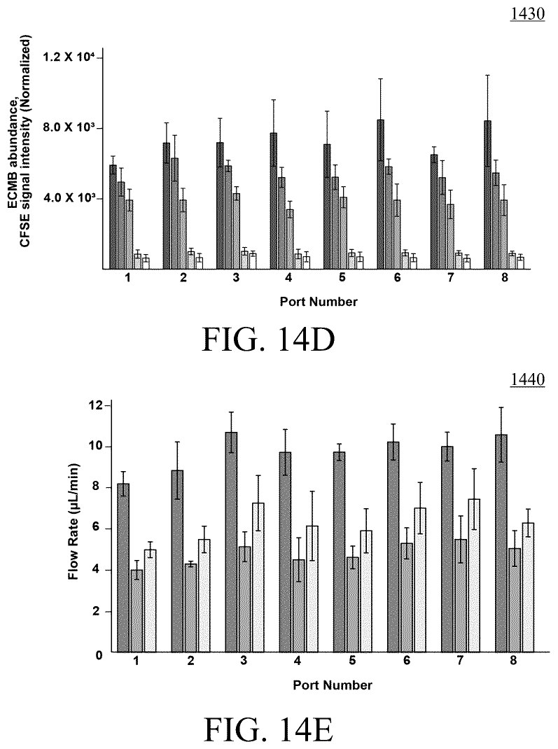

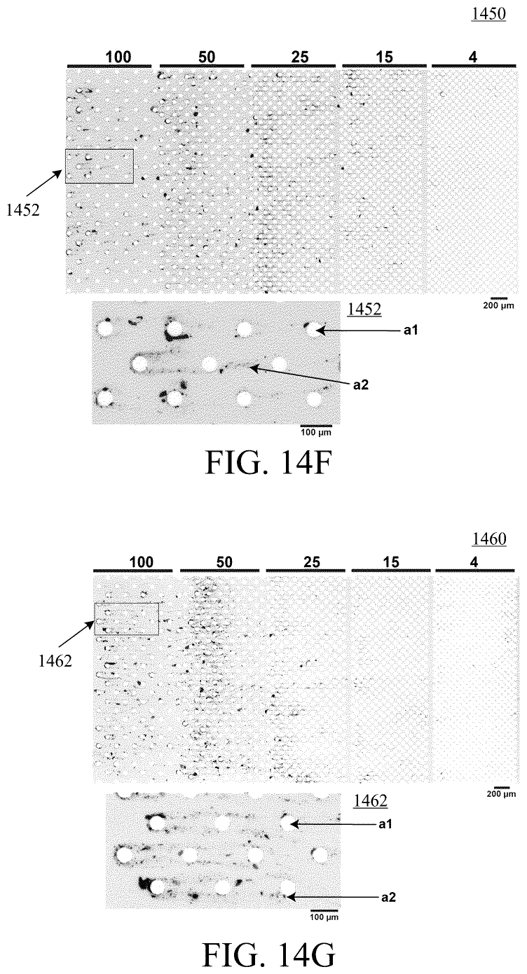

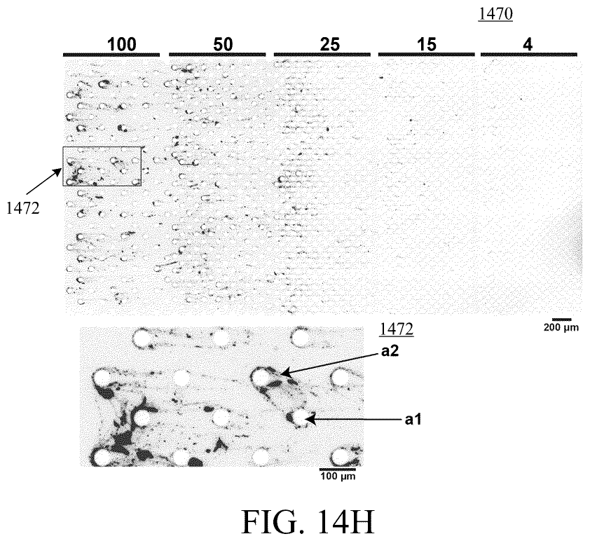

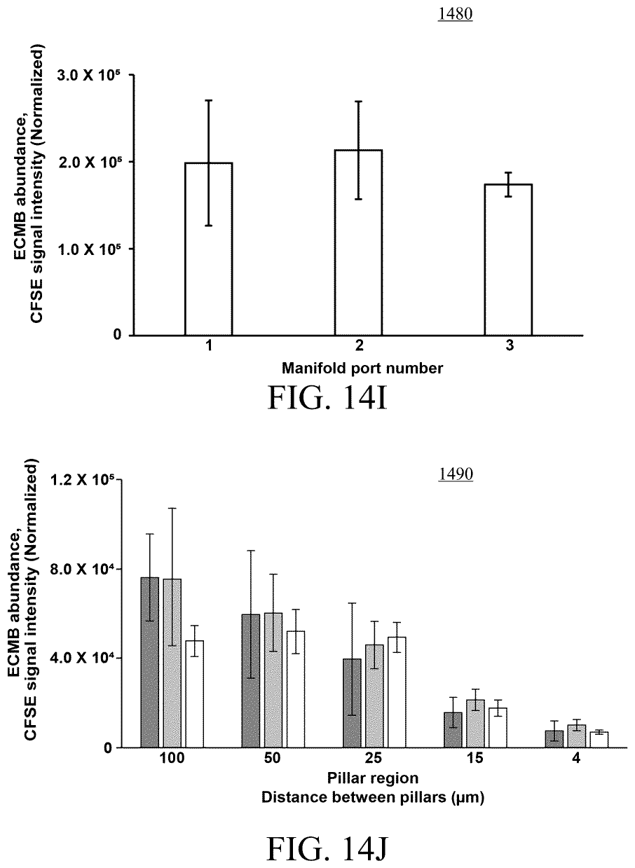

A microfluidic systems described herein comprising a manifold and negative pressure source help to not only increase efficiency and throughput, but do so in a relatively uniform manner otherwise unachievable using conventional solutions. For example, FIG. 14A is a graph 1400 of ECMB amounts based on a 3-port manifold at a negative pressure of 100 mmHg. As can be seen there, the ECMB amounts retrieved from each port are not statistically different (Kruskal-Wallis, p=0.863). However, even at higher negative pressures (e.g., 400 mmHg), the ECMB capture amounts are not statistically different. For example, FIG. 14I is a graph 1480 of ECMB amounts based on a 3-port manifold at a negative pressure of 400 mmHg. The ECMB amounts from each port are not statistically different (Fischer's, p=0.481).

FIG. 14B is a graph 1410 of ECMB amounts across pillar regions having different spacings for different ports of a manifold at a negative pressure of 100 mmHg. For port 1 (dark gray bar), port 2 (light gray bar), and port 3 (white bar), the majority of ECMBs are trapped in the 100 μm, 50 μm, and 25 μm spacing regions. As shown there, there is no statistically significant difference between the ECMB amounts in each pillar region between the different ports (100 μm region—Fisher's, p=0.744, 50 μm region—Kruskal-Wallis, p=0.882, 25 μm region—Fischer's, p=0.912, 15 μm region—Kruskal-Wallis, p=0.490, 4 μm region—Kruskal-Wallis, p=0.230). FIG. 14C is a graph 1420 of ECMB amounts based on an 8-port manifold. The ECMB amounts in each port are not statistically different (p=0.078). Accordingly, the manifold distributes a negative pressure (e.g., 100 mmHg) of vacuum pressure to each port and respective microfluidic chip in a substantially uniform manner. However, even at higher negative pressures (e.g., 400 mmHg), the ECMB capture amounts are not statistically different. For example, FIG. 14J is a graph 1490 of ECMB amounts across pillar regions having different spacings for different ports of a manifold at a negative pressure of 400 mmHg. For port 1 (dark gray bar), port 2 (light gray bar), and port 3 (white bar), the majority of ECMBs are trapped in the 100 μm, 50 μm, and 25 μm spacing regions. There is no statistically significant difference between the ECMB amounts in each pillar region between the different ports (100 μm region—Fischer's, p=0.160, 50 μm region—Fischer's, p=0.745, 25 μm region—Kruskal-Wallis, p=0.475, 15 μm region—Kruskal-Wallis, p=0.393, 4 μm region—Kruskal-Wallis, p=0.114).

Similar to FIG. 14A, the ECMB amounts retrieved from each port of an 8-port manifold are not statistically different. FIG. 14D is a graph 1430 of ECMB amounts across pillar regions having different spacings and an 8-port manifold. The microfluidic chips have 100 μm (very dark gray bar), 50 μm (dark gray bar), 25 μm (medium gray bar), 15 μm (light gray bar), 4 μm (white bar) pillar spacing regions, where the majority of the ECMBs are trapped in the 100 μm, 50 μm, and 25 μm spacing regions. There is no statistically significant difference between the ECMB amounts in each pillar spacing region between the different ports (100 μm region—p=0.067, 50 μm region—p=0.153, 25 μm region—p=0.281, 15 μm region—p=0.943, 4 μm region—p=0.675).

A fluid flow rate through a microfluidic chip being applied with negative pressure through an 8-port manifold may be relatively uniform. For example, FIG. 14E is a graph 1440 of flow rate for three fluid flow processes (e.g., PBS priming, BVH stained with CFSE, PBS wash) using an 8-port manifold at a negative pressure of about 100 mmHg. The flow rates for PBS priming (dark gray bar), BVH and CFSE (medium gray bar), and PBS wash (light gray bar) are not statistically significant different for the different ports (PBS priming—p=0.133, BVH and CFSE loading—p=0.348, PBS wash—p=0.170). However, even at higher negative pressures (e.g., 400 mmHg), the ECMB capture amounts are not statistically different.

FIGS. 14F-14I are images showing trapped ECMBs in a microfluidic chip coupled to a manifold of a negative pressure system. For example, FIG. 14F is an image 1450 of ECMBS a2 stained with CSFE in a microfluidic chip coupled to a three-port manifold at a negative pressure of 100 mmHg. The majority of the ECMBs are trapped in the 100 μm, 50 μm, and 25 μm spaced pillar a1 regions. The magnified image 1452 depicts trapped ECMBs a2 wrapped around pillars a1. FIG. 14G is an image 1460 of ECMBS a2 stained with CSFE in a microfluidic chip coupled to an eight-port manifold at a negative pressure of 100 mmHg. The majority of the ECMBs are trapped in the 100 μm, 50 μm, and 25 μm spaced pillar a1 regions. The magnified image 1462 depicts trapped ECMBs a2 wrapped around pillars a1. FIG. 14H is an image 1470 of ECMBS a2 stained with CSFE in a microfluidic chip coupled to a three-port manifold at a negative pressure of 400 mmHg. The majority of the ECMBs are trapped in the 100 μm, 50 μm, and 25 μm spaced pillar a1 regions. The magnified image 1472 depicts trapped ECMBs a2 wrapped around pillars a1.

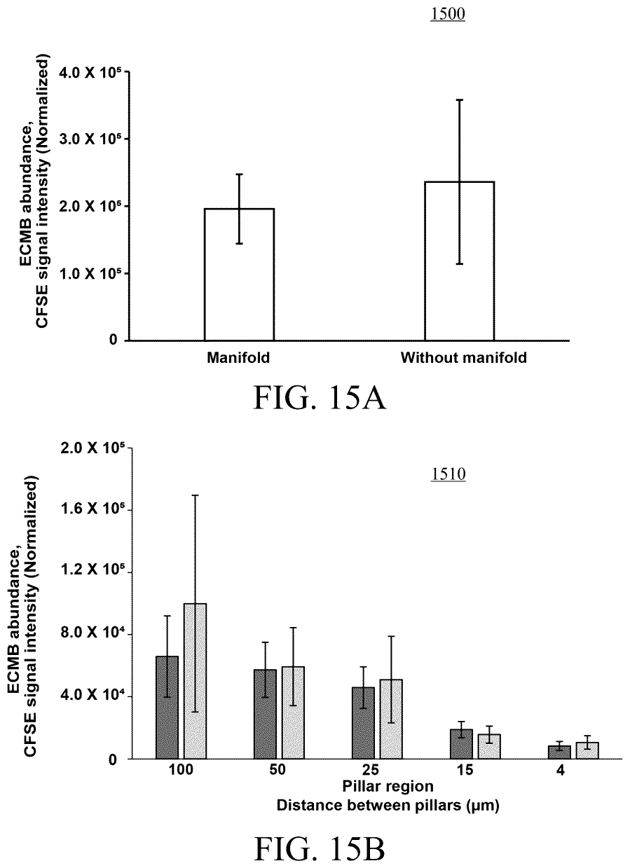

FIG. 15A is a graph 1500 of ECMB amounts using a system with and without a manifold at a negative pressure of 400 mmHg. There is no statistically significant difference between the ECMB amounts for a microfluidic chip with or without coupling to a manifold (Welch's t, p=0.400).

FIG. 15B is a graph 1510 of ECMB amounts across pillar regions having different spacings with and without a manifold at a negative pressure of 400 mmHg. For a manifold (dark gray bar) and a single microfluid chip without a manifold (light gray bar), the majority of ECMBs are trapped in the 100 μm, 50 μm, and 25 μm spacing regions. There is no statistically significant difference between the ECMB amounts in each pillar region with and without a manifold (100 μm region—Welch's t, p=0.220, 50 μm region—Student's t, p=0.831, 25 μm region—Welch's t, p=0.638, 15 μm region—Student's t, p=0.198, 4 μm region—Student's t, p=0.172).

### F. Negative Pressure Source

The systems described herein may comprise a negative pressure source 122, 222. Generally, a negative pressure source 122, 222 may be configured to couple to a manifold 120, 220 and at least one microfluidic chip 116, 216, 316. Application of negative pressure may help reduce contamination and increase processing throughput relative to conventional solutions such as positive pressure systems. In some variations, the negative pressure source may comprise a fluid pump. The processor 128 and memory 130 coupled to the negative pressure source 122, 222 may be configured to control the fluid flow rate and negative pressure. In some variations, the negative pressure source 122, 222 may be configured to apply a negative pressure of between about 10 mm HG and about 760 mm HG to each microfluidic chip 116, 216, 316 of the system 100, 200.

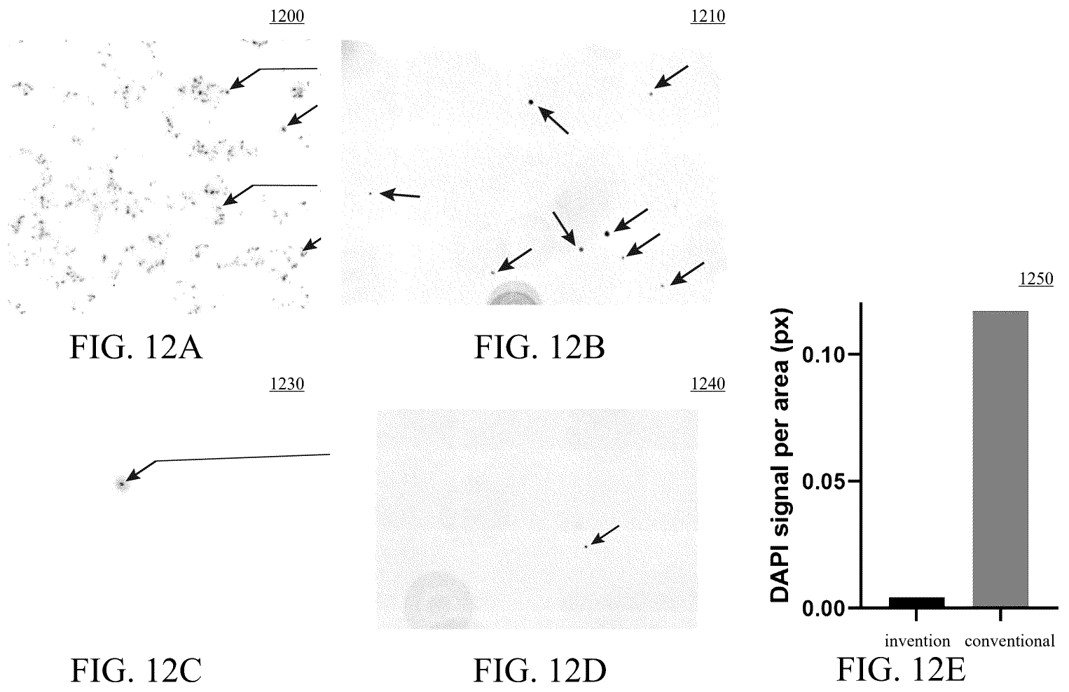

FIGS. 12A and 12B are images 1200, 1200 of biological contamination in a positive pressure microfluidic system following immunofluorescence staining using bovine vitreous humor stained for fibronectin and imaged using fluorescence microscopy. Arrows indicate the biological contaminants. A positive pressure system having a reusable tapered outlet connector was cleaned using a standard operating procedure and a new microfluidic chip was placed in the positive pressure system and provided a buffer flush. FIGS. 12C and 12D are images 1230, 1240 of biological contamination using the systems described herein where the system was cleaned using a standard operating procedure and a new microfluidic chip was placed in the chip connector and provided a buffer flush and a new outlet connector. FIG. 12E is a graph 1250 of biological contamination per area for a positive pressure system and a negative pressure system. The systems utilizing negative pressure and an outlet connector described herein provide significantly reduced contamination relative to a positive pressure system, thereby increasing the precision and reliability of the systems described herein.

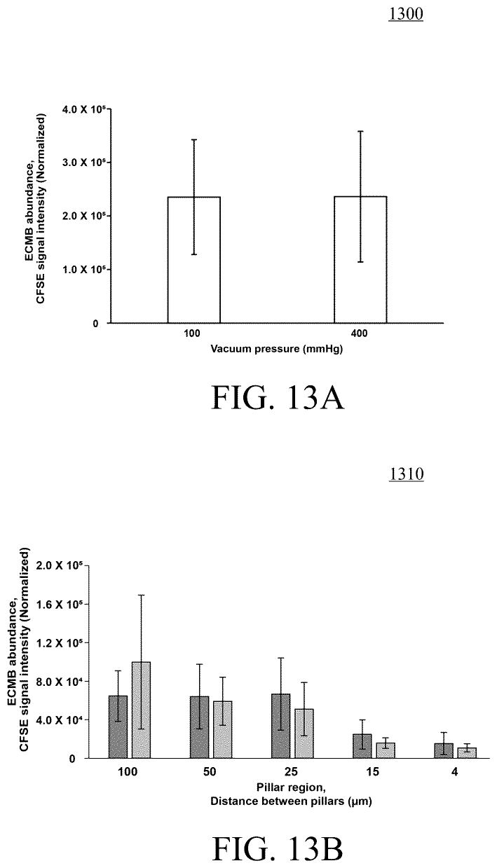

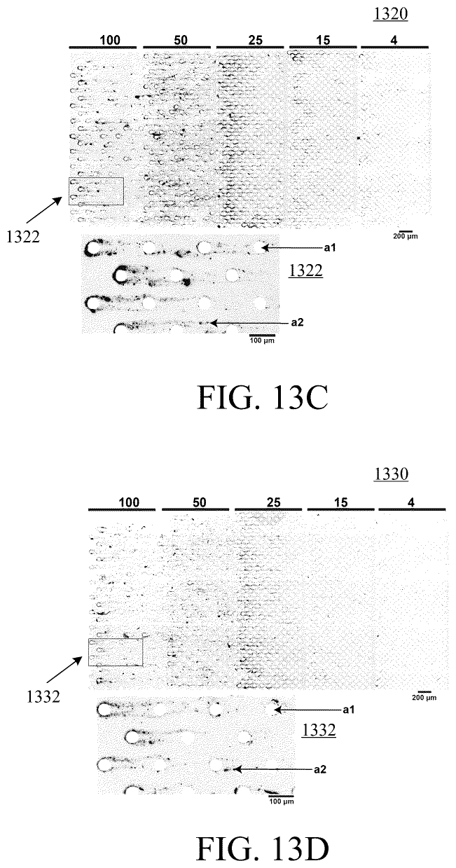

In some variations, a trapped ECMB amount in a microfluidic chip does not necessarily increase linearly with an amount of applied negative pressure. For example, FIG. 13A is a graph 1300 of ECMB amounts for negative pressures of 100 mmHg and 400 mmHg. The ECMB amounts for each negative pressure is not statistically different (Student's t, p=0.988). Similarly, FIG. 13B is a graph 1310 of ECMB amounts across pillar regions having different spacings for negative pressures of 100 mmHg and 400 mmHg. For a 100 mmHg negative pressure (dark gray bar) and a 400 mmHg negative pressure (light gray bar), the majority of ECMBs are trapped in the 100 μm, 50 μm, and 25 μm spacing regions. There is no statistically significant difference between the ECMB amounts in each pillar region between the different negative pressures (100 μm region—Welch's t, p=0.211; 50 μm region—Student's t, p=0.738; 25 μm region—Student's t, p=0.335; 15 μm region—Mann-Whitney U, p=0.238; 4 μm region—Mann-Whitney U, p=0.657).

FIGS. 13C and 13D are images showing trapped ECMBs in a microfluidic chip coupled to a negative pressure system at different negative pressures. For example, FIG. 13C is an image 1320 of ECMBS a2 stained with CSFE at a negative pressure of 100 mmHg. The majority of the ECMBs are trapped in the 100 μm, 50 μm, and 25 μm spaced pillar a1 regions. The magnified image 1322 depicts trapped ECMBs a2 wrapped around pillars a1. FIG. 13D is an image 1330 of ECMBS a2 stained with CSFE at a negative pressure of 400 mmHg. The majority of the ECMBs are trapped in the 100 μm, 50 μm, and 25 μm spaced pillar a1 regions. The magnified image 1332 depicts trapped ECMBs a2 wrapped around pillars a1.

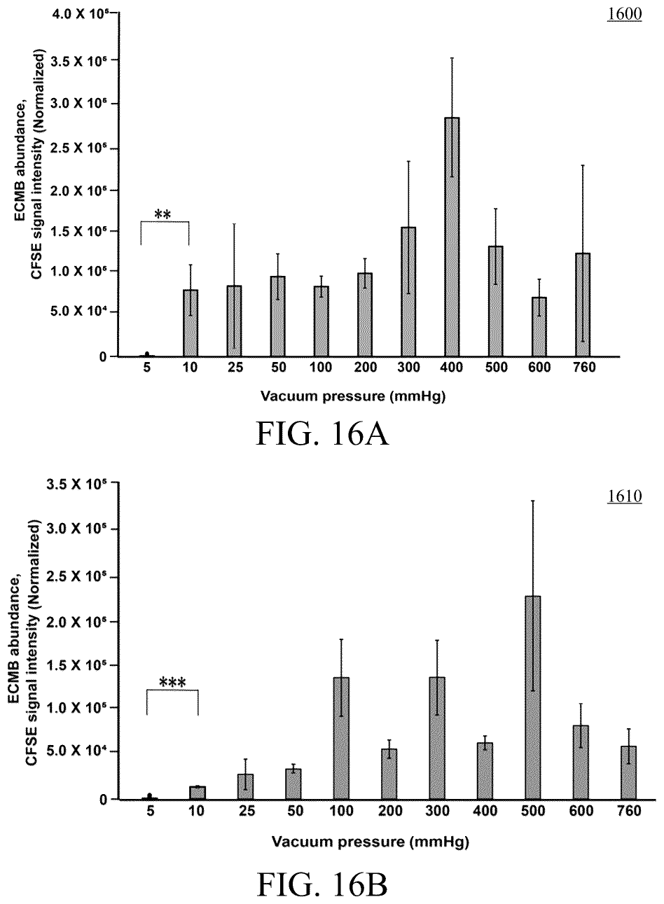

In some variations, a negative pressure of between about 10 mm HG and about 760 mm HG applied to a microfluidic chip may effectively separate ECMBs from a biological fluid. For example, FIGS. 16A and 16B are respective graphs 1600, 1610 of ECMB amounts trapped in a microfluidic channel of a microfluidic chip using negative pressures of between 10 mmHg and 760 mmHg and respective cone-shaped outlet connectors (e.g., FIGS. 6A-6D) and tiered outlet connectors (e.g., FIGS. 5A-5E). For FIG. 16A, the amount of ECMBS trapped at 5 mmHg is statistically significantly smaller than at negative pressures between 10 mmHg and 760 mmHg based on the t-test (Welch's, p=0.001). Similarly for FIG. 16B, the amount of ECMBS trapped at 5 mmHg is statistically significantly smaller than at negative pressures between 10 mmHg and 760 mmHg based on the t-test (Student's, p<0.001).

### G. Sensor

The systems described herein may comprise one or more sensors 124. Generally, a sensor 124 may be configured to measure one or more characteristics (e.g., pressure, flow rate, optical image, temperature, humidity) corresponding to one or more of the biological fluid, holder 112, 212, reservoir 113, 213, robot 114, 214, microfluidic chip 116, 216, 316, chip connector 118, 218, manifold 120, 220, and negative pressure source 122, 222. In this way, the system and the fluids may be monitored during use. In some variations, a sensor may be coupled to or integrated into any component of the system 100 such as the inlet connector, chip connector, etc.

In some variations, the sensor may be an optical sensor coupled to any component of the system 100, 200 such as the chip connector 118, 218. The optical sensor may be configured to image one or more channels of the microfluidic chips 116, 216, 316 for histochemical and morphological study. The optical sensor may be used to receive light signals (e.g., light beams) reflected by the fluid in the microfluidic chip 116, 216, 316. The received light may be used to generate signal data that may be processed by the processor 128 and memory 130 to generate sample data. The optical sensor may further be configured to image one or more identifiers (e.g., label, barcode) and identifiers of the microfluidic chip 116, 216, 316. In some variations, the optical sensor may include one or more of a lens, camera, and measurement optics. For example, the optical sensor may include a charged coupled device (CCD) or complementary metal-oxide semiconductor (CMOS) optical sensor and may be configured to generate an image signal that is transmitted to a output device 134 (e.g., display). For example, the optical sensor may include a camera with an image sensor (e.g., a CMOS or CCD array with or without a color filter array and associated processing circuitry). Additionally or alternatively, the sensor in some variations may be an ultrasound sensor configured to generate an ultrasound signal used to determine a fluid flow rate.

In some variations, the system 100, 200 may include a radiation source configured to emit a light signal (e.g., illumination) directed at the microfluidic chip 116, 216, 316 for visualization, imaging, and/or cleaning (e.g., UV light). In some variations, the radiation source may include one or more of a light emitting diode, laser, microscope, optical sensor, lens, and flash lamp. For example, the radiation source may generate light that may be carried by fiber optic cables or one or more LEDs may be configured to provide illumination. In another example, a fiberscope including a bundle of flexible optical fibers may be configured to receive and propagate light from an external light source.

### H. Input Device

Generally, an input device 126 of a system 100, 200 may serve as a communication interface between an operator and the system 100, 200. The input device 126 may be configured to receive input data and output data to one or more of the robot 114, sensor 124, and output device 134. For example, operator control of an input device 126 (e.g., foot controller, joystick, keyboard, touch screen) may be processed by processor 128 and memory 130 for input device 126 to output a control signal to one or more of robot 114, 214, negative pressure source, and sensor 124. As another example, images generated by sensor 124 may be processed by processor 128 and memory 130, and displayed by the output device 134 (e.g., display). Sensor data from one or more sensors 124 may be output visually, audibly, and/or through haptic feedback by one or more output devices 134.

Some variations of an input device may comprise at least one switch configured to generate a control signal. The input device may be coupled to or separate from other components of the system 100, 200. For example, the input device 126 may be disposed in a different room than the robot 114, 214 and microfluidic chip 116, 216, 316 to reduce potential contamination. The control signal may include, for example, a robot signal, a negative pressure signal, a sensor signal, and other signals. In some variations, the input device 126 may comprise a wired and/or wireless transmitter configured to transmit a control signal to a wired and/or wireless receiver of a controller. A robot signal (e.g., for the control of movement, position, and orientation) may control articulation of the robot in at least four degrees of freedom of motion, and may include yaw and/or pitch rotation. For example, an input device 126 comprising a touch surface may be configured to detect contact and movement on the touch surface using any of a plurality of touch sensitivity technologies including capacitive, resistive, infrared, optical imaging, dispersive signal, acoustic pulse recognition, and surface acoustic wave technologies.

In variations of an input device 126 comprising at least one switch, a switch may comprise, for example, at least one of a button (e.g., hard key, soft key), touch surface, keyboard, analog stick (e.g., joystick), directional pad, mouse, trackball, jog dial, step switch, rocker switch, pointer device (e.g., stylus), motion sensor, image sensor, and microphone. A motion sensor may receive operator movement data from an optical sensor and classify an operator gesture as a control signal. A microphone may receive audio and recognize an operator voice as a control signal. In variations of a system comprising a plurality of input devices, different input devices may generate different types of signals. For example, some input devices (e.g., button, analog stick, directional pad, and keyboard) may be configured to generate a robot signal while other input devices (e.g., step switch, rocker switch) may be configured to control a negative pressure source 122, 222 and the sensors 124.

### I. Processor

A system 100, 200, as depicted in FIG. 1, may comprise a processor 128 and a machine-readable memory 130 (e.g., controller) in communication with the robot 114, 214, negative pressure source 122, 222, and sensor(s) 124. The processor 128 may be connected to the system 100, 200 by wired or wireless communication channels. The processor 128 may be located in the same or different room as the microfluidic chips 116, 216, 316. The processor 128 may be configured to control one or more components of the system 100, 200, such as the robot 114, 214 configured to transfer fluids to the microfluidic chip or an optical sensor configured to visualize ECMBs separated using the microfluidic chip 116, 216, 316.

The processor 128 may be implemented consistent with numerous general purpose or special purpose computing systems or configurations. Various exemplary computing systems, environments, and/or configurations that may be suitable for use with the systems and devices disclosed herein may include, but are not limited to software or other components within or embodied on personal computing devices, network appliances, servers or server computing devices such as routing/connectivity components, portable (e.g., hand-held) or laptop devices, multiprocessor systems, microprocessor-based systems, and distributed computing networks.

Examples of portable computing devices include smartphones, personal digital assistants (PDAs), cell phones, tablet PCs, phablets (personal computing devices that are larger than a smartphone, but smaller than a tablet), wearable computers taking the form of smartwatches, portable music devices, and the like, and portable or wearable augmented reality devices that interface with an operator's environment through sensors and may use head-mounted displays for visualization, eye gaze tracking, and user input.

The processor 128 may incorporate data received from memory 130 and operator input to control one or more robots 114, 214 and negative pressure source 122, 222. The memory 130 may further store instructions to cause the processor 128 to execute modules, processes, and/or functions associated with the system 100, 200. The processor 128 may be any suitable processing device configured to run and/or execute a set of instructions or code and may comprise one or more data processors, image processors, graphics processing units, physics processing units, digital signal processors, and/or central processing units. The processor 128 may be, for example, a general purpose processor, a Field Programmable Gate Array (FPGA), an Application Specific Integrated Circuit (ASIC), configured to execute application processes and/or other modules, processes, and/or functions associated with the system and/or a network associated therewith. The underlying device technologies may be provided in a variety of component types such as metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, combinations thereof, and the like.

### J. Memory

Some variations of memory 130 described herein relate to a computer storage product with a non-transitory computer-readable medium (also may be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as air or a cable). The media and computer code (also may be referred to as code or algorithm) may be those designed and constructed for a specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical discs; solid state storage devices such as a solid state drive (SSD) and a solid state hybrid drive (SSHD); carrier wave signal processing modules; and hardware devices that are specially configured to store and execute program code such as Application-Specific Integrated Circuits (ASICs), Programmable Logic Devices (PLDs), Read-Only Memory (ROM), and Random-Access Memory (RAM) devices. Other variations described herein relate to a computer program product, which may include, for example, the instructions and/or computer code disclosed herein.

The systems, devices, and/or methods described herein may be performed by software (executed on hardware), hardware, or a combination thereof. Software modules (executed on hardware) may be expressed in a variety of software languages (e.g., computer code), including C, C++, Java®, Python, Ruby, Visual Basic®, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

### K. Communication Device

In some variations, systems 100, 200 described herein may communicate with networks and computer systems through a communication device 128. In some variations, the system 100, 200 may be in communication with other devices via one or more wired and/or wireless networks. A wireless network may refer to any type of digital network that is not connected by cables of any kind. Examples of wireless communication in a wireless network include, but are not limited to cellular, radio, satellite, and microwave communication. However, a wireless network may connect to a wired network in order to interface with the Internet, other carrier voice and data networks, business networks, and personal networks. A wired network is typically carried over copper twisted pair, coaxial cable and/or fiber optic cables. There are many different types of wired networks including wide area networks (WAN), metropolitan area networks (MAN), local area networks (LAN), Internet area networks (IAN), campus area networks (CAN), global area networks (GAN), like the Internet, and virtual private networks (VPN). Hereinafter, network refers to any combination of wireless, wired, public and private data networks that are typically interconnected through the Internet, to provide a unified networking and information access system.

Cellular communication may encompass technologies such as GSM, PCS, CDMA or GPRS, W-CDMA, EDGE or CDMA2000, LTE, WiMAX, and 5G networking standards. Some wireless network deployments combine networks from multiple cellular networks or use a mix of cellular, Wi-Fi, and satellite communication. In some variations, the communication device 132 may comprise a radiofrequency receiver, transmitter, and/or optical (e.g., infrared) receiver and transmitter. The communication device 132 may communicate by wires and/or wirelessly with one or more of the robot 114, 214, negative pressure source 122, 222, sensor 124, input device 126, output device 134, network, database, server, combinations thereof, and the like.

### L. Output Device

An output device 134 of a system 100, 200 may be configured to output data corresponding to a system, and may comprise one or more of a display device, audio device, and haptic device. For example, a display device may allow an operator to view images of one or more microfluidic chips 116, 216, 316 and the robot 114, 214. In some variations, an output device may comprise a display device including at least one of a light emitting diode (LED), liquid crystal display (LCD), electroluminescent display (ELD), plasma display panel (PDP), thin film transistor (TFT), organic light emitting diodes (OLED), electronic paper/e-ink display, laser display, and/or holographic display.

An audio device may audibly output fluid data, sensor data, system data, alarms and/or warnings. For example, the audio device may output an audible warning when sensor data (e.g., pressure, flow rate) falls outside a predetermined range or when a malfunction in a robot is detected. As another example, audio may be output when operator input is overridden by the system to prevent potential harm to the operator and/or system (e.g., robot collision, excessive negative pressure). In some variations, an audio device may comprise at least one of a speaker, piezoelectric audio device, magnetostrictive speaker, and/or digital speaker. In some variations, an operator may communicate to other users using the audio device and a communication channel. For example, the operator may form an audio communication channel (e.g., VoIP call) with a remote operator and/or observer.

A haptic device may be incorporated into one or more of the input and output devices to provide additional sensory output (e.g., force feedback) to the operator. For example, a haptic device may generate a tactile response (e.g., vibration) to confirm operator input to an input device (e.g., touch surface). Additionally or alternatively, haptic feedback may notify that an operator input is overridden by the system to prevent potential harm to the operator and/or system (e.g., robot collision, excessive negative pressure).

### II. Methods

Also described here are methods for separating ECMBs from a biological fluid. The methods described herein may be useful in providing high-throughput separation of ECMBs and biological fluids so that additional analysis may be performed, for example analysis of the ECMBs or the biological fluids (or portions or fractions thereof) to help diagnose and/or develop a treatment plan for a subject, and to monitor the effectiveness of a treatment plan. For example, a predetermined fraction of the biological fluid or the ECMBs may be analyzed to determine an amount of a biomarker associated with a disease, which may be useful in diagnosis and target identification. Biomarkers may be used not only for disease screening and prediction, but also to help support disease prognosis, facilitate treatment selection, subtype patients for clinical trials, and/or monitor both the safety and therapeutic signals in subjects after treatment has begun, and during the course of treatment. In some variations, pharmacodynamic biomarkers may function as endpoints for clinical trials and may be surrogate endpoints.

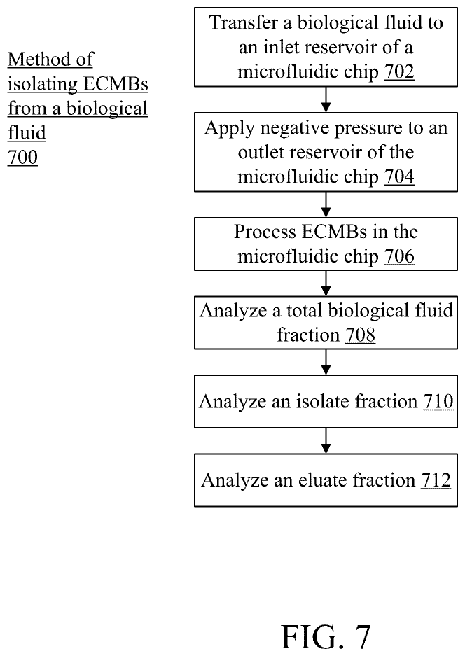

FIG. 7 is flowchart that generally describes a method of separating ECMBs from a biological fluid 700 using any of the systems and devices described herein. The method 700 may include transferring a biological fluid (e.g., about 400 μl sample) to an inlet reservoir of a microfluidic chip 702. For example, the microfluidic chip may comprise at least one restriction channel (e.g., uniform flow channel) having an inlet and an outlet. The inlet reservoir may be fluidically coupled to the inlet of the at least one restriction channel, and at least one obstruction (e.g., pillar), and an outlet reservoir. Optionally, the microfluidic chip may be primed with a buffer prior to receiving the biological fluid. A vacuum seal may be made and maintained within the system to minimize air bubbles in the microfluidic chip.

In some variations, a negative pressure of between about 10 mm HG and about 760 mm HG may be applied to the outlet reservoir of the microfluidic chip 704. The applied negative pressure may remove the non-ECMB portion of the biological fluid from the microfluidic chip while the ECMBs remain disposed within the microfluidic chip. For example, as the fluid flows through the microfluidic chip, the shape of the ECMBs within the fluid is modified by contact (e.g., bending) with the obstructions (e.g., pillars) disposed within the microfluidic chip to facilitate immobilization of ECMBs within the microfluidic chip (e.g., attachment of ECMBs to the pillars).

In some variations, the ECMBs in the microfluidic chip may be processed 706. For example, the ECMBs in the microfluidic chip may be applied with one or more of a histochemical stain, an immunohistochemical (IHC) stain, a multiplex IHC stain, multi-spectral imaging, a protein stain, a nucleic acid stain, chemical fixation, and a protease inhibitor. For example, human plasma may be stained with hematoxylin and eosin. As described in more detail herein, histochemical staining may be used in any of the analytical methods described above.

In some variations, one or more predetermined antibodies (e.g., for extracellular matrix materials, extracellular vesicle markers), washes, and reagents may be applied to the microfluidic chip to help enable IHC staining. For example, a plurality of antibodies (e.g., extracellular matrix, cancer-related markers, extracellular vesicle markers) may be applied to the microfluidic chip IHC for multispectral imaging.

In some variations, successive staining of an isolate fraction on the microfluidic chip may help remove the material within the microfluidic chip. For example, antibody staining of a sample may generate a first spatial arrangement on the microfluidic chip. If the microfluidic chip is subsequently stained (e.g., with a different set of reagents), a second spatial arrangement different from the first spatial arrangement may be generated due to movement of the sample within the microfluidic chip. Thus, a useful comparison between the first and second spatial arrangements may be challenging. Accordingly, chemical fixation (e.g., crosslinking) of biological fluid (e.g., ECMBS) on the chip may be applied to immobilize the biological fluid in the microfluidic chip. For example, the microfluidic chip may receive a carbodiimide fixative and aldehyde fixative configured to crosslink the biological fluid to immobilize the biological fluid on the microfluidic chip. In some variations, an inlet and outlet of the microfluidic chip may be sealed.

In some variations, one or more biomarkers in one or more of the biological fluids and the ECMBs may be measured by one or more of immunoassay, microscopy, immunohistochemistry, fluorescence in situ hybridization, immunofluorescence, infrared, and UV-VIS.

In some variations, the biological fluid may be analyzed as a total biological fluid fraction prior to transferring the biological fluid 708. In some variations, the ECMBs remaining in the microfluidic chip may be analyzed as an isolate fraction after applying the negative pressure 710. In some variations, the biological fluid removed from the microfluidic chip may be analyzed as an eluate fraction after applying the negative pressure 712. In some variations, the biological fluid removed from the microfluidic chip may be processed using one or more of microfluidic separation, affinity chromatography, centrifugation, differential centrifugation, density gradient centrifugation, mesh filtration, ultrafiltration, diafiltration, tangential flow filtration, membrane filtration, immuno-affinity capture, magnetic bead capture, size exclusion chromatography, electrophoresis, and AC electrokinetics.

In some variations, the biological fluid removed from the microfluidic chip (e.g., eluate fraction, total fluid, trapped material) may be analyzed using one or more of microscopy, microfluidic device, mass spectrometry, microarray, nucleic acid amplification, hybridization, proteomic profiling, fluorescence hybridization, immunohistochemistry, nucleic acid analysis or sequencing, next generation sequencing, flow cytometry, chromatography, electrophoresis, immunostaining, fluorescence assay, fluorescent in situ hybridization (FISH), chelate complexation, quantitative HPLC, spectrophotometry, colorimetric assay, chemiluminescence assay, immunofluorescence assay, light scattering, antibody array, Western blot, immunoassay, immunoprecipitation, ELISA, LC-MS, LC-MRM, radioimmunoassay, 2D gel mass spectrometry, LC-MS/MS, RT-PCR, and quantitative PCR.

Although the foregoing variations have, for the purposes of clarity and understanding, been described in some detail by illustration and example, it will be apparent that certain changes and modifications may be practiced and are intended to fall within the scope of the appended claims. Additionally, it should be understood that the components and characteristics of the systems and devices described herein may be used in any combination. The description of certain elements or characteristics with respect to a specific figure are not intended to be limiting or nor should they be interpreted to suggest that the element cannot be used in combination with any of the other described elements. For all of the variations described herein, the steps of the methods may not be performed sequentially. Some steps are optional such that every step of the methods may not be performed.

We claim:

1. A system for separating extra-cellular matrix bodies (ECMBs) from a biological fluid, comprising:
a holder configured to receive the biological fluid;
a robot configured to transfer the biological fluid from the holder to a microfluidic chip;
a chip connector configured to hold at least one microfluidic chip;
a manifold coupled to the at least one microfluidic chip; and
a negative pressure source coupled to the manifold, the negative pressure source configured to apply a negative pressure of between about 10 mm HG and about 760 mm HG to the at least one microfluidic chip.

2. The system of claim 1, wherein the chip connector comprises a base configured to contact a bottom portion of the at least one microfluidic chip, and a cover configured to contact a top portion of the at least one microfluidic chip.

3. The system of claim 1, wherein the chip connector is configured to distribute a compression force applied by the negative pressure to a perimeter of the microfluidic chip.

4. The system of claim 2, wherein the bottom portion comprises a perimeter of the at least one microfluidic chip.

5. The system of claim 2, wherein the cover defines a plurality of apertures.

6. The system of claim 2, wherein the base comprises a first fastener and the cover comprises a second fastener, the first fastener and the second fastener configured to align the microfluidic chip in a predetermined orientation.

7. The system of claim 1, further comprising at least one inlet connector and at least one outlet connector disposed between the cover and the at least one microfluidic chip.

8. The system of claim 7, wherein the at least one outlet connector comprises an elongate body defining a lumen and comprising a plurality of steps along a length of the elongate body.

9. The system of claim 7, wherein the at least one outlet connector comprises an elongate body defining a lumen having an inner diameter decreasing in a distal direction.

10. The system of claim 7, wherein one or more the microfluidic chip, the inlet connector, and the outlet connector comprise a disposable component.

11. The system of claim 1, wherein the chip connector comprises a durable component.

12. The system of claim 1, wherein the holder is configured to receive one or more reagents, and the robot is configured to transfer the one or more reagents from the holder to the microfluidic chip.

13. The system of claim 1, further comprising a sensor coupled to the at least one inlet connector, the sensor configured to measure one or more of flow rate and pressure.

14. The system of claim 1, further comprising an optical sensor coupled to the chip connector, the optical sensor configured to image one or more of the microfluidic chips.

15. The system of claim 1, wherein the at least one microfluidic chip comprises at least one restriction channel fluidically coupled between an inlet and an outlet of the microfluidic chip.

16. The system of claim 15, wherein the at least one restriction channel comprises at least one obstruction.

17. The system of claim 15, wherein the at least one restriction channel comprises a length of between about 5 mm and about 30 mm.

18. The system of claim 15, wherein the at least one restriction channel comprises a cross-sectional dimension of between about 5 μm and about 30 μm.

19. The system of claim 1, wherein the at least one microfluidic chip comprises at least one obstruction configured to restrict fluid flow.

20. The system of claim 19, wherein the at least one obstruction comprises a pillar.

21. The system of claim 1, wherein the at least one microfluidic chip comprises a restricted region configured to hold a first fraction of the biological fluid and permit fluid flow of a second fraction of the biological fluid.

22. The system of claim 21, wherein the first fraction comprises the ECMBs.

23. The system of claim 21, wherein the restricted region comprises a plurality of obstructions configured to hold the first fraction.

24. The system of claim 23, wherein a spacing between the plurality of obstructions in the restricted region decreases along a length of the microfluidic chip from an inlet of the restricted region to an outlet of the restricted region.

25. The system of claim 23, wherein the spacing between the plurality of obstructions in the restricted region is between about 100 μm and about 4 μm.

26. The system of claim 23, wherein each obstruction of the plurality of obstructions comprise a diameter of between about 50 μm and about 1 mm.

27. A method of separating extra-cellular matrix bodies (ECMBs) from a biological fluid, comprising:
transferring the biological fluid to an inlet reservoir of a microfluidic chip, the microfluidic chip comprising:
at least one restriction channel having an inlet and an outlet, wherein the inlet reservoir is fluidically coupled to the inlet of the at least one restriction channel, and
at least one pillar, and
an outlet reservoir; and
applying negative pressure of between about 10 mm HG and about 760 mm HG to the outlet reservoir of the microfluidic chip, wherein the ECMBs remain in the microfluidic chip after removal of the biological fluid from the microfluidic chip.

28. The method of claim 27, further comprising distributing a compression force applied by the negative pressure from the outlet reservoir to a perimeter of the microfluidic chip.

29. The method of claim 27, wherein the at least one restriction channel comprises the at least one pillar.

30. The method of claim 27, wherein the at least one restriction channel comprises a length of between about 5 mm and about 30 mm.

31. The method of claim 27, wherein the at least one restriction channel comprises a cross-sectional dimension of between about 5 μm and about 30 μm.

32. The method of claim 27, wherein the at least one microfluidic chip comprises at least one obstruction configured to restrict fluid flow.

33. The method of claim 27, wherein the at least one microfluidic chip comprises a restricted region configured to hold a first fraction of the biological fluid and permit fluid flow of a second fraction of the biological fluid.

34. The method of claim 33, wherein the restricted region comprises a plurality of obstructions configured to hold the first fraction.

35. The method of claim 34, wherein a spacing between the plurality of obstructions in the restricted region decreases along a length of the microfluidic chip from an inlet of the restricted region to an outlet of the restricted region.

36. The method of claim 34, wherein the spacing between the plurality of obstructions in the restricted region is between about 100 μm and about 4 μm.

37. The method of claim 34, wherein each obstruction of the plurality of obstructions comprise a diameter of between about 50 μm and about 1 mm.

38. The method of claim 27, further comprising applying to the ECMBs in the microfluidic chip one or more of a histochemical stain, an immunohistochemical (IHC) stain, a multiplex IHC stain, multi-spectral imaging, a protein stain, a nucleic acid stain, chemical fixation, and a protease inhibitor.

39. The method of claim 27, further comprising measuring one or more biomarkers in one or more of the biological fluid and the ECMBs by one or more of immunoassay, microscopy, immunohistochemistry, fluorescence in situ hybridization, immunofluorescence, infrared, and UV-VIS.

40. The method of claim 27, further comprising analyzing the biological fluid removed from the microfluidic chip using one or more of microscopy, microfluidic device, mass spectrometry, microarray, nucleic acid amplification, hybridization, proteomic profiling, fluorescence hybridization, immunohistochemistry, nucleic acid analysis or sequencing, next generation sequencing, flow cytometry, chromatography, electrophoresis, immunostaining, fluorescence assay, fluorescent in situ hybridization (FISH), chelate complexation, quantitative HPLC, spectrophotometry, antibody array, Western blot, immunoassay, immunoprecipitation, ELISA, LC-MS, LC-MRM, radioimmunoassay, 2D gel mass spectrometry, LC-MS/MS, RT-PCR, and quantitative PCR.

41. The method of claim 27, further comprising processing the biological fluid removed from the microfluidic chip using one or more of microfluidic separation, affinity chromatography, centrifugation, differential centrifugation, density gradient centrifugation, mesh filtration, diafiltration, tangential flow filtration, membrane filtration, immuno-affinity capture, magnetic bead capture, size exclusion chromatography, electrophoresis, and AC electrokinetics.

42. The method of claim 27, wherein the biological fluid comprises one or more of whole blood, blood plasma, blood serum, cerebrospinal fluid, intrathecal fluid, urine, saliva, sweat, tears, synovial fluid, pleural fluid, gastric fluid, peritoneal fluid, breast milk, nipple aspirate, semen, amniotic fluid, vitreous, aqueous humor, lymph, bile, cerumen, chyle, chyme, endolymph, perilymph, exudates, feces, ejaculate, gastric acid, gastric juice, mucus, pericardial fluid, pus, rheum, sebum, serous fluid, smegma, sputum, synovial fluid, vaginal secretion, menstrual effluent, vomit, and fluids passed through one or more of tissues and gels.
